(19) United States
(12) Patent Application Publication
(10) Pub. No.: US 2020/0003569 A1
(43) Pub. Date: Jan. 2, 2020

(54) NAVIGATION SYSTEMS, DEVICES, AND METHODS

(71) Applicant: Pawel Polanowski, Garfield, NJ (US)

(72) Inventor: Pawel Polanowski, Garfield, NJ (US)

(21) Appl. No.: 16/022,689

(22) Filed: Jun. 29, 2018

(51) Int. Cl. G01C 21/34; G01C 21/36

(52) U.S. Cl. CPC G01C 21/3461; G01C 21/3484; G01C 21/3697; G01C 21/3415

(57) ABSTRACT

A method for navigation may include receiving, by a server system, an indication of a starting location and an indication of a destination from a client device; identifying a route between and including the starting location and the destination; calculating a safety rating for the route, the safety rating indicating an estimated likelihood of a traveler experiencing an incident when traveling along the route; and/or transmitting, from the server system to the client device, an indication of the route and an indication of the safety rating. A navigation system including devices for implementing the method is also disclosed.

### BACKGROUND

### Technical Field

The present disclosure relates generally to systems, devices, and methods for navigating from an origin to a destination and any intermediate point therebetween. More particularly, the present disclosure relates to systems, devices, and methods for facilitating safer navigation from an origin to a destination and any intermediate point therebetween.

### Description of the Related Art

Getting lost while commuting is never a pleasant experience. Thankfully, navigation technology has allowed individuals to venture into and through unfamiliar areas. Such technology includes navigation systems that utilize global positioning systems (GPS). GPS was originally developed for use by the United States military, but in the 1980s the United States government made GPS available for civilian use. Although GPS satellite data is free and available anywhere in the world, a device and the associated software must be purchased or rented so that one may utilized GPS.

Increasingly, some software for GPS systems attempt to provide users with travel times and traffic information related to navigation. One such software includes WAZE, which was formally known as FreeMap Israel. By providing the user with relatively current traffic information, the WAZE software is able to provide routing information that may reduce travel time. However, conventional software, including that provided by WAZE, does not consider the safety of a route and has no means of doing so at the onset of a trip. While some navigation systems may include active alerts or even updates from other users of the system as to current traffic conditions, these systems do not assess the potential danger that the route poses to a traveler. Further, current navigation systems do not account for statistical resources that may impact the safety of a route when determining the best routes for their users to navigate. For example, currently, there is no way to prophylactically and intelligently navigate a traveler along routes that account for the possibility of the traveler being a victim of a crime by considering all the multitude of factors that might put that traveler in danger while traveling along a particular route.

Traveling along a route through a relatively dangerous area can needlessly jeopardize one's safety when a safer alternative route exists. While venturing into an unfamiliar area can be exciting and is sometimes necessary to get to one's destination, the unknown can also present a range of dangers or threats for such travelers whether their means of transportation is a private car, motorcycle, bicycle, on foot, or public transportation. Traveling through a relatively dangerous area needlessly jeopardizes the safety of a traveler, since there are often alternative routes the traveler may take which pose less of a risk to the safety of the traveler. Often such safer alternatives exist, and it would be preferable to not only arrive at a destination speedily, but also to travel there safely.

Further, conventional navigation systems, even those that are capable of permitting a user to select some preferences such as to avoid a particular area altogether (e.g., avoid toll roads), are incapable of intelligently determining the best route based on data relating to historical, updated, or real-time safety information (e.g., history of criminal activity, severe weather, or vehicle accidents) for a particular area. Sadly, some tragedies have occurred to users of such conventional systems, in part because those systems did not take into consideration safety information pertaining to the routes of users, resulting in the users traveling through unfamiliar dangerous locations. For example, in 2018, a tourist couple driving in Canada had to be rescued after their vehicle became stranded in snow due to following unsafe GPS navigation onto a road that was ‘virtually impassable’ and not recommended for travel by locals of the area, (see: http://www.cbccainewsicanada/nova-scotia/rcmp-help-stranded-tourists-in-cape-breton-highlands-1.4541258.) As another example, in 2015, The Washington Post reported that a driver unfamiliar with the area drove off a partially demolished bridge due to following unsafe GPS navigation, resulting in the death of his passenger wife (see: https://wwwwashingtonpost.com/news/morning-mix/wp/2015/03/31/driver-follows-gps-off-demolished-bridge-killing-wife-police-say/?utm_term=.10af497c0049). These are only a few examples out of many, where unsafe GPS navigation directed a traveler unfamiliar with the area into a dangerous situation. In other cases, tourists traveling in war torn areas have found that their GPS systems led them to villages where the residents greeted them with hostility on account of their inadvertent incursions. Thus, it can be appreciated that travelers who proceed along an unknown route provided by conventional GPS navigation may face dangers that put them at potential risk of harm.

Accordingly, there is a need for a navigation systems, devices, and methods that will account for the safety and risk posed to the traveler when providing a prescribed route. The foregoing discussion is provided to facilitate a better understanding of the present disclosure and technical field to which it pertains, and is not be regarded as any admission of prior art.

### SUMMARY

In accordance with aspects of the present disclosure, a method for navigation may include: receiving, by a server system, an indication of a starting location and an indication of a destination from a first client device; identifying a first route between and including the starting location and the destination; calculating a first safety rating for the first route, the first safety rating indicating an estimated likelihood of a traveler experiencing an incident when traveling along the first route; and/or transmitting, from the server system to the first client device, an indication of the first route and an indication of the first safety rating. The first safety rating may be calculated based on at least one of a user rating and a statistical resource. The first route may include one or more travel segments and the first safety rating may be calculated based at least on one or more segment scores. Each travel segment may identify a portion of the first route, and each segment score may indicate an estimated likelihood of the traveler experiencing an incident when traveling along one of the one or more travel segments.

In accordance with other aspects of the present disclosure, the method for navigation may additionally or alternatively include: updating the starting location to be a current location of the first client device in response to detecting that the first client device has commenced travel along the first route; identifying a second route between and including the starting location and the destination after updating the starting location to be the current location of the first client device; calculating a second safety rating for the second route after identifying the second route, the second safety rating indicating an estimated likelihood of the traveler experiencing an incident when traveling along the second route; and/or transmitting, from the server system to the first client device, an indication of the second route and an indication of the second safety rating.

In accordance with other aspects of the present disclosure, the method for navigation may additionally or alternatively include: identifying, for at least one path point, a point data set including one or more information sources for each path point, each path point identifying a location included within the first route, each information source having a data value, a data importance factor, a data category, and a geographic zone, the geographic zone indicating a geographic area associated with the information source, the geographic zone of each information source in the point data set being within a predetermined distance from the corresponding path point, the data importance factor being assigned to the information source and indicating a degree of significance associated with the data value, the data category being one of a user rating and a statistical resource; identifying one or more category data sets of information sources for each point data set, each of the category data sets being a subset of the point data set, each category data set having a set category and a category importance factor, the category importance factor being assigned to the category data set and indicating a degree of significance associated with the set category, the set category being one of the user rating and the statistical resource, and each category data set including the one or more information sources in the point data set having the data category matching the set category of the category data set; calculating a category score for each category data set, the category score being calculated based on the data value and the data importance factor of at least one of the information sources that is included within the category data set; calculating a path point score for each path point, the path point score being calculated based on the category score and the category importance factor associated with at least one of the category data sets that is a subset of the point data set for the path point; and/or calculating the first safety rating based on the at least one path point score.

In accordance with other aspects of the present disclosure, the method for navigation may additionally or alternatively include: identifying, for at least one travel segment, a segment data set including one or more information sources for each travel segment, each information source having a data value, a data importance factor, a data category, and a geographic zone, the geographic zone indicating a geographic area associated with the information source, the geographic zone of each information source in the segment data set being within a predetermined distance from any location within the corresponding travel segment, the data importance factor being assigned to the information source and indicating a degree of significance associated with the data value, the data category being one of a user rating and a statistical resource; identifying one or more category data sets of information sources for each segment data set, each of the category data sets being a subset of the segment data set, each category data set having a set category and a category importance factor, the category importance factor being assigned to the category data set and indicating a degree of significance associated with the set category, the set category being one of the user rating and the statistical resource, each category data set including the one or more information sources in the segment data set having the data category matching the set category of the category data set; calculating the category score for each category data set, the category score being calculated based on the data value and the data importance factor of at least one of the information sources that is included within the category data set; calculating a segment score for each travel segment, the segment score being calculated based on the category score and the category importance factor associated with at least one of the category data sets that is a subset of the segment data set for the travel segment; and/or calculating the first safety rating based on at least one segment score.

In accordance with other aspects of the present disclosure, the method for navigation may additionally or alternatively include: receiving, by the server system, an indication of a new rating and an indication of a new rating location from the first client device, the new rating indicating an estimated likelihood of the traveler experiencing an incident when at the new rating location.

In accordance with other aspects of the present disclosure, when the first safety rating is calculated based at least on a set of user ratings, the method for navigation may additionally or alternatively include: receiving, by the server system, an indication of a new rating and an indication of a new rating location from a reporting client device, the new rating indicating an estimated likelihood of the traveler experiencing an incident when at the new rating location; updating the set of user ratings to include the new rating; calculating a remaining safety rating for a remaining portion of the first route in response to detecting that the new rating location is within a predetermined distance from the remaining portion of the first route, the remaining portion of the first route being between and including a current location of the first client device and the destination, the remaining safety rating being calculated based on at least the set of user ratings, the remaining safety rating indicating an estimated likelihood of the traveler experiencing an incident when traveling along the remaining portion of the first route; and/or transmitting, from the server system to the first client device, an indication of the remaining portion of the first route and an indication of the remaining safety rating.

In accordance with other aspects of the present disclosure, when the first safety rating is calculated based at least on a set of user ratings, the method for navigation may additionally or alternatively include: receiving, by the server system, an indication of a new rating and an indication of a new rating location from a reporting client device, the new rating indicating an estimated likelihood of the traveler experiencing an incident when at the new rating location; updating the set of user ratings to include the new rating; calculating a remaining safety rating for a remaining portion of the first route in response to detecting that the new rating location is within a predetermined distance from the remaining portion of the first route, the remaining portion of the first route being between and including a current location of the first client device and the destination, the remaining safety rating being calculated based on at least the set of user ratings, the remaining safety rating indicating an estimated likelihood of the traveler experiencing an incident when traveling along the remaining portion of the first route; identifying a second route between and including a current location of the first client device and the destination; calculating a second safety rating for the second route, the second safety rating being calculated based at least on the set of user ratings, the second safety rating indicating an estimated likelihood of the traveler experiencing an incident when traveling along the second route; and/or transmitting, from the server system to the first client device, an indication of the second route and an indication of the second safety rating in response to detecting that the second safety rating is better than or equal to the remaining safety rating.

In accordance with other aspects of the present disclosure, the method for navigation may additionally or alternatively include: receiving, by the server system, an indication of a minimum safety threshold from the first client device; and/or transmitting, from the server system to the first client device, an indication of a second route and an indication of a second safety rating in response to: (a) detecting that the first safety rating does not satisfy the minimum safety threshold; (b) identifying the second route between and including the starting location and the destination, the second safety rating being associated with the second route, the second safety rating indicating an estimated likelihood of the traveler experiencing an incident when traveling along the second route; and (c) the second safety rating satisfying the minimum safety threshold.

In accordance with other aspects of the present disclosure, the method for navigation may additionally or alternatively include: receiving, by the server system, an indication of a preferred route type from the first client device, the preferred route type being one of a safest route, a fastest route, a shortest route, and an optimized route, the optimized route being determined based on at least one of the first safety rating, a first duration for the first route, and a first distance for the first route; and/or identifying the first route based on the preferred route type. The optimized route may be determined using a function that maximizes the first safety rating and minimizes at least one of the first duration and the first distance.

In accordance with other aspects of the present disclosure, the first route may be identified such that at least one of: (a) the first duration has a first value within a predetermined number of standard deviations away from a mean value of durations of an identified set of routes or the first value is less than the mean value of durations of the identified set of routes; and/or (b) the first distance has a second value within a predetermined number of standard deviations away from a mean value of distances of an identified set of routes or the second value is less than the mean value of distances of the identified set of routes.

In accordance with other aspects of the present disclosure, the method for navigation may additionally or alternatively include: identifying a live danger condition and a live danger location; identifying a remaining portion of the first route in response to detecting that the first client device has commenced travel along the first route, the remaining portion of the first route being between and including a current location of the first client device and the destination; and/or transmitting, from the server system to the first client device, an indication of the live danger condition and an indication of the live danger location in response to: (a) detecting that the live danger location is within a predetermined distance from the remaining portion of the first route; and (b) determining that there is a statistically relevant increase in the estimated likelihood of the traveler experiencing an incident when traveling along the remaining portion of the first route because of the live danger condition.

In accordance with other aspects of the present disclosure, the method for navigation may additionally or alternatively include: receiving, by the server system, an indication of route safety options from the first client device, the route safety options including an option to bypass roads without street lighting; an option to bypass roads not permitting commercial vehicle access; an option to bypass dirt roads; an option to bypass highways; and/or an option specifying a preferred road type for travel; and/or identifying the first route based on the route safety options.

In accordance with other aspects of the present disclosure, the method for navigation may additionally or alternatively include: receiving, by the server system, an indication of an SOS request from the first client device, the SOS request being at least one of a request to contact emergency services, a request to contact an emergency contact, and a request to activate an alarm; and/or effecting at least one of: a communication with the emergency services in response to detecting that the SOS request is the request to contact emergency services, the communication with the emergency services including at least one of a user identification, a vehicle identification, and a last known location of the first client device; a communication with the emergency contact in response to detecting that the SOS request is the request to contact the emergency contact, the communication with the emergency contact including at least one of the user identification, the vehicle identification, and the last known location of the first client device; and/or an activation of the alarm in response to detecting that the SOS request is the request to activate the alarm.

In accordance with other aspects of the present disclosure, the method for navigation may additionally or alternatively include: receiving, by the server system, an indication of a report safety condition request and an indication of identifying information from the first client device, the report safety condition request being at least one of a request to report an unsafe condition, a request to report criminal activity, and a request to report a severe weather condition, and the identifying information including at least one of a condition type, a condition location, a condition description, a user identification, and a vehicle identification; and/or effecting a predetermined response in response to detecting that the condition type is within a predetermined condition category.

In accordance with other aspects of the present disclosure, the method for navigation may additionally or alternatively include: receiving, by the server system, an indication of a minimum safety threshold from the first client device; determining a first destination category for the destination; calculating a destination safety rating for the destination, the destination safety rating indicating an estimated likelihood of the traveler experiencing an incident when at the destination; identifying an alternate destination within a predetermined distance from the destination in response to detecting that the destination safety rating does not satisfy the minimum safety threshold, the alternate destination having an alternate safety rating that satisfies the minimum safety threshold, the alternate safety rating indicating an estimated likelihood of the traveler experiencing an incident when at the alternate destination, the alternate destination having a second destination category matching the first destination category; and/or transmitting, from the server system to the first client device, an indication of the alternate destination and an indication of the alternate safety rating.

In accordance with other aspects of the present disclosure, the method for navigation may additionally or alternatively include: calculating a second safety rating for a remaining portion of the first route, the remaining portion of the first route being between and including a current location of the first client device and the destination in response to detecting that the first client device has commenced travel along the first route; generating a safety change alert in response to detecting that the second safety rating is worse than the first safety rating and detecting that a difference between the second safety rating and the first safety rating exceeds a predetermined threshold; and/or transmitting, from the server system, an indication of the safety change alert and an indication of the second safety rating to the first client device after generating the safety change alert.

In accordance with aspects of the present disclosure, a method for navigation may include: transmitting, from a client device to a server system, a request for: (a) a route between and including a starting location and a destination, and (b) a safety rating associated with the route, the safety rating indicating an estimated likelihood of a traveler experiencing an incident when traveling along the route; and/or receiving, by the client device from the server system, an indication of a first route and an indication of a first safety rating for the first route, the first route being between and including the starting location and the destination, the first safety rating indicating an estimated likelihood of the traveler experiencing an incident when traveling along the first route. The first route may include one or more travel segments and the first safety rating may be calculated based at least on one or more segment scores. Each travel segment may identify a portion of the first route, and each segment score may indicate an estimated likelihood of the traveler experiencing an incident when traveling along one of the one or more travel segments.

In accordance with other aspects of the present disclosure, the method for navigation may additionally or alternatively include: transmitting, from the client device to the server system, a request for an updated route and an updated safety rating in response to detecting that the client device has commenced travel along the first route, the request for the updated route and the updated safety rating including an indication of a current location of the client device, the updated safety rating indicating an estimated likelihood of the traveler experiencing an incident when traveling along the updated route.

In accordance with other aspects of the present disclosure, the method for navigation may additionally or alternatively include: transmitting, from the client device to the server system, an indication of a new rating and an indication of a new rating location, the new rating indicating an estimated likelihood of the traveler experiencing an incident when at the new rating location.

In accordance with other aspects of the present disclosure, the method for navigation may additionally or alternatively include: detecting input specifying a minimum safety threshold; and/or transmitting, from the client device to the server system, an indication of the minimum safety threshold.

In accordance with other aspects of the present disclosure, the method for navigation may additionally or alternatively include: detecting input specifying a minimum safety threshold; and/or outputting, using an output device, the first route in response to detecting that the first safety rating satisfies the minimum safety threshold.

In accordance with other aspects of the present disclosure, the method for navigation may additionally or alternatively include: detecting input specifying a minimum safety threshold; detecting input specifying a safety override approval in response to detecting that the first safety rating does not satisfy the minimum safety threshold; and/or outputting, using an output device, the first route in response to detecting that the safety override approval is affirmative.

In accordance with other aspects of the present disclosure, the method for navigation may additionally or alternatively include: transmitting, from the client device to the server system, an indication of a preferred route type, the preferred route type being one of a safest route, a fastest route, a shortest route, and an optimized route.

In accordance with other aspects of the present disclosure, the method for navigation may additionally or alternatively include: receiving, by the client device from the server system, an indication of a live danger condition and an indication of a live danger location; and/or outputting, using an output device, a representation of the live danger condition.

In accordance with other aspects of the present disclosure, the method for navigation may additionally or alternatively include: transmitting, from the client device to the server system, an indication of route safety options, the route safety options including an option to bypass roads without street lighting; an option to bypass roads not permitting commercial vehicle access; an option to bypass dirt roads; an option to bypass highways; and/or an option specifying a preferred road type for travel.

In accordance with other aspects of the present disclosure, the method for navigation may additionally or alternatively include: detecting input specifying an SOS request, the SOS request being at least one of a request to contact emergency services, a request to contact an emergency contact, and a request to activate an alarm; and/or transmitting, from the client device to the server system, an indication of the SOS request.

In accordance with other aspects of the present disclosure, the method for navigation may additionally or alternatively include: detecting input specifying an SOS request, the SOS request being at least one of a request to contact emergency services, a request to contact an emergency contact, and a request to activate an alarm; and/or effecting at least one of: a communication with the emergency services in response to detecting that the SOS request is the request to contact emergency services, the communication with the emergency services including at least one of a user identification, a vehicle identification, and a last known location of the client device; a communication with the emergency contact in response to detecting that the SOS request is the request to contact the emergency contact, the communication with the emergency contact including at least one of the user identification, the vehicle identification, and the last known location of the client device; and/or an activation of the alarm in response to detecting that the SOS request is the request to activate the alarm.

In accordance with other aspects of the present disclosure, the method for navigation may additionally or alternatively include: detecting input specifying a report safety condition request, the report safety condition request being at least one of a request to report an unsafe condition, a request to report criminal activity, and a request to report a severe weather condition; and/or transmitting, from the client device to the server system, an indication of the report safety condition request and an indication of identifying information, the identifying information including at least one of a condition type, a condition location, a condition description, a user identification, and a vehicle identification.

In accordance with other aspects of the present disclosure, the method for navigation may additionally or alternatively include: outputting, using an output device, a representation of the first route and a representation of the first safety rating.

In accordance with other aspects of the present disclosure, when the first route includes one or more travel segments and the first safety rating is calculated based at least on one or more segment scores, each travel segment identifying a portion of the first route, each segment score indicating an estimated likelihood of the traveler experiencing an incident when traveling along one of the one or more travel segments, the method for navigation may additionally or alternatively include: outputting, using an output device, a representation of the one or more travel segments and a representation of at least one of the one or more travel segment safety ratings.

In accordance with aspects of the present disclosure, a server system for navigation may include: a memory; a communications interface; and at least one processor operatively coupled to the memory, and the processor may be configured to: receive an indication of a starting location and an indication of a destination from a first client device; identify a first route between and including the starting location and the destination; calculate a first safety rating for the first route, the first safety rating indicating an estimated likelihood of a traveler experiencing an incident when traveling along the first route; and/or transmit, to the first client device, an indication of the first route and an indication of the first safety rating. The first safety rating may be calculated based on at least one of a user rating and a statistical resource. The first route may include one or more travel segments and the first safety rating may be calculated based at least on one or more segment scores. Each travel segment may identify a portion of the first route, and each segment score may indicate an estimated likelihood of the traveler experiencing an incident when traveling along one of the one or more travel segments.

In accordance with other aspects of the present disclosure, the processor of the server system may additionally or alternatively be configured to: update the starting location to be a current location of the first client device in response to detecting that the first client device has commenced travel along the first route; identify a second route between and including the starting location and the destination after updating the starting location to be the current location of the first client device; calculate a second safety rating for the second route after identifying the second route, the second safety rating indicating an estimated likelihood of the traveler experiencing an incident when traveling along the second route; and/or transmit, to the first client device, an indication of the second route and an indication of the second safety rating.

In accordance with other aspects of the present disclosure, the processor of the server system may additionally or alternatively be configured to: identify, for at least one path point, a point data set including one or more information sources for each path point, each path point identifying a location included within the first route, each information source having a data value, a data importance factor, a data category, and a geographic zone, the geographic zone indicating a geographic area associated with the information source, the geographic zone of each information source in the point data set being within a predetermined distance from the corresponding path point, the data importance factor being assigned to the information source and indicating a degree of significance associated with the data value, the data category being one of a user rating and a statistical resource; identify one or more category data sets of information sources for each point data set, each of the category data sets being a subset of the point data set, each category data set having a set category and a category importance factor, the category importance factor being assigned to the category data set and indicating a degree of significance associated with the set category, the set category being one of the user rating and the statistical resource, and each category data set including the one or more information sources in the point data set having the data category matching the set category of the category data set; calculate a category score for each category data set, the category score being calculated based on the data value and the data importance factor of at least one of the information sources that is included within the category data set; calculate a path point score for each path point, the path point score being calculated based on the category score and the category importance factor associated with at least one of the category data sets that is a subset of the point data set for the path point; and/or calculate the first safety rating based on at least one path point score.

In accordance with other aspects of the present disclosure, the processor of the server system may additionally or alternatively be configured to: identify, for at least one travel segment, a segment data set including one or more information sources for each travel segment, each information source having a data value, a data importance factor, a data category, and a geographic zone, the geographic zone indicating a geographic area associated with the information source, the geographic zone of each information source in the segment data set being within a predetermined distance from any location included within the corresponding travel segment, the data importance factor being assigned to the information source and indicating a degree of significance associated with the data value, the data category being one of a user rating and a statistical resource; identify one or more category data sets of information sources for each segment data set, each of the category data sets being a subset of the segment data set, each category data set having a set category and a category importance factor, the category importance factor being assigned to the category data set and indicating a degree of significance associated with the set category, the set category being one of the user rating and the statistical resource, each category data set including the one or more information sources in the segment data set having the data category matching the set category of the category data set; calculate the category score for each category data set, the category score being calculated based on the data value and the data importance factor of at least one of the information sources that is included within the category data set; calculate a segment score for each travel segment, the segment score being calculated based on the category score and the category importance factor associated with at least one of the category data sets that is a subset of the segment data set for the travel segment; and/or calculate the first safety rating based on at least one segment score.

In accordance with other aspects of the present disclosure, the processor of the server system may additionally or alternatively be configured to: receive an indication of a new rating and an indication of a new rating location from the first client device, the new rating indicating an estimated likelihood of the traveler experiencing an incident when at the new rating location.

In accordance with other aspects of the present disclosure, when the first safety rating is calculated based at least on a set of user ratings, the processor of the server system may additionally or alternatively be configured to: receive an indication of a new rating and an indication of a new rating location from a reporting client device, the new rating indicating an estimated likelihood of the traveler experiencing an incident when at the new rating location; update the set of user ratings to include the new rating; calculate a remaining safety rating for a remaining portion of the first route in response to detecting that the new rating location is within a predetermined distance from the remaining portion of the first route, the remaining portion of the first route being between and including a current location of the first client device and the destination, the remaining safety rating being calculated based on at least the set of user ratings, the remaining safety rating indicating an estimated likelihood of the traveler experiencing an incident when traveling along the remaining portion of the first route; and/or transmit, to the first client device, an indication of the remaining portion of the first route and an indication of the remaining safety rating.

In accordance with other aspects of the present disclosure, when the first safety rating is calculated based at least on a set of user ratings, the processor of the server system may additionally or alternatively be configured to: receive an indication of a new rating and an indication of a new rating location from a reporting client device, the new rating indicating an estimated likelihood of the traveler experiencing an incident when at the new rating location; update the set of user ratings to include the new rating; calculate a remaining safety rating for a remaining portion of the first route in response to detecting that the new rating location is within a predetermined distance from the remaining portion of the first route, the remaining portion of the first route being between and including a current location of the first client device and the destination, the remaining safety rating being calculated based on at least the set of user ratings, the remaining safety rating indicating an estimated likelihood of the traveler experiencing an incident when traveling along the remaining portion of the first route; identify a second route between and including a current location of the first client device and the destination; calculate a second safety rating for the second route, the second safety rating being calculated based at least on the set of user ratings, the second safety rating indicating an estimated likelihood of the traveler experiencing an incident when traveling along the second route; and/or transmit, to the first client device, an indication of the second route and an indication of the second safety rating in response to detecting that the second safety rating is better than or equal to the remaining safety rating.

In accordance with other aspects of the present disclosure, the processor of the server system may additionally or alternatively be configured to: receive an indication of a minimum safety threshold from the first client device; and/or transmit, to the first client device, an indication of a second route and an indication of a second safety rating in response to: (a) detecting that the first safety rating does not satisfy the minimum safety threshold; (b) identifying the second route between and including the starting location and the destination, the second safety rating being associated with the second route, the second safety rating indicating an estimated likelihood of the traveler experiencing an incident when traveling along the second route; and (c) the second safety rating satisfying the minimum safety threshold.

In accordance with other aspects of the present disclosure, the processor of the server system may additionally or alternatively be configured to: receive an indication of a preferred route type from the first client device, the preferred route type being one of a safest route, a fastest route, a shortest route, and an optimized route, the optimized route being determined based on at least one of the first safety rating, a first duration for the first route, and a first distance for the first route; and/or identify the first route based on the preferred route type. The optimized route may be determined using a function that maximizes the first safety rating and minimizes at least one of the first duration and the first distance.

In accordance with other aspects of the present disclosure, the first route may be identified such that at least one of: (a) the first duration has a first value within a predetermined number of standard deviations away from a mean value of durations of an identified set of routes or the first value is less than the mean value of durations of the identified set of routes; and/or (b) the first distance has a second value within a predetermined number of standard deviations away from a mean value of distances of an identified set of routes or the second value is less than the mean value of distances of the identified set of routes.

In accordance with other aspects of the present disclosure, the processor of the server system may additionally or alternatively be configured to: identify a live danger condition and a live danger location; identify a remaining portion of the first route in response to detecting that the first client device has commenced travel along the first route, the remaining portion of the first route being between and including a current location of the first client device and the destination; and/or transmit, to the first client device, an indication of the live danger condition and an indication of the live danger location in response to: (a) detecting that the live danger location is within a predetermined distance from the remaining portion of the first route; and (b) determining that there is a statistically relevant increase in the estimated likelihood of the traveler experiencing an incident when traveling along the remaining portion of the first route because of the live danger condition.

In accordance with other aspects of the present disclosure, the processor of the server system may additionally or alternatively be configured to: receive an indication of route safety options from the first client device, the route safety options including an option to bypass roads without street lighting; an option to bypass roads not permitting commercial vehicle access; an option to bypass dirt roads; an option to bypass highways; and an option specifying a preferred road type for travel; and/or identify the first route based on the route safety options.

In accordance with other aspects of the present disclosure, the processor of the server system may additionally or alternatively be configured to: receive an indication of an SOS request from the first client device, the SOS request being at least one of a request to contact emergency services, a request to contact an emergency contact, and a request to activate an alarm; and/or effect at least one of: a communication with the emergency services in response to detecting that the SOS request is the request to contact emergency services, the communication with the emergency services including at least one of a user identification, a vehicle identification, and a last known location of the first client device; a communication with the emergency contact in response to detecting that the SOS request is the request to contact the emergency contact, the communication with the emergency contact including at least one of the user identification, the vehicle identification, and the last known location of the first client device; and/or an activation of the alarm in response to detecting that the SOS request is the request to activate the alarm.

In accordance with other aspects of the present disclosure, the processor of the server system may additionally or alternatively be configured to: receive an indication of a report safety condition request and an indication of identifying information from the first client device, the report safety condition request being at least one of a request to report an unsafe condition, a request to report criminal activity, and a request to report a severe weather condition, and the identifying information including at least one of a condition type, a condition location, a condition description, a user identification, and a vehicle identification; and/or effect a predetermined response in response to detecting that the condition type is within a predetermined condition category.

In accordance with other aspects of the present disclosure, the processor of the server system may additionally or alternatively be configured to: receive an indication of a minimum safety threshold from the first client device; determine a first destination category for the destination; calculate a destination safety rating for the destination, the destination safety rating indicating an estimated likelihood of the traveler experiencing an incident when at the destination; identify an alternate destination within a predetermined distance from the destination in response to detecting that the destination safety rating does not satisfy the minimum safety threshold, the alternate destination having an alternate safety rating that satisfies the minimum safety threshold, the alternate safety rating indicating an estimated likelihood of the traveler experiencing an incident when at the alternate destination, the alternate destination having a second destination category matching the first destination category; and/or transmit, to the first client device, an indication of the alternate destination and an indication of the alternate safety rating.

In accordance with other aspects of the present disclosure, the processor of the server system may additionally or alternatively be configured to: calculate a second safety rating for a remaining portion of the first route, the remaining portion of the first route being between and including a current location of the first client device and the destination, in response to detecting that the first client device has commenced travel along the first route; generate a safety change alert in response to detecting that the second safety rating is worse than the first safety rating and detecting that a difference between the second safety rating and the first safety rating exceeds a predetermined threshold; and/or transmit an indication of the safety change alert and an indication of the second safety rating to the first client device after generating the safety change alert.

In accordance with aspects of the present disclosure, a client device for navigation may include: a memory; a communications interface; and at least one processor operatively coupled to the memory, and the processor may be configured to: transmit, to a server system, a request for: (a) a route between and including a starting location and a destination, and (b) a safety rating associated with the route, the safety rating indicating an estimated likelihood of a traveler experiencing an incident when traveling along the route; and/or receive, from the server system, an indication of a first route and an indication of a first safety rating for the first route, the first route being between and including the starting location and the destination, and the first safety rating indicating an estimated likelihood of the traveler experiencing an incident when traveling along the first route. The first route may include one or more travel segments and the first safety rating may be calculated based at least on one or more segment scores. Each travel segment may identify a portion of the first route, and each segment score may indicate an estimated likelihood of the traveler experiencing an incident when traveling along one of the one or more travel segments.

In accordance with other aspects of the present disclosure, the processor of the client device may additionally or alternatively be configured to: transmit, to the server system, a request for an updated route and an updated safety rating in response to detecting that the client device has commenced travel along the first route, the request for the updated route and the updated safety rating including an indication of a current location of the client device, the updated safety rating indicating an estimated likelihood of the traveler experiencing an incident when traveling along the updated route.

In accordance with other aspects of the present disclosure, the processor of the client device may additionally or alternatively be configured to: transmit, to the server system, an indication of a new rating and an indication of a new rating location, the new rating indicating an estimated likelihood of the traveler experiencing an incident when at the new rating location.

In accordance with other aspects of the present disclosure, the processor of the client device may additionally or alternatively be configured to: detect input specifying a minimum safety threshold; and/or transmit, to the server system, an indication of the minimum safety threshold.

In accordance with other aspects of the present disclosure, the client device for navigation may further include an output device, and the processor of the client device may additionally or alternatively be configured to: detect input specifying a minimum safety threshold; and/or output, using the output device, the first route in response to detecting that the first safety rating satisfies the minimum safety threshold.

In accordance with other aspects of the present disclosure, the client device for navigation may further include an output device, and the processor of the client device may additionally or alternatively be configured to: detect input specifying a minimum safety threshold; detect input specifying a safety override approval in response to detecting that the first safety rating does not satisfy the minimum safety threshold; and/or output, using the output device, the first route in response to detecting that the safety override approval is affirmative.

In accordance with other aspects of the present disclosure, the processor of the client device may additionally or alternatively be configured to: transmit, to the server system, an indication of a preferred route type, the preferred route type being one of a safest route, a fastest route, a shortest route, and an optimized route.

In accordance with other aspects of the present disclosure, the client device for navigation may further include an output device, and the processor of the client device may additionally or alternatively be configured to: receive, from the server system, an indication of a live danger condition and an indication of a live danger location; and/or output, using the output device, a representation of the live danger condition.

In accordance with other aspects of the present disclosure, the processor of the client device may additionally or alternatively be configured to: transmit, to the server system, an indication of route safety options, the route safety options including an option to bypass roads without street lighting.

In accordance with other aspects of the present disclosure, the processor of the client device may additionally or alternatively be configured to: detect input specifying an SOS request, the SOS request being at least one of a request to contact emergency services, a request to contact an emergency contact, and a request to activate an alarm; and/or transmit, to the server system, an indication of the SOS request.

In accordance with other aspects of the present disclosure, the processor of the client device may additionally or alternatively be configured to: detect input specifying an SOS request, the SOS request being at least one of a request to contact emergency services, a request to contact an emergency contact, and a request to activate an alarm; and/or effect at least one of: a communication with the emergency services in response to detecting that the SOS request is the request to contact emergency services, the communication with the emergency services including at least one of a user identification, a vehicle identification, and a last known location of the client device; a communication with the emergency contact in response to detecting that the SOS request is the request to contact the emergency contact, the communication with the emergency contact including at least one of the user identification, the vehicle identification, and the last known location of the client device; and/or an activation of the alarm in response to detecting that the SOS request is the request to activate the alarm.

In accordance with other aspects of the present disclosure, the processor of the client device may additionally or alternatively be configured to: detect input specifying a report safety condition request, the report safety condition request being at least one of a request to report an unsafe condition, a request to report criminal activity, and a request to report a severe weather condition; and/or transmit, to the server system, an indication of the report safety condition request and an indication of identifying information, the identifying information including at least one of a condition type, a condition location, a condition description, a user identification, and a vehicle identification.

In accordance with other aspects of the present disclosure, the client device for navigation may further include an output device, and the processor of the client device may additionally or alternatively be configured to: output, using the output device, a representation of the first route and a representation of the first safety rating.

In accordance with other aspects of the present disclosure, the client device for navigation may further include an output device, and the first route may include one or more travel segments and the first safety rating may be calculated based at least on one or more segment scores, each travel segment identifying a portion of the first route, each segment score indicating an estimated likelihood of the traveler experiencing an incident when traveling along one of the one or more travel segments, and the processor of the client device may additionally or alternatively be configured to: output, using the output device, a representation of the one or more travel segments and a representation of at least one of the one or more travel segment safety ratings.

The above and other aspects, features, and advantages of the present disclosure will become apparent from the following description read in conjunction with the accompanying drawings, in which like reference numerals designate the same elements.

### BRIEF DESCRIPTION OF THE DRAWINGS

A further understanding of the present disclosure can be obtained by reference to preferred embodiments set forth in the illustrations of the accompanying figures. The illustrated preferred embodiments are merely exemplary of methods, structures, and compositions for carrying out the present disclosure. Both the organization and method of the disclosure, in general, together with further objectives and advantages thereof, may be more easily understood by reference to the figures and the following description. The figures are not intended to limit the scope of this disclosure, which is set forth with particularity in the claims as appended or as subsequently amended, but merely to clarify and exemplify the disclosure.

For a more complete understanding of the present disclosure, reference is now made to the following figures in which:

FIG. 1 depicts a schematic diagram of an embodiment of a network, according to aspects of the disclosure.

FIG. 2 depicts a diagram of an embodiment of a server, according to aspects of the disclosure;

FIG. 3 depicts a diagram of an embodiment of a client device, according to aspects of the disclosure;

FIG. 4A depicts a flowchart of an embodiment of a process performed by a server system, according to aspects of the disclosure;

FIG. 4B depicts a flowchart of an embodiment of a process performed by a server system, according to aspects of the disclosure;

FIG. 4C depicts a flowchart of an embodiment of a process performed by a server system, according to aspects of the disclosure;

FIG. 4D depicts a flowchart of an embodiment of a process performed by a server system, according to aspects of the disclosure;

FIG. 5 depicts a flowchart of an embodiment of subprocess associated with FIG. 4A;

FIG. 6 depicts a flowchart of an embodiment of subprocess associated with FIG. 4B;

FIG. 7 depicts a flowchart of an embodiment of subprocess associated with FIG. 4B;

FIG. 8 depicts a flowchart of an embodiment of subprocess associated with FIG. 4B;

FIG. 9 depicts a flowchart of an embodiment of subprocess associated with FIG. 4B;

FIG. 10 depicts a flowchart of an embodiment of subprocess associated with FIG. 4C;

FIG. 11 depicts a flowchart of an embodiment of subprocess associated with FIG. 4C;

FIG. 12 depicts a flowchart of an embodiment of subprocess associated with FIG. 4C;

FIG. 13 depicts a flowchart of an embodiment of subprocess associated with FIG. 4C;

FIG. 14 depicts a flowchart of an embodiment of subprocess associated with FIG. 4D;

FIG. 15 depicts a flowchart of an embodiment of subprocess associated with FIG. 4D;

FIG. 16A depicts a flowchart of an embodiment of a process performed by a client device, according to aspects of the disclosure;

FIG. 16B depicts a flowchart of an embodiment of a process performed by a client device, according to aspects of the disclosure;

FIG. 16C depicts a flowchart of an embodiment of a process performed by a client device, according to aspects of the disclosure;

FIG. 17 depicts a flowchart of an embodiment of subprocess associated with FIG. 16B.

FIG. 18 depicts a diagram of an embodiment of a user interface for a client device, according to aspects of the disclosure;

FIG. 19 depicts a diagram of an embodiment of a user interface for a client device, according to aspects of the disclosure;

FIG. 20 depicts a diagram of an embodiment of a user interface for a client device, according to aspects of the disclosure;

FIG. 21 depicts a diagram of an embodiment of a user interface for a client device, according to aspects of the disclosure;

FIG. 22 depicts a diagram of an embodiment of a user interface for a client device, according to aspects of the disclosure; and

FIG. 23 depicts a diagram of an embodiment of a user interface for a client device, according to aspects of the disclosure.

### DETAILED DESCRIPTION

Reference will now be made in detail to embodiments of the invention that are illustrated in the accompanying figures. Wherever possible, same or similar reference numerals are used in the figures and the written description to refer to the same or like parts or steps. The figures are in simplified form and are not to precise scale. The figures are non-limiting examples of the disclosed embodiments of the present disclosure and corresponding parts or steps in the different figures may be interchanged and interrelated to the extent such interrelationship is described or inherent from the disclosures contained herein. The specific functional and structural details disclosed herein are merely representative, yet in that regard, they are deemed to afford the best embodiment for purposes of disclosure and to provide a basis for the claims herein, which define the scope of the present disclosure.

As will be discussed in greater detail hereinbelow, the present disclosure generally relates to systems, devices, and methods for safe navigation of a route to reach a destination from a starting location or from a current location of a user.

Systems for navigating (i.e., navigation systems) may include devices such as a server or server system that is specifically purposed to perform operations in accordance with a method as presently disclosed and client devices (e.g., smartphones, standalone GPS navigators, or the like) that include an application for performing a method as presently disclosed. The devices may communicate with one another and may provide data as needed to perform the operations of the presently disclosed methods. The systems, devices, and methods in accordance with the present disclosure provide users with safer navigation by providing safer routes that reduce the risk of the users being put in danger (i.e., experiencing an incident) while traveling, as compared to alternative routes that may exist, by accounting for a multitude of factors that may be employed in order to assess and select such safer routes.

Generally, the term “route” as used throughout the disclosure may refer to a path from a starting location to a destination. Such a path may be represented as a serious of instructions or directions for navigating from the starting location to the destination, including navigating between intermediary points between the starting location and the destination. Further, the route may have a route safety rating associated with the route that provides an indication of the safety of the route. In other words, the route safety rating that is associated with the route may indicate an estimated likelihood of a traveler along the route being put in danger. The route safety rating may be determined, for example, by performing calculations on data associated with locations that are within a predetermined distance from any point along the route between and including the starting location and the destination, and/or other criteria, user-provided ratings, and data that may be utilized to determine the safety of a route.

A segment of the route may also have its own segment safety rating that indicates an estimated likelihood of a traveler being put in danger while traveling along the respective segment of the route. Furthermore, a specific location may have a safety rating associated with it that indicates an estimated likelihood of a traveler being put in danger when at the specific location.

It is noted that the phrase “being put in danger” as used herein is recited interchangeably with the phrase “experiencing an incident” and is intended to have the same meaning. Being put in danger or experiencing an incident may include, for example, experiencing an unsafe condition, criminal activity, a severe weather condition, and/or other incidents or events that may adversely impact the safety of a traveler when at a particular location included within a route. It is a rationale of the present disclosure that present or historical occurrences of particular incidents at particular locations, as known from information sources, statistical data, and/or current or real-time reporting of such incidents, increases the estimated likelihood (e.g., statistical probability) that a user may be put in danger and/or experience similar incidents when at or near those particular locations.

Navigation systems, as described in the present disclosure, may provide routes to one or more users. The navigation systems may include server systems and client devices that may perform the operations of the presently disclosed methods such that users are navigated along routes that are determined to have higher degrees of safety (i.e., a lower estimated likelihood of experiencing an incident when traveling along the route) as compared to being navigated along alternative routes. The estimated likelihood of experiencing an incident may be based on a multitude of factors, information sources, and analyses thereof. Advantageously, the presently disclosed systems, methods, and devices may provide for an integrated analysis of a multitude of factors and information sources that would be difficult, if not impossible, to objectively, consistently, and meaningfully apply if presented to a user individually. The integrated analysis may include, for example, providing the user with an overall safety rating of the entire route or a portion thereof that has taken into account the multitude of factors and information sources. Such safety ratings are described in greater detail hereinbelow.

A navigation system 100, in accordance with the present disclosure, may include a communications network 102, a server system 101 which may include one or more servers 200, a map database 104-105, and at least one client device 300 which together facilitate routing a user of the navigation system more safely to a destination than would be possible using conventional navigation tools by performing the operations of processes in accordance with the present disclosure. The process performed by the server system 101, in accordance with the present disclosure, implements an algorithm that facilitates a determination of a preferred routing based on a plurality of factors which include data and information relating to safety.

Advantageously, the navigation system 100 may facilitate communication among the constituent elements of the navigation system 100 (e.g., the communications network 102, the server system 101 which may include one or more servers 200, a map database 104-105, and the at least one client device 300) to alert the client device(s) 300 of dangers and/or to avoid a traveler along a route being exposed to unacceptable levels of danger. Both historical data (e.g., crime statistics, vehicle accident statistics, weather statistics, etc.) as well as real-time data provided by users via their client devices 300 may be used by the navigation system 100 to actively and safely navigate a user to their destination. The navigation system 100 may also account for the user's means of transportation (e.g., car, bus, train, semi-trailer truck, bicycle, motorcycle, pedestrian, etc.). It should be noted that depending upon the user's means of transportation that the routing of the user may differ and that threats of danger whether from road conditions (e.g., icy roads, road curvatures, a lack of street lighting, etc.) or a heightened risk of criminal activity in a relatively dangerous area, for example, may be taken into account in different ways in order to determine routes having an acceptable level of safety for the user. The acceptable level of safety (also referred to herein as a minimum safety threshold) may be set by the respective user. Further, any means of transportation is to be regarded as falling within the scope and spirit of the present disclosure. The navigation system 100 as described herein may provide a specific tool for assessing the safety of a route, a segment of a route, or a specific location, and such a safety assessment (also referred to herein as a safety rating) may be provided to the user while traveling along the route in real-time and may also be dynamically updated due to changing circumstances (e.g., new information relevant to making such an assessment of safety).

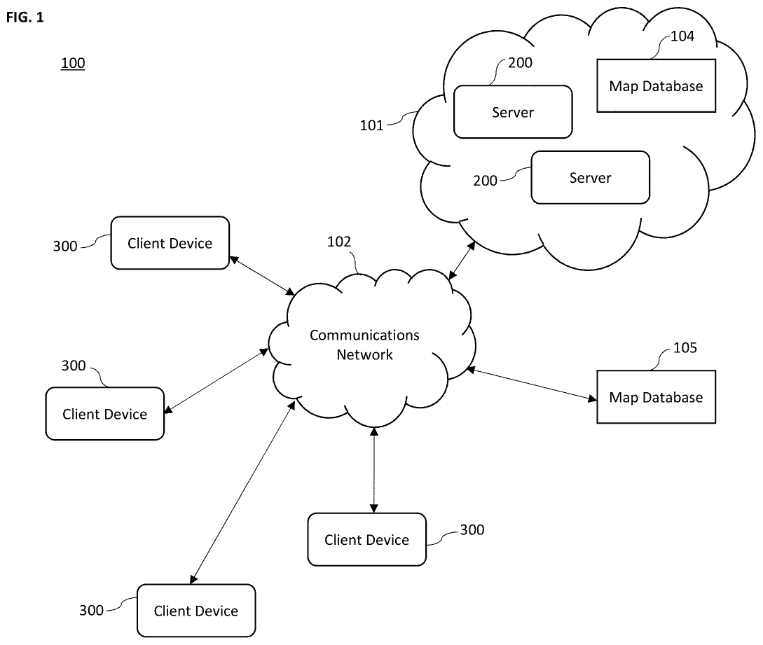

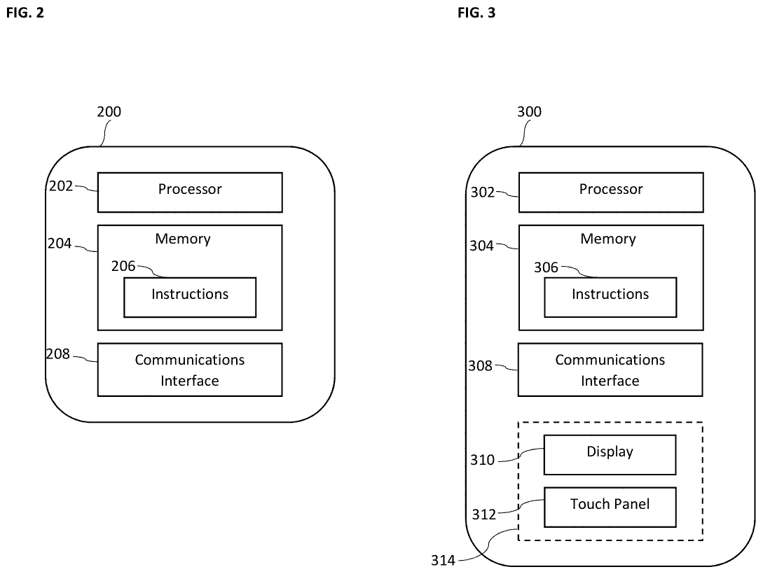

With reference to FIG. 1, a schematic diagram is depicted of an embodiment of a navigation system 100, according to aspects of the disclosure. As illustrated, the navigation system 100 may include a server system 101, client devices 300 (shown in FIG. 3), an external map database 105, and/or a communications network 102. The server system 101 may include one or more servers 200 (shown in FIG. 2), and in some embodiments may also include an internal map database 104.

According to aspects of the disclosure, the server system 101 may comprise a plurality of servers 200 (e.g., a load-balanced server farm) that communicate directly or indirectly over a network and exchange information for the purpose of receiving, processing, and transmitting data to the client devices 300. The plurality of servers 200 may be distributed geographically while remaining operatively connected through any suitable type of network including one or more of the Internet, World Wide Web, intranets, virtual private networks (VNPs), wide area networks (WANs), local networks (LANs), private networks using communication protocols proprietary to one or more companies, Ethernet, WiFi (such as 802.11 standards), BLUETOOTH, wireless telecommunications networks (e.g., LTE, 4G, 3G), HTTP, and various combinations and configurations of the foregoing. In operation, the server system 101 may interact with client devices 300 and provide a route and a route safety rating to one or more of the client devices 300.

According to aspects of the disclosure, the server system 101 may include an internal map database 104 that stores maps and mapping information that identify street layouts, intersection locations, geo-coded addresses, building locations, and other information that is typically found in a maps database. At least some of the information stored in the internal map database 104 may be stored directly on the one or more servers 200 or elsewhere on an independent server as depicted in FIG. 1. In some embodiments, the server system 101 may additionally or alternatively interact with an external map database 105 that stores maps and mapping information that identify street layouts, intersection locations, geo-coded addresses, building locations, and other information that is typically found in a maps database. The external map database 105 may be accessed or obtained from a public map service, such as GOOGLE MAPS, YAHOO MAPS, and MAPQUEST, or it may be accessed or obtained from a private map service.

According to aspects of the disclosure, the servers 200 may be any suitable type of computing device (or system) that is capable of directly or indirectly communicating with the client devices 300 via the communications network 102. The servers 200 may also be capable of directly or indirectly communicating with a map database 104-105. In some embodiments, any of the servers 200 may include a web server that is capable of communicating with client devices 300 and/or map databases 104-105 via the communications network 102, such that the servers 200 use the communication network 102 to transmit and display information on a display 310 of a client device 300. As described in more detail above, a plurality of servers 200 may comprise a server system 101 (e.g., a load-balanced server farm), in which the servers 200 communicate directly or indirectly over a network and exchange information for the purpose of receiving, processing, and transmitting data to at least one of the client devices 300. It is further understood that a greater or lesser number of such servers 200 may be included in the navigation system 100.

According to aspects of the disclosure, the client devices 300 may include any suitable type of computing device (or system) that is capable of directly or indirectly communicating with the server system 101 via the communications network 102. The client devices 300 may also be capable of directly or indirectly communicating with the external map database 105. For example, any of the client devices 300 may include a smartphone, a smartwatch, a tablet, a laptop, a desktop computer, a fitness or activity tracker, a standalone GPS navigator, a global positioning system (GPS) device, a smart vehicle, a digital media player, a wearable technology device, or any mobile device capable of exchanging data with the server system 101 via the communications network 102. It is further understood that a greater or lesser number of such client devices 300 may be included in the navigation system 100.

The client device 300 may include one or more output devices or components that are configured to provide information to a user. Such output devices or components may include visual output devices or components (e.g., display 310 described below), audible output devices or components (e.g., a speaker), tactile output devices or components (e.g., a digital or electronic braille device, or a haptic feedback component that makes use of the sense of touch by applying force, motions, or vibrations), and/or any other suitable output devices or components that are configured to provide information in a format that is understandable to a user. An output device utilized by the client device 300 may be included as part of the client device 300 itself or may be separate from the client device 300 (e.g., part of another distinct device, as a standalone output device, etc.) while capable of communication, directly or indirectly, with the client device 300.

According to aspects of the disclosure, the communications network 102 may include, but is not limited to, one or more of the Internet, World Wide Web, intranets, virtual private networks (VNPs), wide area networks (WANs), local networks (LANs), private networks using communication protocols proprietary to one or more companies, Ethernet, WiFi (such as 802.11 standards), BLUETOOTH, wireless telecommunications networks (e.g., LTE, 4G, 3G), HTTP, and various combinations and configurations of the foregoing.

With reference to FIG. 2, a diagram is depicted of an embodiment of a server 200, according to aspects of the disclosure. As illustrated, the server 200 may include a processor 202, a memory 204, and/or a communications interface 208. According to aspects of the disclosure, the processor 202 may include any suitable type of processing circuitry, such as a general-purpose processor (e.g., an ARM-based processor), an application-specific integrated circuit (ASIC), or a Field-Programmable Gate Array (FPGA). The memory 204 may include any suitable type of volatile and non-volatile memory capable of storing information accessible by the processor 202, such as random-access memory (RAM), read-only memory (ROM), a hard disk (HD), a solid state drive (SSD), a CD-ROM, flash memory, cloud storage, and network accessible storage (NAS). The communications interface 208 may include any suitable type of communications interface, such as a WiFi interface, an Ethernet interface, a Long-Term Evolution (LTE) interface, an Infrared interface, a BLUETOOTH Interface, the like, and/or any combination thereof.

The memory 204 stores information accessible by the processor 202, including instructions 206 that may be executed by the processor. The instructions 206 may be any set of instructions to be executed directly (such as machine code) or indirectly (such as scripts) by the processor. In that regard, the terms “instructions,” “steps,” and “programs” may be used interchangeably herein. The instructions 206 may be stored in object code format for direct processing by the processor 202, or in any other computer language including scripts or collections of independent source code modules that are interpreted on demand or compiled in advance. The instructions 206 may include functions, methods, routines, the like, and/or any combination thereof.

Although FIG. 2 functionally illustrates the processor 202 and the memory 204 as being within the same block, it will be understood by those of ordinary skill in the art that the processor 202 and the memory 204 may actually comprise multiple processors and multiple memories that may or may not be stored within the same physical housing. Further, some or all of the instructions 206 may be stored in a location physically remote from, yet still accessible by, the processor 202. For example, some of the instructions 206 may be stored within a read-only computer memory chip and others on removable CD-ROM. Similarly, the processor 202 may include a collection of processors that may or may not operate in parallel or that may be part of the same cloud computing system.

With reference to FIG. 3, a diagram is depicted of an embodiment of a client device 300, according to aspects of the disclosure. As illustrated, the client device 300 may include a processor 302, a memory 304, a communications interface 308, a display 310, and/or a touch panel 312. According to aspects of the disclosure, the processor 302 may include any suitable type of processing circuitry, such as a general-purpose processor (e.g., an ARM-based processor), an application-specific integrated circuit (ASIC), or a Field-Programmable Gate Array (FPGA). The memory 304 may include any suitable type of volatile and non-volatile memory capable of storing information accessible by the processor 302, such as random-access memory (RAM), read-only memory (ROM), a hard disk (HD), a solid state drive (SSD), a CD-ROM, flash memory, cloud storage, and network accessible storage (NAS). The communications interface 308 may include any suitable type of communications interface, such as a WiFi interface, an Ethernet interface, a Long-Term Evolution (LTE) interface, an Infrared interface, a BLUETOOTH Interface, the like, and/or any combination thereof.

The display 310 of client device 300 may include any suitable type of display such as a liquid crystal display (LCD), a light-emitting diode (LED) display, or an active-matrix organic light-emitting diode (AMOLED) display. The touch panel 312 may include any suitable type of touch panel, such as a capacitive touch panel or a resistive touch panel. In some embodiments, the touch panel 312 may be layered onto the display 310 to form a touchscreen 314. Although not illustrated, the client device 300 may include additional or alternative input devices, such as a microphone, a keyboard, and a mouse.

The memory 304 stores information accessible by the processor 302, including instructions 306 that may be executed by the processor. The instructions 306 may be any set of instructions to be executed directly (such as machine code) or indirectly (such as scripts) by the processor. In that regard, the terms “instructions,” “steps” and “programs” may be used interchangeably herein. The instructions 306 may be stored in object code format for direct processing by the processor 302, or in any other computer language including scripts or collections of independent source code modules that are interpreted on demand or compiled in advance. The instructions 206 may include functions, methods, routines, the like, and/or any combination thereof.

Although FIG. 3 functionally illustrates the processor 302 and the memory 304 as being within the same block, it will be understood by those of ordinary skill in the art that the processor 302 and the memory 304 may actually comprise multiple processors and multiple memories that may or may not be stored within the same physical housing. Further, some or all of the instructions 306 may be stored in a location physically remote from, yet still accessible by, the processor 302. For example, some of the instructions 306 may be stored within a read-only computer memory chip and others on removable CD-ROM. Similarly, the processor 302 may actually comprise a collection of processors that may or may not operate in parallel or that may be part of the same cloud computing system.

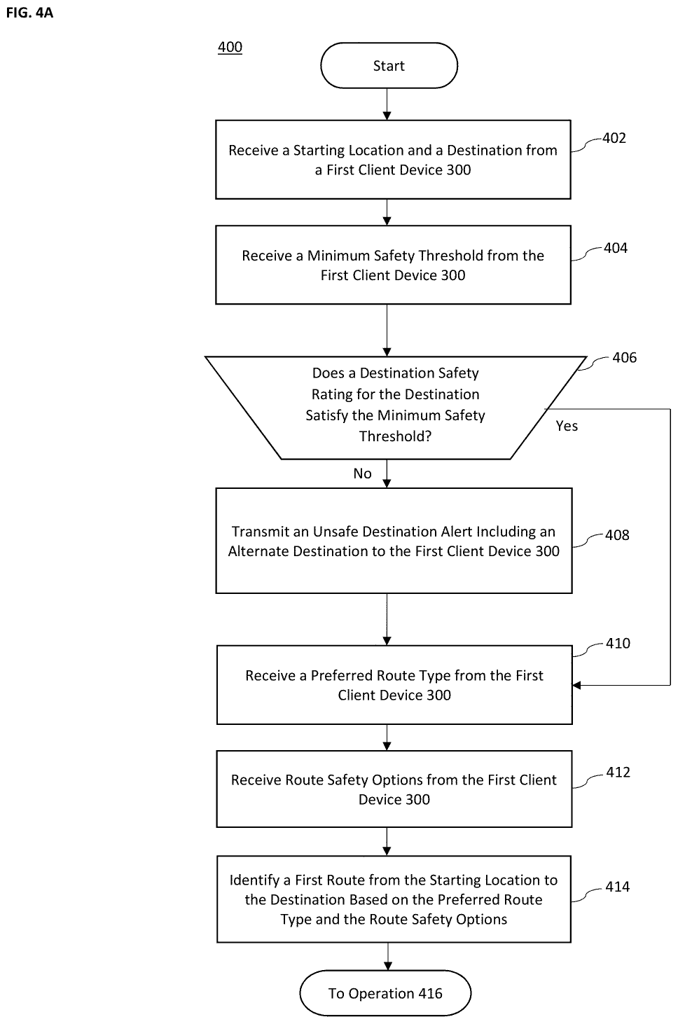

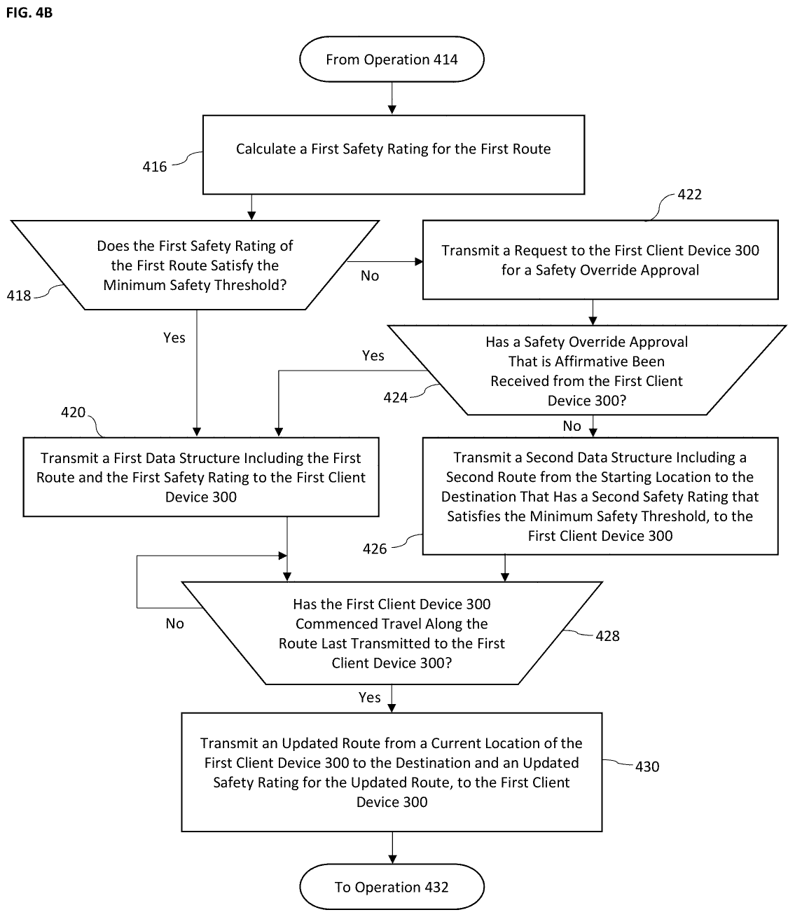

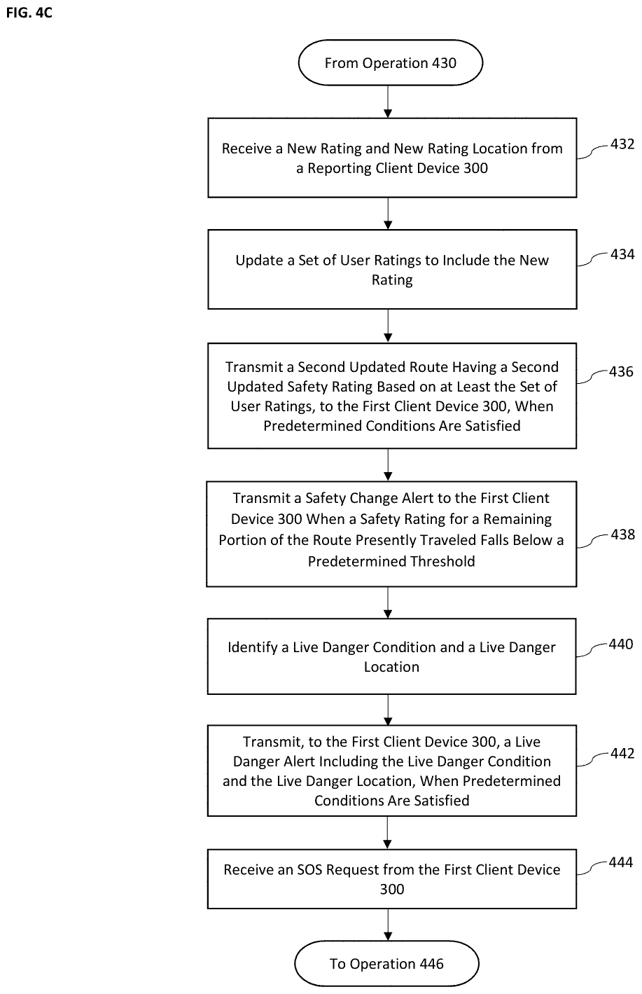

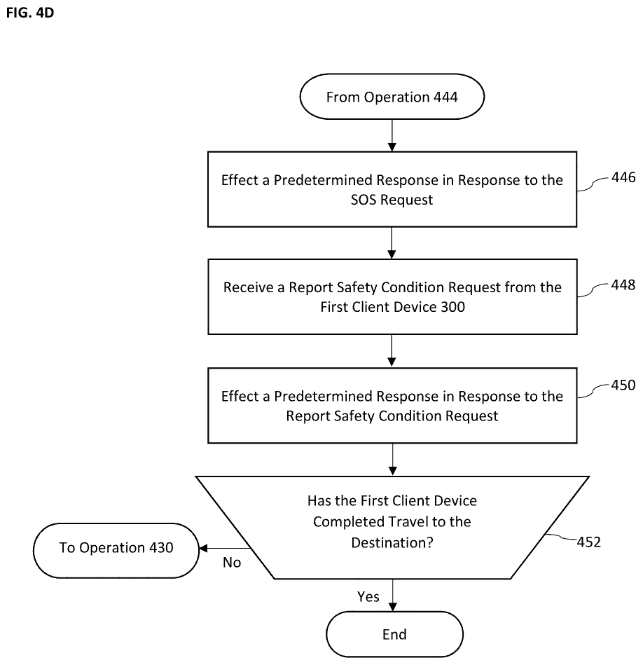

FIGS. 4-17 include flowcharts illustrating processes according to various embodiments of the present disclosure. It is to be understood that in an effort not to obscure the present disclosure in unnecessary detail that the processes depicted in the flowcharts of FIGS. 4-17 may contain additional operations not shown therein. Additionally or alternatively, the processes depicted in the flowcharts of FIGS. 4-17 may omit some of the operations shown therein. The operations depicted in the flowcharts of FIGS. 4-17 are not intended to be limited to any particular order or sequence; rather, the operations may be performed in any order or sequence unless otherwise explicitly stated herein. In light of the present disclosure, alternative orders or sequences of the operations shown in the flowcharts of FIGS. 4-17 will be apparent to those of ordinary skill in the art, and thus such alternative orders or sequences are intended to be within the scope and spirit of the present disclosure.

With reference to FIGS. 4A-D, a flow chart is depicted of an example of a process 400 performed by a server system 101, according to aspects of the disclosure. Although in this embodiment the operations of the process 400 are described and illustrated as being performed by the server system 101, in other embodiments, at least some of the operations of the process 400 may be performed by the client device 300 instead. Further, in some embodiments, at least some of the operations performed by the client device 300 may be performed on behalf of a respective user (i.e., a user of the client device 300).

In operation 402, the server system 101 receives an indication of a starting location and an indication of a destination from a first client device 300. The indication of the starting location and the indication of the destination may each be any suitable means to locate and/or define a geographic location. Such suitable means for locating and/or defining a geographic location may include, but are not limited to, one or more of the following examples: (a) using an address; (b) using GPS coordinates (e.g., latitude and longitude); (c) using a name for the location (e.g., “Yellowstone National Park”); (d) using the name of a municipality (e.g., a city, a town, a neighborhood); and/or using the name of a business or building that can be associated with an address or GPS coordinates.

In operation 404, the server system 101 receives an indication of a minimum safety threshold from the first client device 300. The indication of the minimum safety threshold may be a numerical figure, a color, and/or other visual, audible, or tactile indicia that indicate the lowest safety rating that is acceptable to the first client device 300 (or acceptable to the user of the first client device 300). For example, audible and/or tactile indicia may be preferred by visually impaired users. As discussed above, a safety rating may indicate an estimated likelihood of a traveler being put in danger: (a) at a specific location; (b) while traveling along a route; or (c) while traveling along a segment of the route. As will be discussed further below, the minimum safety threshold may be utilized by the server system 101 such that preferably the safety rating associated with a route, a segment of a route, or a destination that will be provided to the first client device 300 satisfies the minimum safety threshold (i.e., does not fall below the minimum safety threshold), in order to prevent the user of the first client device 300 from being navigated along a route, a segment of a route, or to a destination that does not satisfy the minimum safety threshold (i.e. has been determined to impose too high of a risk to the safety of the traveler). However, the user may opt to override the minimum safety threshold, for example in the case when no route would otherwise satisfy the minimum safety threshold, an embodiment of which is discussed below with regard to operations 410 and 422-424.

In operation 406, the server system 101 determines whether a safety rating associated with the destination (i.e., a destination safety rating) satisfies the minimum safety threshold. The destination safety rating indicates an estimated likelihood of a traveler at the destination being put in danger. Upon a negative determination that the destination safety rating does not meet or exceed the minimum safety threshold (i.e., that the destination is determined to be less safe than the user-defined preference for safety as indicated by the minimum safety threshold), the process 400 proceeds to operation 408. Otherwise, upon a positive determination that the destination safety rating meets or exceeds the minimum safety threshold (i.e., that the destination is determined to be as safe or safer than the user-defined preference for safety as indicated by the minimum safety threshold), the process 400 proceeds to operation 410.

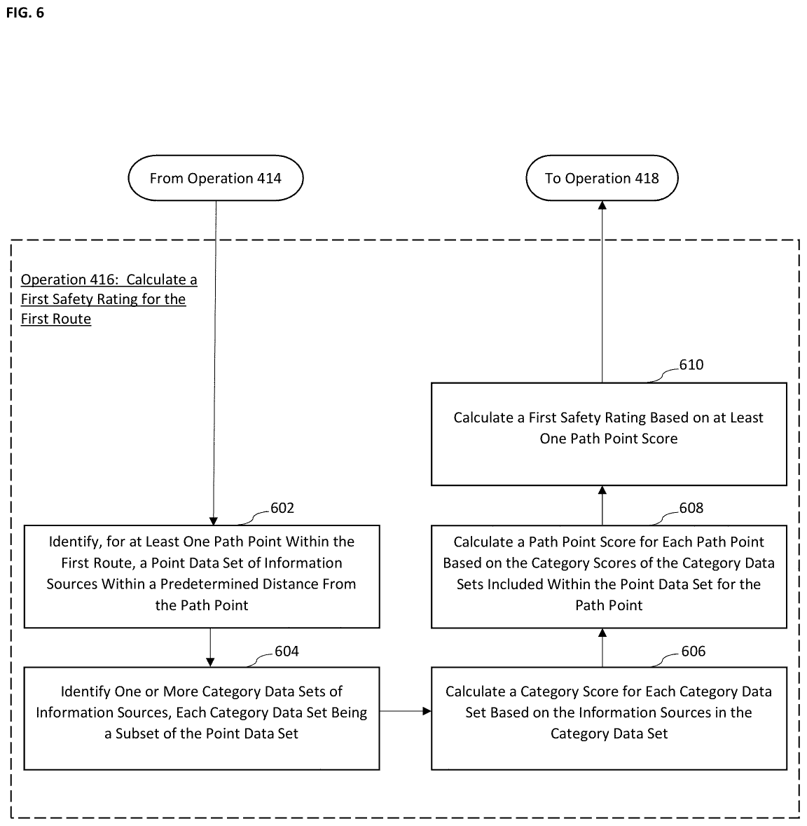

The destination safety rating may be calculated in a substantially similar manner as to how a path point score is calculated, as described in detail below with reference to FIG. 6 in which the path point score is used during the calculation of a route safety rating. In particular, the destination safety rating may be a path point score determined at a location that is an end point (which may be an intermediate waypoint or the final destination) of the route.

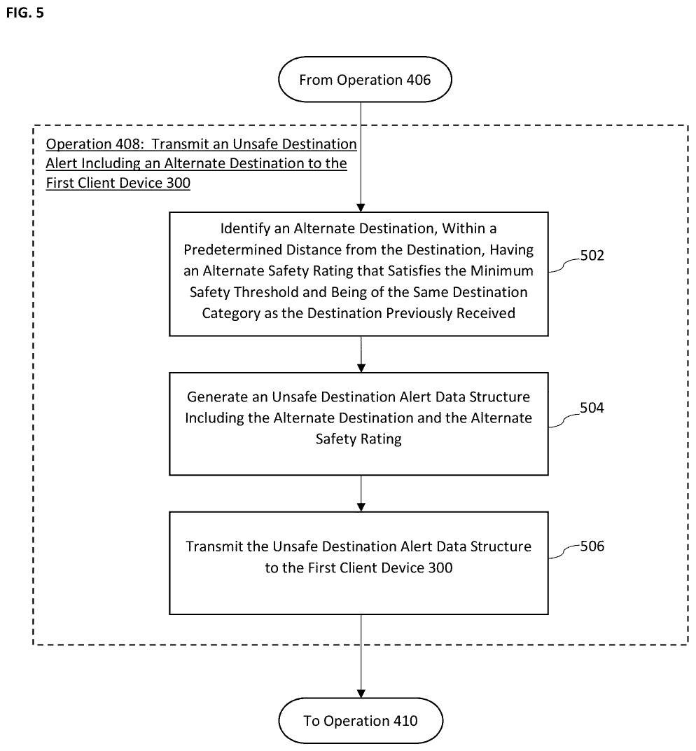

In operation 408, the server system 101 transmits an unsafe destination alert to the first client device 300. In some embodiments, the unsafe destination alert may include an alternate destination, an embodiment of which is discussed below with reference to FIG. 5. Once the first client device 300 has received the unsafe destination alert data structure, the first client device 300 may have the option to lower the minimum safety threshold (for only this particular instance and/or for all future navigation requests) so that the destination safety rating meets or exceeds the newly updated minimum safety rating as lowered (so that no rerouting is necessary in response to the destination safety rating having been less than the previously set minimum safety threshold), then the process 400 proceeds to operation 410. Additionally or alternatively, in some embodiments the user of the first client device 300 may have the option to select an alternate destination for use that would satisfy the minimum safety threshold as previously set or as updated. For example, a user may have selected a destination that is associated with a known category of destinations (e.g., coffee shops, gas stations, etc.), and upon a determination that an alternative destination associated with the same category satisfies the minimum safety threshold and is located within a predetermined distance from the destination, the user may be given the option of rerouting to that alternative destination instead of the destination originally set. This rerouting may be accomplished, for example, by updating the destination to match the alternate destination. After the destination has been updated, the process 400 proceeds to operation 410.

In operation 410, the server system 101 may receive a preferred route type from the first client device 300. The preferred route type may be one of a safest route, a fastest route, a shortest route, and an optimized route. The safest route is a route having the highest route safety rating of a set of routes identified by the server system 101. The fastest route is a route having the shortest travel duration of a set of routes identified by the server system 101. The shortest route is a route having the shortest travel distance of a set of routes identified by the server system 101. The optimized route may be determined from a set of routes identified by the server system 101. More particularly, the optimized route may be determined based on or using a function of at least one of the route safety rating, the travel duration of the route, and the travel distance of the route.

In some embodiments, the optimized route may be determined by maximizing the function of the variables: route safety rating, travel duration, and travel distance. In other words, the function of the variables may be maximized (and thus the route may be optimized) when the combination of variables that are associated with the selected route include the best combination of the available variables (i.e., route safety rating, travel duration, and travel distance) of an identified set of routes. While the best combination of the available variables may preferably have the highest route safety rating, the shortest travel duration, and the shortest travel distance, it understood that the optimized route is not necessarily the safest route or the shortest route in terms of travel duration or travel distance. Rather, the optimized route may be the route which has the best overall combination of those variables, even though when viewing each of the variables in isolation, there may be safer or shorter (in terms of travel time or travel distance) routes. Statistical processes that determine a preferred and/or maximized combination of variables are known and would be readily applied by a person of ordinary skill in statistical analysis.

In some embodiments, the function may provide a predetermined weight (e.g., an importance factor or a multiplier) to at least one of the variables. By assigning predetermined weight(s), the function may also favor one of the variables over the remaining variables. For example, the function may favor a safer route (i.e., a route that has a higher route safety rating) over an alternative route that has a shorter travel duration and/or shorter travel distance. The route for which the function is maximized may be selected as the optimized route. Furthermore, when the server system 101 has received an indication of a minimum safety threshold as discussed above with regard to operation 404, the function may reject and not consider any route that does not satisfy the minimum safety threshold. In such a case, the user may be provided with an indication that one or more routes were rejected for not satisfying the minimum safety threshold. For example, the user may be provided with an indication that one or more routes having a shorter travel duration or shorter travel distance were identified but are not being displayed because they do not satisfy the minimum safety threshold. In that situation, the user may be provided with an option to override the minimum safety threshold and/or to select one of the rejected routes for use.

In some embodiments, the function that determines the optimized route may select the optimized route from a set of routes identified by the server system 101, such that the function maximizes the route safety rating of the optimized route while minimizing at least one of the travel duration and/or the travel distance of the optimized route. In some embodiments, the optimized route may be identified such that at least one of: (a) the travel duration of the optimized route is within a predetermined number of standard deviations away from a mean value of travel durations of the set of routes identified by the server system 101 or the travel duration is less than the mean value of durations of the set of routes identified by the server system 101; and (b) the travel distance of the optimized route is within a predetermined number of standard deviations away from a mean value of travel distances of the set of routes identified by the server system 101 or the travel distance is less than the mean value of distances of the set of routes identified by the server system 101. Alternatively, a predetermined percentage above or below the mean value of a particular value may be utilized instead of a predetermined number of standard deviations away from the mean value of the particular value.

In operation 412, the server system 101 may receive route safety options from the first client device 300. For example, the route safety options may include one or more of: an option to bypass roads without street lighting; an option to bypass roads not permitting commercial vehicle access; an option to bypass dirt roads; an option to bypass highways; and an option specifying a preferred road type for travel. The option specifying a preferred road type for travel may, for example, allow the user to select high-speed roads such as highways and freeways as being preferable for travel in contrast to low-speed roads such as local city streets.

In operation 414, the server system 101 identifies a first route between and including the starting location and the destination. In some embodiments, the identification of the first route may be based, at least in part, on: a preferred route type received from the first client device 300 in operation 410; route safety options received from the first client device 300 in operation 412; and/or the minimum safety threshold received from the first client device 300 in operation 404. In some embodiments, the first route may comprise one or more travel segments that each identify a portion of the first route. Further, in some embodiments, the identification of a particular travel segment may be based, at least in part, on: the preferred route type; the route safety options; and/or the minimum safety threshold.

In operation 416, the sever system 101 calculates a first safety rating for the first route. The first safety rating indicates an estimated likelihood of a traveler being put in danger while traveling along the first route. As discussed in greater detail below with reference to FIG. 6, in some embodiments, the first safety rating may be calculated based on at least one of a set of statistical resources and a set of user ratings (i.e., user-provided safety ratings, such as a new rating as discussed below with regard to operation 432).

In some embodiments, the set of statistical resources may be further divided into a set of positive statistical resources and a set of negative statistical resources. Further, the set of positive statistical resources may include those statistical resources that provide data or metrics that correlate with improved safety conditions, i.e., a reduced estimated likelihood of a traveler along the route being put in danger. Further, the set of negative statistical resources may include those statistical resources that provide data or metrics that correlate with worsened safety conditions, i.e., an increased estimated likelihood of a traveler along the route being put in danger.

In some embodiments, the set of user rating may be further divided into a set of recent user ratings and a set of historical user ratings. Further, the set of recent user ratings may include those user ratings that were provided within a predetermined period of time and the set of historical user ratings may include those user ratings that were provided outside of the predetermined period of time. For example, the predetermined period of time may be equal to 2 weeks, such that a recent user rating is one that has been provided within 2 weeks from the present date and time, and a historical user rating is one that has been provided outside of the 2 week period (i.e., at a date and time earlier than 2 weeks from the present).

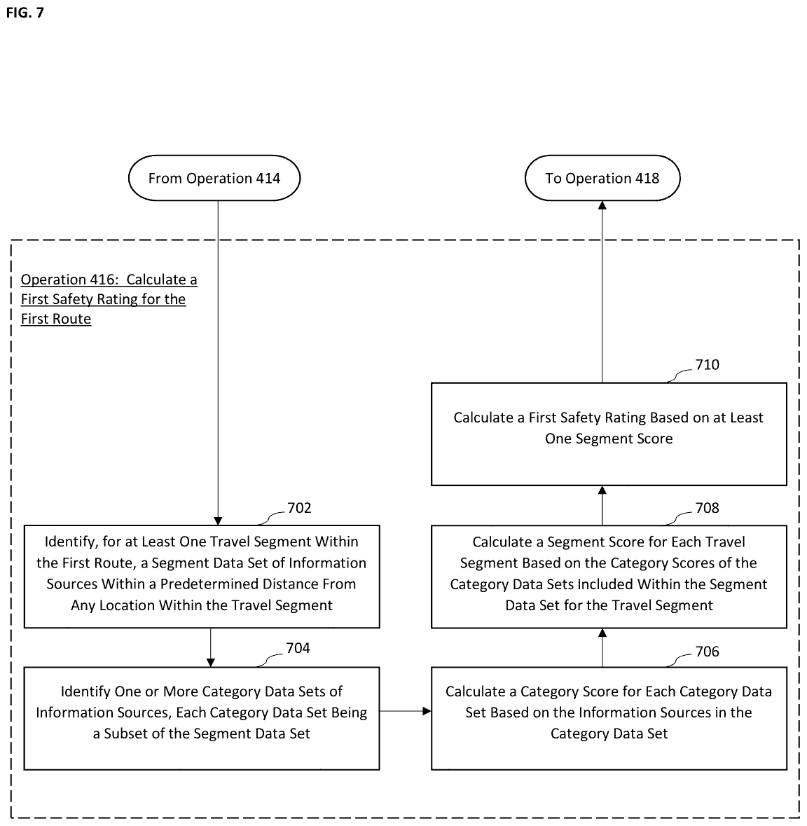

In some embodiments, the first route may comprise one or more travel segments that each identify a portion of the first route and the first safety rating may be calculated based at least on one or more segment safety ratings. Each segment safety rating may be associated with a particular travel segment and indicates the estimated likelihood of a traveler being put in danger while traveling along the travel segment. As discussed in greater detail below with reference to FIG. 7, in some embodiments, the first safety rating for the first route (in its entirety) may be calculated based at least on the one or more segment safety ratings (also referred to as ‘segment scores’ in FIG. 7). Further, each of the segment safety ratings may be calculated based on at least one of a set of user ratings and a set of statistical resources, as discussed in greater detail below with reference to FIG. 7.

A safety rating may be represented by, for example, a numerical figure, a color, and/or any visual, audible, tactile, or other indicia or form of representation that is capable of providing the user of the client device 300 with information, or any combination thereof. For example, audible and/or tactile indicia may be preferred by visually impaired users. In some embodiments, the safety rating may be represented by a numerical figure between 0.0 and 10.0. For example, 0.0 may represent the lowest possible safety rating (i.e., least safe), 10.0 may represent the highest possible safety rating (i.e., most safe), and numerical figures between 0.0 and 10.0 may represent intermediate safety ratings therebetween. In some embodiments, the first safety rating may be represented by a color. For example, red may represent the lowest possible safety rating (i.e., least safe), green may represent the highest possible safety rating (i.e., most safe), and a color gradient between red and green may represent intermediate safety ratings therebetween. The color gradient between red and green may contain different shades of yellow (i.e., a mixture of red and green), in which darker yellows may represent intermediate safety ratings closer to red and increasingly lighter yellows may represent intermediate safety ratings closer to green. Alternatively, a gradient of another color besides yellow, such as magenta, may be used to represent intermediate safety ratings.

In operation 418, the server system 101 determines whether the first safety rating associated with the first route satisfies the minimum safety threshold. When the first safety rating is calculated based on at least one segment score (as discussed below with regard to operation 710), in some embodiments a determination that the first safety rating satisfies the minimum safety threshold is contingent upon a determination that each of the segment scores upon which the first safety rating is based also satisfy the minimum safety threshold. Upon a positive determination that the first safety rating meets or exceeds the minimum safety threshold, the process 400 proceeds to operation 420. Otherwise, upon a negative determination that the first safety rating does not meet or exceed the minimum safety threshold, the process 400 proceeds to operation 422.

In operation 420, the server system 101 generates and transmits a first data structure that includes an indication of the first route and an indication of the first safety rating, to the first client device 300. In some embodiments, the first data structure may also include additional information items. The additional information items may contain data concerning the first route or any portion thereof, the first safety rating, and/or the destination. For example, such additional information items may include a warning about a dangerous portion of the first route (e.g., “many recent carjackings in this area”), additional explanation about the first safety rating (e.g., “the safety rating for this area has declined 50% in the last month” (which may be indicative of a spate of recent crimes)), or a warning about the destination (e.g., “fire reported close to the destination”).

In operation 422, the server system 101 transmits a request to the first client device 300 for a safety override approval.

In operation 424, the server system 101 determines whether a safety override approval that is affirmative has been received from the first client device 300. Upon a positive determination that a safety override that is affirmative has been received, the process 400 proceeds to operation 420. Otherwise, upon a negative determination that a safety override approval that is affirmative has not been received, the process 400 proceeds to operation 426.

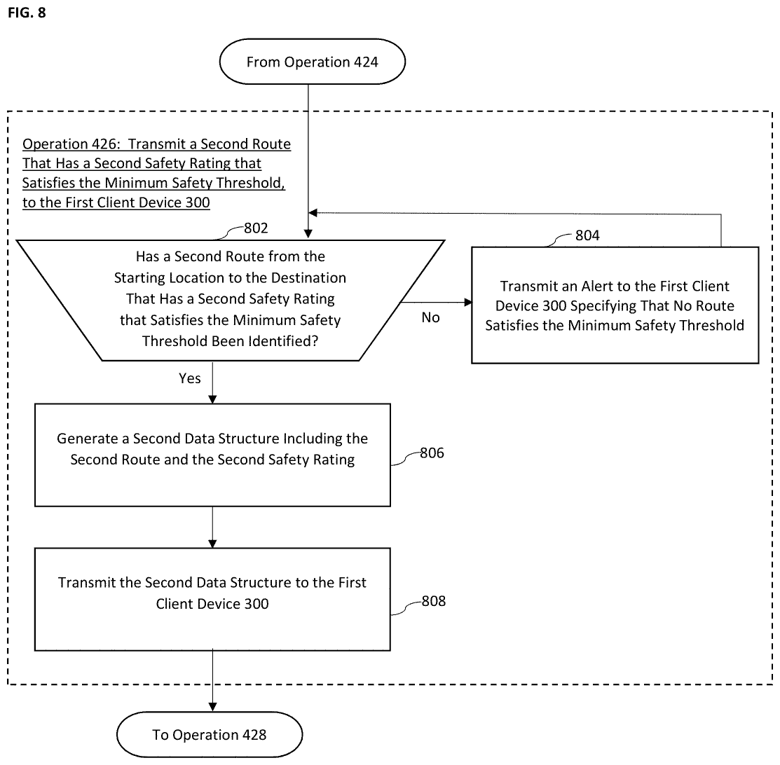

In operation 426, the server system 101 generates and transmits a second data structure that includes an indication of a second route and an indication of a second safety rating, to the first client device 300, an embodiment of which is discussed below with reference to FIG. 8. The second route is between and including the starting location and the destination. In that regard, the second route is an alternative to the first route as they share the same starting and ending points. The second safety rating that is associated with the second route satisfies the minimum safety threshold and indicates an estimated likelihood of a traveler along the second route being put in danger. The second safety rating may be calculated in a substantially similar manner as to how the first safety rating is calculated, two embodiments of which are discussed below with reference to FIGS. 6-7.

In some embodiments, the second data structure may also include additional information items. The additional information items may contain data concerning the second route or any portion thereof, the second safety rating, and/or the destination. For example, such additional information items may include a warning about a dangerous portion of the second route (e.g., “many recent carjackings in this area”), additional explanation about the second safety rating (e.g., “the safety rating for this area has declined 50% in the last month” (which may be indicative of a spate of recent crimes)), or a warning about the destination (e.g., “fire reported close to the destination”).

In operation 428, the server system 101 determines whether the first client device 300 (or the user of the first client device 300) has commenced travel along the route last transmitted to the first client device 300. The route last transmitted to the first client device 300 may be, for example, the first route (see operation 420) or the second route (see operation 426) depending on the operations previously performed by the process 400. Upon a negative determination that the first client device 300 (or the user of the first client device 300) has not commenced travel, operation 428 is repeated again. Otherwise, upon a positive determination that the first client device 300 (or the user of the first client device 300) has commenced travel, the process 400 proceeds to operation 430.

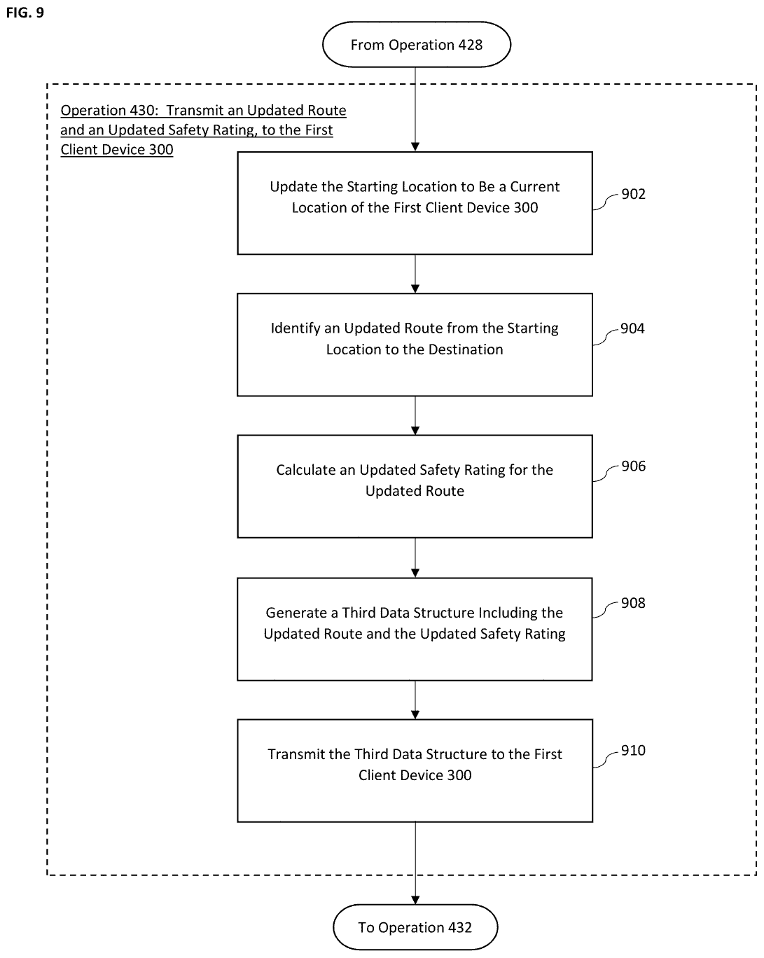

In operation 430, the server system 101 generates and transmits a third data structure that includes an indication of an updated route and an indication of an updated safety rating, to the first client device 300 in response to a predetermined condition, an embodiment of which is discussed below with reference to FIG. 9. The predetermined condition may include, but is not limited to, the following examples: (a) a predetermined time interval having elapsed; (b) an expiration of a timer; (c) a periodic or random execution of the operation; (d) an occurrence of an action or the detection of a state, which may for example include a detection that the first client device 300 has commenced travel and/or has traveled a predetermined distance along the route; (e) a report safety condition request having been received from the first client device 300 (as described in more detail below with respect to operation 448) when the condition location is within a predetermined distance from the presently traveled route; and (f) the identification of a live danger condition by the server system 101 (as described in more detail below with regard to operation 440) when the live danger location is within a predetermined distance from the presently traveled route.

The updated route is between and including the current location of the first client device 300 (or the user of the first client device 300) and the destination. The updated safety rating satisfies the minimum safety threshold and indicates an estimated likelihood of a traveler along the updated route being put in danger. The updated safety rating may be calculated in a substantially similar manner as to how the first safety rating is calculated, two embodiments of which are discussed below with reference to FIGS. 6-7. In some instances, the updated route may identify a remaining portion of a route presently traveled by the first client device 300 (or the user of the first client device 300) that has not yet been completed. The route presently traveled may be, for example, the first route (see operation 420) or the second route (see operation 426) depending on the operations previously performed by the process 400. In some instances, the updated route may be different than the remaining portion of the route presently traveled while still sharing the same starting and ending points. In that situation, the updated route is an alternative to the remaining portion of the route presently traveled as they share the same starting and ending points.

In some embodiments, the third data structure may also include additional information items. The additional information items may contain data the updated route or any portion thereof, the updated safety rating, and/or the destination. For example, such additional information items may include a warning about a dangerous portion of the updated route (e.g., “many recent carjackings in this area”), additional explanation about the updated safety rating (e.g., “the safety rating for this area has declined 50% in the last month” (which may be indicative of a spate of recent crimes)), or a warning about the destination (e.g., “fire reported close to the destination”).

In operation 432, the server system 101 receives an indication of a new rating and an indication of a new rating location associated with the new rating, from a reporting client device 300 (or a user of the reporting client device 300). The new rating indicates an estimated likelihood of a traveler at the new rating location being put in danger, as determined by the reporting client device 300 (or the user of the reporting client device 300). The new rating location may be, for example, a current location of the reporting client device 300 (or a user of the reporting client device 300). In some embodiments, the reporting client device 300 and the first client device 300 may refer to the same client device 300. In other embodiments, the reporting client device 300 and the first client device 300 may refer to two distinct client devices 300.

In operation 434, the server system 101 updates a set of user ratings to include the new rating. The set of user ratings may be employed during the calculation of a safety rating for a specific location, a route, or a segment of the route. Two embodiments of the calculation of a safety rating are discussed below with reference to FIGS. 6-7.

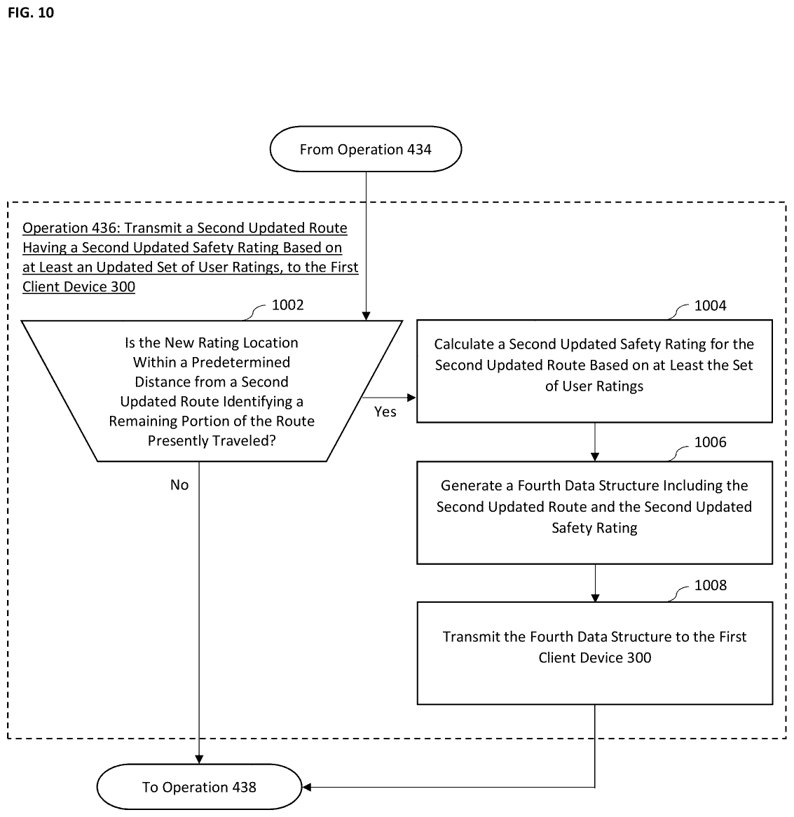

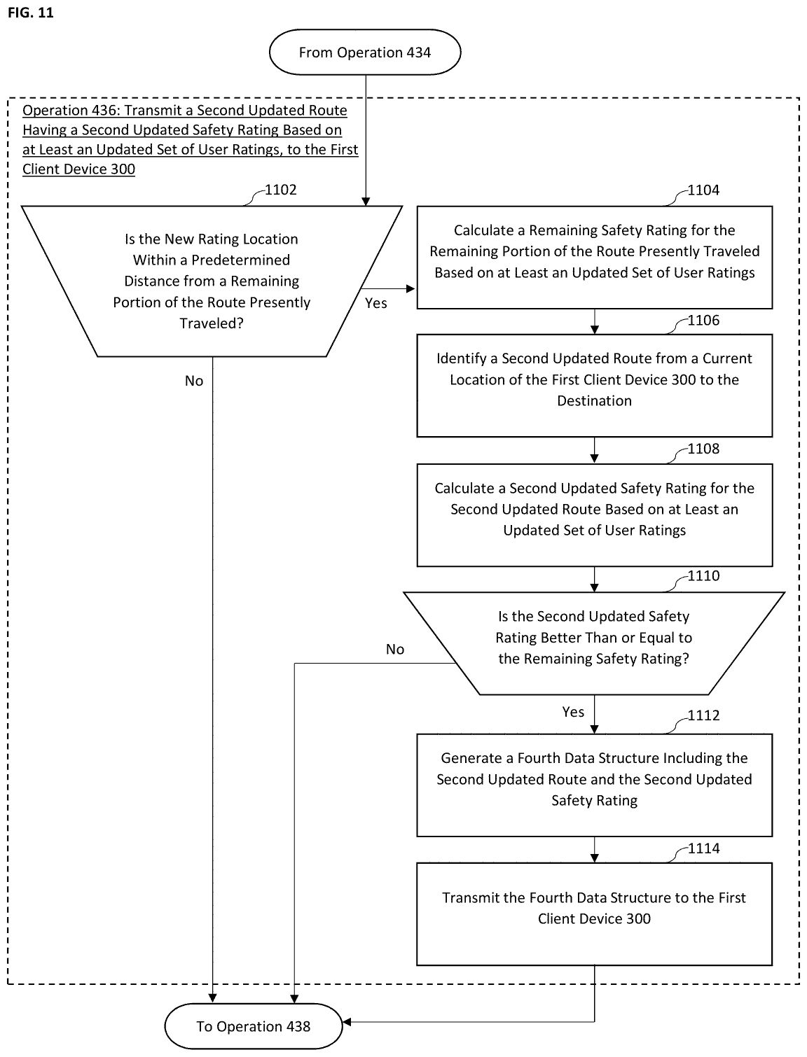

In operation 436, the server system 101 generates and transmits a fourth data structure that includes an indication of a second updated route and an indication of a second updated safety rating, to the first client device 300 when predetermined conditions are satisfied, two embodiments of which are discussed below with reference to FIGS. 10-11. The second updated safety rating indicates an estimated likelihood of a traveler along the second updated route being put in danger. The second updated safety rating may be calculated in a substantially similar manner as to how the first safety rating is calculated, two embodiments of which are discussed below with reference to FIGS. 6-7.

The second updated safety rating is based at least in part on the set of user ratings, which may have been updated to include the new rating discussed above with regard to operation 432. In some instances, the second updated route may identify a remaining portion of a route presently traveled by the first client device 300 (or the user of the first client device 300) that has not yet been completed, as discussed in greater detail below with reference to FIG. 10. The route presently traveled may be, for example, the first route (see operation 420), the second route (see operation 426), or the updated route (see operation 430) depending on the operations previously performed by the process 400. In some instances, the second updated route may be different than the remaining portion of the route presently traveled while still sharing the same starting and ending points, as discussed in greater detail below with reference to FIG. 11. In that situation, the second updated route is an alternative to the remaining portion of the route presently traveled as they share the same starting and ending points.

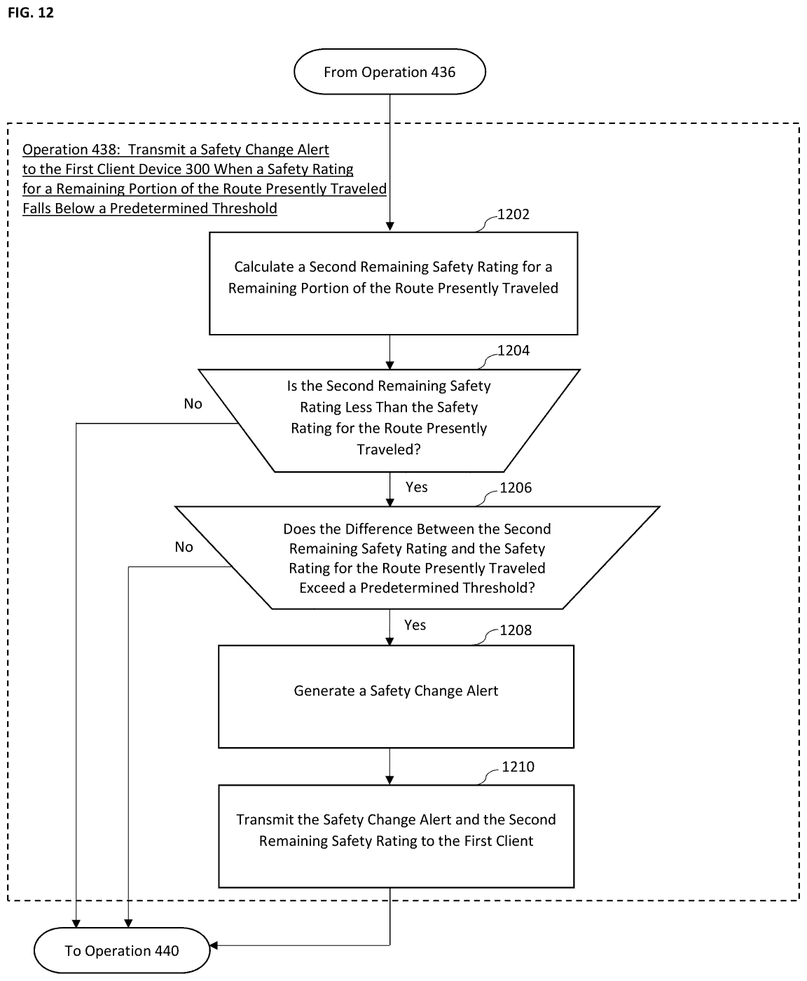

In operation 438, the server system 101 transmits a safety change alert to the first client device 300 when a safety rating for a remaining portion of a route presently traveled by the first client device 300 (or the user of the first client device 300) falls below a predetermined threshold, an embodiment of which is discussed below with reference to FIG. 12. The route presently traveled may be, for example, the first route (see operation 420), the second route (see operation 426), the updated route (see operation 430), or the second updated route (see operation 436) depending on the operations previously performed by the process 400. For example, when the route presently traveled is the second updated route, the predetermined threshold may be set to 20% below the second updated safety rating. Further, in such a situation if the second updated safety rating has a value of 5, then this results in the predetermined threshold having a value of 4 (i.e., 20% below 5). Therefore, the safety change alert is transmitted when the safety rating for a remaining portion of the second updated route falls below the value of 4.

In operation 440, the server system 101 identifies a live danger condition and a live danger location associated with the live danger condition. The live danger condition may be identified from any suitable source of news, weather, or criminal activity information, such as: a public, private, and/or governmental news service; a public, private, and/or governmental weather service; a public, private, and/or governmental service including criminal activity; and a client device 300 (or a user of the client device 300) as discussed below. Examples of a live danger condition may include: (a) criminal activity such as carjackings and gun violence; (b) unsafe road conditions such as icy roads, a lack of street lighting, and a multi-vehicle collision; (c) severe weather such as a tornado, a fire, and a flood; and (d) other unsafe conditions that may affect a traveler.

A live danger condition may be received from the client device 300 (or the user of the client device 300) via a crowdsourcing model that utilizes report safety condition requests and SOS requests received by the server system 101. For example, the server system 101 may receive a report safety condition request from the client device 300 that involves an unsafe condition, a criminal activity, or a severe weather condition, as discussed in greater detail below with regard to operation 448. The server system 101 may then determine whether or not the report safety condition request concerns a live danger condition. In another example, the server system 101 may receive an SOS request from the client device 300, as discussed in greater detail below with regard to operation 444. The server system 101 may then determine whether or not the SOS request concerns a live danger condition. Consequently, the server system 101 may identify a live danger condition from the client device 300 (or the user of the client device 300) via a crowdsourcing model that utilizes report safety condition requests and SOS requests received by the server system 101.

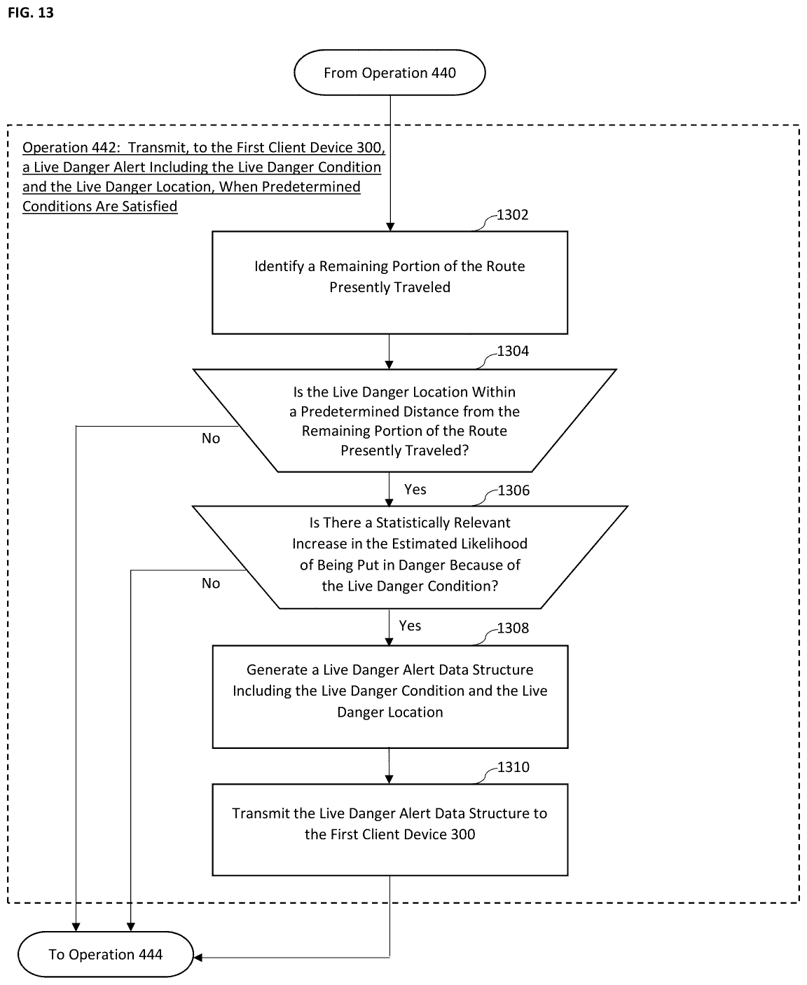

In operation 442, the server system 101 generates and transmits a live danger alert including an indication of the live danger condition and an indication of the live danger location, to the first client device 300, when predetermined conditions are satisfied. The predetermined conditions employed by some embodiments are discussed in greater detail below with reference to FIG. 13.

In operation 444, the server system 101 receives an indication of an SOS request from the first client device 300 (or a user of the first client device 300). The SOS request may be at least one of: (a) a request to contact emergency services; (b) a request to contact an emergency contact; and (c) a request to activate an alarm. In some embodiments, the SOS request may also be a user-defined customized request as determined by the first client device 300 (or the user of the first client device 300). In some embodiments, the SOS request may also include additional information items. The additional information items may include at least one of a user identification, a vehicle identification, a last known location of the first client device 300 (or the user of the first client device 300), a description of the reasons for the SOS request, information regarding an emergency contact including contact information, and/or other information relevant to the SOS request.

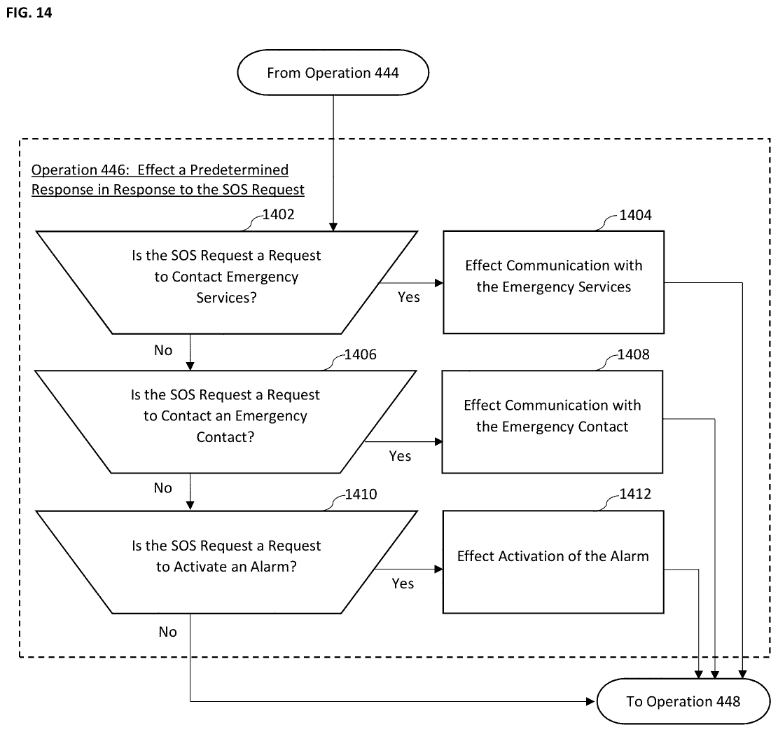

In operation 446, the server system 101 effects a predetermined response in response to the SOS request, an embodiment of which is discussed below with reference to FIG. 14. Additionally or alternatively, the server system 101 may determine that the SOS request concerns a live danger condition and may proceed with operation 442 as part of the predetermined response. In one instance, the predetermined response of the server system 101 may be to effect communication with emergency service in response to receiving an SOS request to contact emergency services. In some embodiments, the predetermined response (e.g., effecting communication with emergency services) may also include additional information items. The additional information items may include at least one of a user identification, a vehicle identification, a last known location of the first client device 300 (or the user of the first client device 300), a description of the reasons for the SOS request, information regarding an emergency contact including contact information, a waypoint stop (e.g., a service station, a gas station, etc.) within a predetermined distance from the first client device 300 (or a user of the first client device 300), and/or other information relevant to the SOS request.

In operation 448, the server system 101 receives an indication of a report safety condition request from the first client device 300 (or a user of the first client device 300). The report safety condition request may be one of: (a) a request to report an unsafe condition; (b) a request to report criminal activity; and (c) a request to report a severe weather condition. In some embodiments, the report safety condition request may also be a user-defined customized request as determined by the first client device 300 (or the user of the first client device 300). In some embodiments, the report safety condition request may also include identifying information. The identifying information may include at least one of a condition type (e.g., carjacking), a condition location, a condition description, a user identification, a vehicle identification, and/or other information relevant to the report safety condition request.

It should be understood that the term “request” when referring to any of the above report safety condition requests should not necessarily be construed as a request by the first client device 300 (or a user of the first client device 300) to effect any particular action or response for, or on behalf of, the first client device 300 (or a user of the first client device 300). Rather, the term “request” should be construed more generally as either being only a report or additionally as a request in the ordinary sense of the word. In particular, the intent of the first client device 300 (or a user of the first client device 300) may simply be to report a safety condition without requesting any particular action or response for, or on behalf of, the first client device 300 (or a user of the first client device 300). Nonetheless, such a report safety condition request may result in the server system 101 taking action in response thereto that impacts the first client device 300 (or a user of the first client device 300) that made the request. In such a situation, the term “request” is used in the ordinary sense of the word.

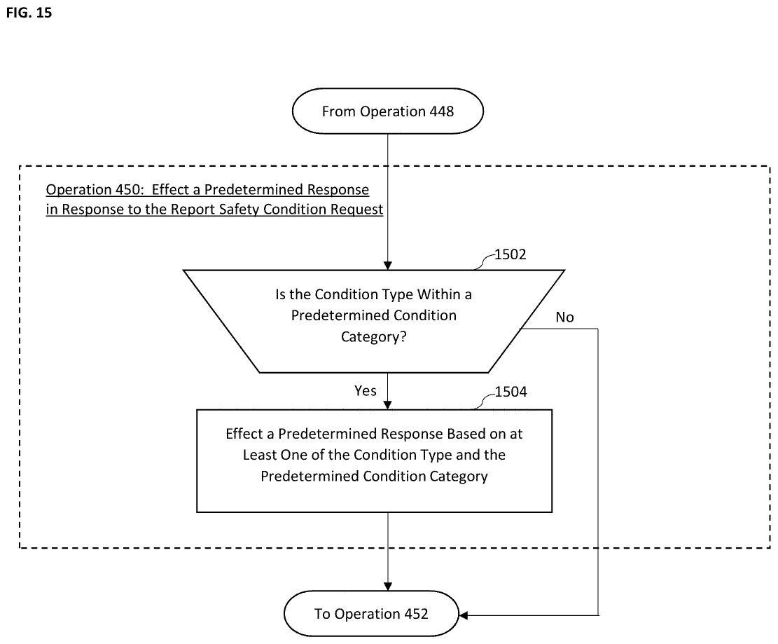

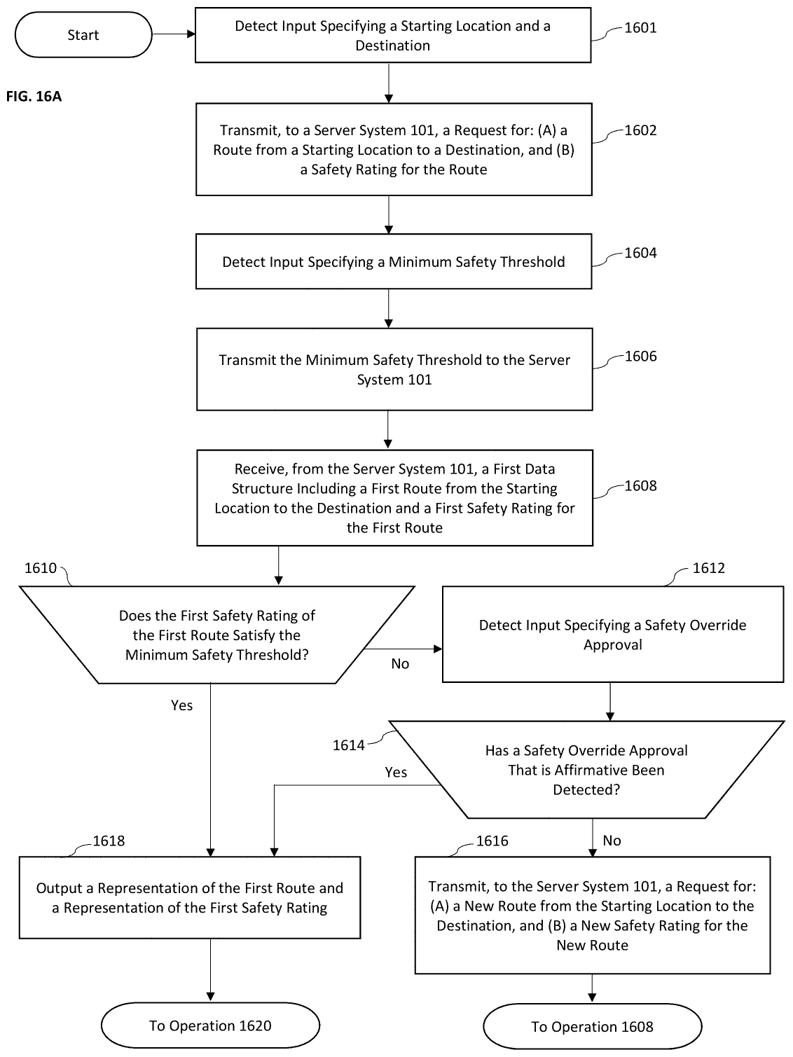

In operation 450, the server system 101 effects a predetermined response in response to the report safety condition request, an embodiment of which is discussed below with reference to FIG. 15 for some embodiments. Additionally or alternatively, the server system 101 may determine that the report safety condition request concerns a live danger condition and may proceed with operation 442 as part of the predetermined response. In one instance, the predetermined response of the server system 101 may be to effect communication with emergency service in response to receiving a report safety condition request indicating that a building is on fire. In some embodiments, the predetermined response (e.g., effecting communication with emergency services) may also include identifying information. The identifying information may include at least one of a condition type (e.g., carjacking), a condition location, a condition description, a user identification, a vehicle identification, a waypoint stop (e.g., a service station, a gas station, etc.) within a predetermined distance from the first client device 300 (or a user of the first client device 300), and/or other information relevant to the report safety condition request.

In operation 452, the server system 101 determines whether the first client device 300 (or the user of the first client device 300) has completed travel to the destination. Upon a negative determination that the first client device 300 (or the user of the first client device 300) has not yet completed travel to the destination, the process 400 proceeds to operation 430.

With reference to FIG. 5, a flowchart is depicted of an embodiment of a subprocess associated with transmitting an unsafe destination alert to the first client device 300 as shown by operation 408 in FIG. 4A, according to aspects of the disclosure. In this embodiment, operation 408 may include the following subtasks: identifying an alternate destination (operation 502); generating an unsafe destination alert including the alternate destination (operation 504); and transmitting the unsafe destination alert to the first client device 300 (operation 506).

In operation 502, the server system 101 identifies an alternate destination that satisfies a set of predetermined conditions. A first predetermined condition is that the alternate destination must be within a predetermined distance from the destination. For example, the predetermined distance may be 10 miles, such that the alternate destination must be within 10 miles from the destination. A second predetermined condition is that the alternate destination and the destination (e.g., as previously received in operation 402) must share the same destination category. For example, if the destination is associated with the destination category of “coffee shop,” then the alternate destination must also be associated with the destination category of “coffee shop.” A third predetermined condition is that a safety rating for the alternate destination (i.e., an alternate safety rating) must meet or exceed the minimum safety threshold. The alternate safety rating indicates an estimated likelihood of a traveler at the alternate destination being put in danger.

The alternate safety rating may be calculated in a substantially similar manner to how a path point score is calculated, as described in detail below with reference to FIG. 6 in which the path point score is used during the calculation of a route safety rating. In particular, the destination safety rating may be a path point score determined at a location that is an end point (which may be an intermediate waypoint or the final destination) of the route.

In operation 504, the server system 101 generates an unsafe destination alert data structure that includes an indication of the alternate destination and an indication of the alternate safety rating. In some embodiments, the unsafe destination alert data structure may also include additional information about the alternate destination. For example, such additional information about the alternate destination may include its name, its location, a description of the alternate destination, a rating about the alternate destination, a review of the alternate destination, and other information that may be useful when determining whether or not to proceed to the alternate destination.

In operation 506, the server system 101 transmits the unsafe destination alert data structure to the first client device 300. Once the first client device 300 has received the unsafe destination alert data structure, the first client device 300 may have the option to lower the minimum safety threshold (for only this particular instance and/or for all future navigation requests) so that the destination safety rating (for the destination previously received in operation 402) meets or exceeds the newly updated minimum safety rating as lowered (so that no rerouting is necessary in response to the destination safety rating having been less than the previously set minimum safety threshold). Additionally or alternatively, in some embodiments the user of the first client device 300 may have the option of rerouting to that alternative destination instead of the destination (e.g., as previously received in operation 402). This rerouting may be accomplished, for example, by updating the destination to match the alternate destination.

With reference to FIG. 6, a flowchart is depicted of an embodiment of a subprocess associated with calculating a first safety rating for the first route as shown by operation 416 in FIG. 4B, according to aspects of the disclosure. In this embodiment, operation 416 may include the following subtasks: identifying, for at least one path point, a point data set of information sources (operation 602); identifying one or more category data set of information sources (operation 604); calculating a category score for each category data set (operation 606); calculating a path point score for each path point (operation 608); and calculating a first safety rating based on at least one path point score (operation 610).

Each information source may each include a data value, a data importance factor, a data category, and a geographic zone. The data value of an information source may be a numerical representation of data provided by the information source. The data importance factor may be assigned to each information source and may indicate a degree of significance associated with the data value. The data category of the information source may be a user rating or a statistical resource. The geographic zone of an information source indicates a geographic area that is associated with the information source.

The data value of an information source may be a numerical representation of data provided by the information source. Further, the data provided by an information source may be normalized, such that the data from disparate information sources are of similar scale and/or similar units of measure so that the data may be easily and meaningfully applied to calculate a safety rating. Moreover, while the disparate information sources may each provide meaningful data or a metric related to safety, if the disparate information sources are of different scales or units of measure, they would not be as readily combinable into a singular representative value that would be utilized during the calculation of the safety rating.

Advantageously, disparate types of data may be normalized through active manipulation and transformation such that the data can be readily used and applied when calculating the safety rating. In contrast, the data in its original raw form (i.e., not manipulated or transformed as described herein) would not be as easily or readily combinable to derive a singular representative value that would be utilized during the calculation of the safety rating as described herein. Furthermore, the data in its original raw form (e.g., 100 murders annually in a large populous city) may provide a misleading and/or statistically irrelevant benchmark for the safety of a traveler without such transformation of the original raw data into something that is more meaningful to the safety of the traveler and/or safe navigation. In other words, the original raw data is transformed into a numerical representation that provides a meaningful value related to safety based on the raw data as well as predetermined criteria. For example, ‘X’ number of incidents per ‘Y’ number of people in a geographical area may be transformed into a corresponding numerical value ‘Z,’ whereby ‘Z’ provides a more usable and meaningful assessment of safety than was provided by the original raw data.

Accordingly, the normalization of the data provided by the information sources includes active manipulation and transformation of the data into a readily usable and applicable format, as discussed further below. Some data from an information source may be provided as a numerical value having a corresponding unit of measure. For example, one type of data at issue may be a crime statistic that is measured as a number of criminal incidents on an annual per capita basis. Another type of data at issue may be a user-provided safety rating received from a user of the first client device 300 (i.e., a new rating, as discussed in more detail above with reference to operation 432. The user-provided safety rating may be measured on an integer scale, for example from 0 to 10 with 0 being the worst rating and 10 being the best rating. The crime statistic may be transformed to a numerical representation on an equivalent integer scale (e.g., 0 to 10), so that the crime statistic may be more readily combinable with other data, such as the user-provided safety rating, in order to create an easily usable and understandable singular value that may be employed during the calculation of a safety rating.

In some embodiments, for example, such a transformation of the crime statistic may be performed by a data mapping of a plurality of ranges of values to singular integer values representing each range. In other words, each range is transformed into an integer value, for example as shown on Table 1 below. The range of 0-10 criminal incidents per 1000 people on an annual basis may be transformed to an integer value of 10, representing the best value on the 0 to 10 scale. The range of 11-20 criminal incidents per 1000 people on an annual basis may be transformed to an integer value of 9 on the 0 to 10 scale. Similarly, 101 or more criminal incidents per 1000 people on an annual basis may be transformed to an integer value of 0, representing the worst value on the 0 to 10 scale. Various ranges of criminal incidents on annual per capita basis may be similarly transformed to integer values on the same 0 to 10 scale. The particularly assigned integer values described above (i.e., 0 to 10) are merely illustrative as other integer values may be assigned. Further, the particularly assigned integer values may be predetermined based on the type or category of the data being transformed to those assigned integer values. Additionally or alternatively, the range of number of incidents for an assigned integer value may be predetermined based on the type or category of the data being transformed to that assigned integer value. Although the transformation described herein utilized an assigned integer value, it is within the scope and spirit of the present disclosure that any numerical representation can be utilized for such a transformation, including for example, integers, decimals, fractions, and/or mixed numbers.

TABLE 1
Transformation of a Crime Statistic into an
Integer Numerical Representation

| Range of Criminal Incidents per | Numerical Representation on |
|---|---|
| 1000 People on an Annual Basis | an Integer Scale from 0 to 10 |
| 0-10 | 10 |
| 11-20 | 9 |
| . . . | . . . |
| 101 or more | 0 |

The data importance factor is assigned to an information source and indicates a degree of significance associated with the data value. Moreover, a higher data importance factor may indicate that a data value has greater significance than another data value associated with a lower data importance factor. The data importance factor may take into account considerations such as: the age or date of the data value; the data value's relevance to the safety of a traveler along a route; the credibility of the information source from which the data value was obtained; the traveler's means of transportation (as discussed further below); the type of thoroughfares that are commuted upon (as discussed further below); etc. For example, a data value concerning the number of automobile accidents per month on a particular street may be deemed to have more relevance to the safety of the traveler than another data value concerning the number of traffic tickets for an illegal U-turn per month on the same street. In such a situation, the data value concerning the number of automobile accidents per month on the particular street may have a higher data importance factor than the data value concerning the number of traffic tickets for an illegal U-turn per month on the same street.

In some embodiments, the data importance factor may also be based at least in part on the traveler's means of transportation (e.g., car, bus, train, semi-trailer truck, bicycle, motorcycle, pedestrian, etc.). Additionally, in some embodiments the drive layout (e.g., front-wheel drive, rear-wheel drive, all-wheel drive, four-wheel drive, eight-wheel drive, H-drive, etc.) may also be taken into consideration when the data importance factor is based at least in part on the traveler's means of transportation. For example, a data value concerning the average wind speed at a particular location may have more relevance to the safety of a traveler (and thus have a higher associated data importance factor) when the traveler's means of transportation is a semi-trailer truck versus a car. Semi-trailer trucks have a propensity to flip over or rollover onto their side when exposed to high wind speeds, due to having a large lateral surface area that may function like a sail when exposed to high wind speeds. In contrast, a car has a much smaller lateral surface area that is significantly less impacted by high wind speeds, and consequently a car may be less likely to flip onto its side than a semi-trailer truck exposed to the same wind speed. Therefore, the data importance factor associated with a data value concerning the average wind speed at a particular location may be higher when the traveler is traveling by means of a semi-trailer truck than when traveling by means of a car.

In some embodiments, the data importance factor may also be based at least in part on the type of thoroughfares that are commuted upon while traveling along a route (e.g., local city street, highway, sidewalk, footpath, hiking trail, cycleway, waterway, etc.). Additionally, in some embodiments the aspects of a thoroughfare (e.g., speed limit; geometric design elements (e.g., profile, cross-section, alignment incl. curvature, etc.), type of surface (e.g., dirt, gravel, cobblestone, concrete, asphalt, composite, etc.), and the like) may also be taken into consideration when the data importance factor is based at least in part on the type of thoroughfares that are commuted upon. For example, a data value concerning the carjacking rate in a city may have more relevance to the safety of a traveler (and thus have a higher associated data importance factor) when traveling on local city streets versus traveling on a highway. When traveling on local city streets, there may be stop signs, traffic lights, and low speed limits that create opportunities for carjackings. In contrast, when traveling on a highway, there may be high-speed limits and stop signs and traffic lights may be bypassed, thus minimizing the opportunities for carjackings. Therefore, the data importance factor associated with the data value concerning the carjacking rate in a city may be higher when the traveler is commuting on local city streets than when the traveler is commuting on a highway.

The data category of an information source may be a user rating or a statistical resource. The data category of user rating is associated with an information source which provides data that is derived from a user-provided safety rating. The user-provided safety rating is a safety rating provided by a user of the first client device 300 (i.e., a new rating, as discussed in more detail above with reference to operation 432). In some embodiments, the set data category of user rating may be further divided into the set data category of recent user rating and the set data category of historical user rating. The data category of recent user rating is associated with an information source which provides data that is derived from a recent user-provided safety rating. The recent user-provided safety rating may be a safety rating provided by the user of the first client device 300 within a predetermined period of time. The data category of historical user rating is associated with an information source which provides data that is derived from a historical user-provided safety rating. The historical user-provided safety rating may be a safety rating provided by the user of the first client device 300 outside of the predetermined period of time.

Accordingly, the recent user-provided safety rating is a safety rating that has been provided at later date and time (i.e., more recently) than when the historical user-provided safety rating has been provided. For example, the predetermined period of time may be equal to 2 weeks, such that a recent user-provided safety rating is a safety rating that has been provided within 2 weeks from the present date and time, and a historical user-provided safety rating is a safety rating that has been provided outside of the 2 week period (i.e., at a date and time earlier than 2 weeks from the present). In some embodiments, the age of a user-provided safety rating may have an inverse relationship with the significance associated with that user-provided safety rating. In other words, the older a user-provided safety rating is from the present, the less relevance to the safety of a traveler along the route that this user-provided safety rating is deemed to have. Accordingly, the historical user-provided safety rating may have a lower associated data importance factor than the recent user-provided safety rating.

The data category of statistical resource is associated with an information source which provides data that is derived from a statistic that is correlated to safety. A statistic may be positively or negatively correlated to safety. In some embodiments, the set data category of statistical resource may be further divided into the set data category of positive statistical resource and the set data category of negative statistical resource. The data category of positive statistical resource is associated with an information source which provides data that is derived from a positive statistic that is correlated to safety. The positive statistic may be any data or metrics that correlate with improved safety conditions, i.e., a reduced estimated likelihood of a traveler along the route being put in danger. The data category of negative statistical resource is associated with an information source which provides data that is derived from a negative statistic that is correlated to safety. The negative statistic may be any data or metrics that correlate with worsened safety conditions, i.e., an increased estimated likelihood of a traveler along the route being put in danger.

Any statistic may be viewed as a positive statistic or a negative statistic depending on whether its data or metrics have been shown to be statistically relevant for improved or worsened safety conditions, respectively. For example, a higher than average statistic for per capita income level, employment rate, or average education level (e.g. based upon high school graduation rates, advanced degrees rates, etc.) may be, but is not necessarily, a positive statistic correlated with improved safety conditions at the location associated with that statistic. Conversely, a lower than average statistic for per capita income level, employment rate, or average education level may be, but is not necessarily, a negative statistic correlated with worsened safety conditions at the location associated with the statistic.

With respect to a statistic for criminal activity, it may be inferred that locations having a higher than average statistic for criminal activity are necessarily less safe (i.e., more dangerous) than locations having a lower than average statistic for criminal activity. Additionally, in some embodiments a statistic for a certain type of criminal activity may be more or less correlated with safety conditions depending on the traveler's means of transportation (which are discussed above) and/or the type of thoroughfares that are commuted upon (which are discussed above). Statistics for criminal activity may include, but are not limited to, data or metrics concerning homicide, forcible rape, violent crime, robbery, property crime, aggravated assault, burglary, larceny, theft, motor vehicle theft, firearm murders, firearm robberies, firearm assaults, motor vehicle violations (e.g., speeding tickets), drug overdose, and other crimes.

Statistics for travel conditions may include, but are not limited to, data or metrics concerning weather, temperature, ice formation, time of day, sunrise or sunset times, calendar date, season of the year, and other travel conditions that may impact safety. Such statistics for travel conditions may be correlated with improved or worsened safety conditions. For example, low temperatures and ice formation may be correlated with worsened safety conditions. Additionally, in some embodiments a statistic for a certain travel condition may be more or less correlated with safety conditions depending on the traveler's means of transportation (which are discussed above) and/or the type of thoroughfares that are commuted upon (which are discussed above). For example, ice formation may be more correlated with worsened safety conditions when the traveler's means of transportation is a motorcycle versus a car, since the additional wheels of the car may provide extra traction and grip on a road's surface which may in turn decrease the slipping effect of ice. In another example, traveling at a time of day after sunset (i.e., during the dark hours of the night) may be more correlated with worsened safety conditions when commuting upon a highway versus a local city street, since the high speeds of a highway may provide the traveler with less reaction time in an already limited visibility scenario.

In some embodiments, the server system 101 may provide a model for predicting improved or worsened safety conditions based at least in part on statistics for various travel conditions. In particular, the server system 101 may provide a numerical score based on the travel conditions and other factors relevant to safety. This numerical score may be utilized when determining and assigning the data importance factor for a particular information source. Additionally, in some embodiments, the data importance factor may also be based at least in part on a physics analysis and/or a simulated-driving analysis that analyzes the traveler's means of transportation (as discussed above), the type of thoroughfares that are commuted upon (as discussed above), and/or statistics for travel conditions including data related to weather (as discussed above).

The geographic zone of an information source indicates a geographic area associated with the information source. The geographic area associated with the information source delineates a geographic area of relevance for which the data value of the information source is relevant. As regards an information source having a data category of user rating, the geographic area of relevance for the data that is derived from a user-provided safety rating (as discussed above) may be the area within a predetermined distance from a location associated with the user-provided safety rating. The location associated with the user-provided safety rating is the new rating location, as discussed in more detail above with reference to operation 432). Therefore, the geographic zone for an information source having a data category of user rating may be the geographic area within a predetermined distance from the new rating location.

As regards an information source having a data category of statistical resource, the geographic area of relevance for the data that is derived from a statistic may include a preassigned territory specific to the statistic and an area within a predetermined distance from the preassigned territory. The preassigned territory for a statistic may be any suitable type of geographic identifier for locating and/or defining a geographic area including an address, a zip code, a municipality (e.g., a city, town, village, etc.), a neighborhood or district of a municipality, a state, a country, a specific location, a road or thoroughfare, a waterway, a location or region identified by GPS coordinates (e.g., latitude and longitude), etc. For example, the statistic may be a per capita income level in a zip code, the rate of carjackings in a district of a municipality, the employment rate in a state, the number of motor vehicle violations on a particular road, the average monthly temperature for a city, etc.

The predetermined distance may be specific to a particular statistic and based upon factors including the type of statistic (e.g., rate of homicide, average monthly temperature, etc.), the category of statistic (e.g., criminal activity, weather conditions, etc.), and a calculated affected area for which it has been determined that there is statistically relevant increase or decrease in the estimated likelihood of a traveler being put in danger due to the proximity of the traveler to the preassigned territory for the statistic. For example, the statistic for a rate of homicide in a zip code may have a predetermined distance of 1 mile, such that the geographic area of relevance includes the zip code and the area within 1 mile from the zip code. Therefore, the geographic zone for an information source having a data category of statistical resource may be the geographic area including a preassigned territory specific to a statistic and an area within a predetermined distance from the preassigned territory.

In operation 602, the server system 101 identifies, for at least one path point, a point data set including one or more information sources for each path point. Each path point identifies a location included within the first route. Each information source in the point data set has a geographic zone that is within a predetermined distance from the corresponding path point.

In operation 604, the server system 101 identifies one or more category data sets of information sources for each point data set. Each of the category data sets is a subset of the point data set. Each category data set has a set category and a category importance factor. The set category is one of a user rating and a statistical resource. In some embodiments, the set category of user rating may be further divided into the set category of recent user rating and the set category of historical user rating, as discussed above. In some embodiments, the set category of statistical resource may be further divided into the set category of positive statistical resource and the set category of negative statistical resource, as discussed above. Each category data set includes the one or more information sources in the point data set that have a data category that matches the set category of the category data set.

The category importance factor is assigned to the category data set and indicates a degree of significance associated with the set category. Moreover, a higher category importance factor may indicate that a set category has greater significance than another set category associated with a lower category importance factor. For example, in some embodiments, the set category of recent user rating may have a higher category importance factor than the set category of historical user rating. As another example, in some embodiments, the set category of positive statistical resource may have a higher category importance factor than the set category of negative statistical resource.

In operation 606, the server system 101 calculates a category score for each category data set. The category score may be calculated based on the information sources included within the category data set. In some embodiments, the category score may be calculated based on the data value (i.e., the data after active manipulation and transformation, such as the assigned integer values discussed above for example) and the data importance factor of at least one information source that is included within the category data set. For example, the category score may be based on a weighted average of the data values of the at least one data information source while using the data importance factors as the corresponding weights. In another example, the category score may be based on a weighted median of the data values of the at least one data information source while using the data importance factors as the corresponding weights.

In another example, regression analysis may be performed to determine the category score as a function of at least the data values and the data importance factors of the at least one data information source. Regression analysis, as would be understood by a person of ordinary skill in the field of statistics, is a powerful tool to analyze data, enabling the identification and characterization of relationships among multiple factors and the identification of relevant factors for calculating risk scores based on case specific circumstances. In particular, regression analysis may be beneficial to determine the causal relationship of particular ones of the data information sources upon the safety of a traveler who is traveling through particular locations and can facilitate a determination as to which factors may be the most relevant to safety, which factors to ignore, and which factors may be assigned a greater or lesser weight. It should be understood that such regression analysis may be utilized when analyzing any information source and calculating, assigning, or deriving any score or value from raw or manipulated data, as not all information or data is equally important in ascertaining safety or risk. For example, a regression analysis may be performed as described by John Fox in “Applied Regression Analysis, Linear Models, and Related Methods,” SAGE Publications Inc., 1998, and/or as described by David G. Kleinbaum et al. in “Applied Regression Analysis and Other Multivariable Methods,” 5th Edition, Cengage Learning, 2013, the contents of each of which are hereby incorporated by reference herein in their entireties.

In some embodiments, in order to determine which of the information sources included within the category data set to utilize during the calculation of the category score, a statistical analysis may be performed that would be known by statisticians to correct for outlier data or anomalous data through the removal of certain information sources from the calculation. For example, outlier data may include those information sources having a data value, a data importance factor, or a resultant combination thereof that is not included within a predetermined number of standard deviations from the mean of the respective population of values.

In operation 608, the server system 101 calculates a path point score for each path point. The path point score may be calculated based on the category data sets included within the point data set for the path point. The category data sets included within the point data set are those category data sets that are subsets of the point data set for the path point. In some embodiments, the path point score may be calculated based on the category score and the category importance factor of at least one category data set that is included within the point data set. For example, the path point score may be based on a weighted average of the category scores of the at least one category data set while using the category importance factors as the corresponding weights. In another example, the path point score may be based on a weighted median of the category scores of the at least one category data set while using the category importance factors as the corresponding weights.

In another example, regression analysis may be performed to determine the path point score as a function of at least the category scores and the category importance factors of the at least one category data set. Regression analysis, as would be understood by a person of ordinary skill in the field of statistics, is a powerful tool to analyze data, enabling the identification and characterization of relationships among multiple factors and the identification of relevant factors for calculating risk scores based on case specific circumstances. In particular, regression analysis may be beneficial to determine the causal relationship of particular ones of the category data sets upon the safety of a traveler who is traveling through particular locations and can facilitate a determination as to which factors may be the most relevant to safety, which factors to ignore, and which factors may be assigned a greater or lesser weight. It should be understood that such regression analysis may be utilized when analyzing any category data set. For example, a regression analysis may be performed as described by John Fox in “Applied Regression Analysis, Linear Models, and Related Methods,” SAGE Publications Inc., 1998, and/or as described by David G. Kleinbaum et al. in “Applied Regression Analysis and Other Multivariable Methods,” 5th Edition, Cengage Learning, 2013, the contents of each of which are hereby incorporated by reference herein in their entireties.

In some embodiments, in order to determine which of the category data sets included within the point data set to utilize during the calculation of the path point score, a statistical analysis may be performed that would be known by statisticians to correct for outlier data or anomalous data through the removal of certain category data sets from the calculation. For example, outlier data may include those category data sets having a category score, a category importance factor, or a resultant combination thereof that is not included within a predetermined number of standard deviations from the mean of the respective population of values.

In operation 610, the server system 101 calculates the first safety rating based on at least one path point score. In which each path point score has been calculated for a corresponding path point (as discussed above), and each path point identifies a location included within the first route (as discussed above). For example, the first safety rating may be based on an average of the at least one path point score. In another example, the first safety rating may be based on a median or mode of the at least one path point score.

In another example, regression analysis may be performed to determine the first safety rating as a function of at least the at least one path point score. Regression analysis, as would be understood by a person of ordinary skill in the field of statistics, is a powerful tool to analyze data, enabling the identification and characterization of relationships among multiple factors and the identification of relevant factors for calculating risk scores based on case specific circumstances. In particular, regression analysis may be beneficial to determine the causal relationship of particular ones of the path point scores upon the safety of a traveler who is traveling through particular locations and can facilitate a determination as to which factors may be the most relevant to safety, which factors to ignore, and which factors may be assigned a greater or lesser weight. It should be understood that such regression analysis may be utilized when analyzing any path point score. For example, a regression analysis may be performed as described by John Fox in “Applied Regression Analysis, Linear Models, and Related Methods,” SAGE Publications Inc., 1998, and/or as described by David G. Kleinbaum et al. in “Applied Regression Analysis and Other Multivariable Methods,” 5th Edition, Cengage Learning, 2013, the contents of each of which are hereby incorporated by reference herein in their entireties.

In some embodiments, in order to determine which of the path point scores to utilize during the calculation of the first safety rating, a statistical analysis may be performed that would be known by statisticians to correct for outlier data or anomalous data through the removal of certain path point scores from the calculation. For example, outlier data may include those path point scores that are not included within a predetermined number of standard deviations from the mean.

With reference to FIG. 7, a flowchart is depicted of an embodiment of a subprocess associated with calculating a first safety rating for the first route as shown by operation 416 in FIG. 4B, according to aspects of the disclosure. In this embodiment, operation 416 includes the following subtasks: identifying, for at least one travel segment, a segment data set of information sources (operation 702); identifying one or more category data set of information sources (operation 704); calculating a category score for each category data set (operation 706); calculating a segment score for each travel segment (operation 708); and calculating a first safety rating based on at least one segment score (operation 710).

Each information source may each include a data value, a data importance factor, a data category, and a geographic zone. The data value of an information source may be a numerical representation of data provided by the information source. The data importance factor may be assigned to each information source and may indicate a degree of significance associated with the data value. The data category of the information source may be a user rating or a statistical resource. The geographic zone of an information source indicates a geographic area that is associated with the information source.

The data value of an information source may be a numerical representation of data provided by the information source. Further, the data provided by an information source may be normalized, such that the data from disparate information sources are of similar scale and/or similar units of measure so that the data may be easily and meaningfully applied to calculate a safety rating. Moreover, while the disparate information sources may each provide meaningful data or a metric related to safety, if the disparate information sources are of different scales or units of measure, they would not be as readily combinable into a singular representative value that would be utilized during the calculation of the safety rating.

Advantageously, disparate types of data may be normalized through active manipulation and transformation such that the data can be readily used and applied when calculating the safety rating. In contrast, the data in its original raw form (i.e., not manipulated or transformed as described herein) would not be as easily or readily combinable to derive a singular representative value that would be utilized during the calculation of the safety rating as described herein. Furthermore, the data in its original raw form (e.g., 100 murders annually in a large populous city) may provide a misleading and/or statistically irrelevant benchmark for the safety of a traveler without such transformation of the original raw data into something that is more meaningful to the safety of the traveler and/or safe navigation. In other words, the original raw data is transformed into a numerical representation that provides a meaningful value related to safety based on the raw data as well as predetermined criteria. For example, ‘X’ number of incidents per ‘Y’ number of people in a geographical area may be transformed into a corresponding numerical value ‘Z,’ whereby ‘Z’ provides a more usable and meaningful assessment of safety than was provided by the original raw data.

Accordingly, the normalization of the data provided by the information sources includes active manipulation and transformation of the data into a readily usable and applicable format, as discussed further below. Some data from an information source may be provided as a numerical value having a corresponding unit of measure. For example, one type of data at issue may be a crime statistic that is measured as a number of criminal incidents on an annual per capita basis. Another type of data at issue may be a user-provided safety rating received from a user of the first client device 300 (i.e., a new rating, as discussed in more detail above with reference to operation 432. The user-provided safety rating may be measured on an integer scale, for example from 0 to 10 with 0 being the worst rating and 10 being the best rating. The crime statistic may be transformed to a numerical representation on an equivalent integer scale (e.g., 0 to 10), so that the crime statistic may be more readily combinable with other data, such as the user-provided safety rating, in order to create an easily usable and understandable singular value that may be employed during the calculation of a safety rating.

In some embodiments, for example, such a transformation of the crime statistic may be performed by a data mapping of a plurality of ranges of values to singular integer values representing each range. In other words, each range is transformed into an integer value, for example as shown on Table 2 below. The range of 0-10 criminal incidents per 1000 people on an annual basis may be transformed to an integer value of 10, representing the best value on the 0 to 10 scale. The range of 11-20 criminal incidents per 1000 people on an annual basis may be transformed to an integer value of 9 on the 0 to 10 scale. Similarly, 101 or more criminal incidents per 1000 people on an annual basis may be transformed to an integer value of 0, representing the worst value on the 0 to 10 scale. Various ranges of criminal incidents on annual per capita basis may be similarly transformed to integer values on the same 0 to 10 scale. The particularly assigned integer values described above (i.e., 0 to 10) are merely illustrative as other integer values may be assigned. Further, the particularly assigned integer values may be predetermined based on the type or category of the data being transformed to those assigned integer values. Additionally or alternatively, the range of number of incidents for an assigned integer value may be predetermined based on the type or category of the data being transformed to that assigned integer value. Although the transformation described herein utilized an assigned integer value, it is within the scope and spirit of the present disclosure that any numerical representation can be utilized for such a transformation, including for example, integers, decimals, fractions, and/or mixed numbers.

TABLE 2
Transformation of a Crime Statistic into an
Integer Numerical Representation

| Range of Criminal Incidents per | Numerical Representation on |
|---|---|
| 1000 People on an Annual Basis | an Integer Scale from 0 to 10 |
| 0-10 | 10 |
| 11-20 | 9 |
| . . . | . . . |
| 101 or more | 0 |

The data importance factor is assigned to an information source and indicates a degree of significance associated with the data value. Moreover, a higher data importance factor may indicate that a data value has greater significance than another data value associated with a lower data importance factor. The data importance factor may take into account considerations such as: the age or date of the data value; the data value's relevance to the safety of a traveler along a route; the credibility of the information source from which the data value was obtained; the traveler's means of transportation (as discussed further below); the type of thoroughfares that are commuted upon (as discussed further below); etc. For example, a data value concerning the number of automobile accidents per month on a particular street may be deemed to have more relevance to the safety of the traveler than another data value concerning the number of traffic tickets for an illegal U-turn per month on the same street. In such a situation, the data value concerning the number of automobile accidents per month on the particular street may have a higher data importance factor than the data value concerning the number of traffic tickets for an illegal U-turn per month on the same street.

In some embodiments, the data importance factor may also be based at least in part on the traveler's means of transportation (e.g., car, bus, train, semi-trailer truck, bicycle, motorcycle, pedestrian, etc.). Additionally, in some embodiments the drive layout (e.g., front-wheel drive, rear-wheel drive, all-wheel drive, four-wheel drive, eight-wheel drive, H-drive, etc.) may also be taken into consideration when the data importance factor is based at least in part on the traveler's means of transportation. For example, a data value concerning the average wind speed at a particular location may have more relevance to the safety of a traveler (and thus have a higher associated data importance factor) when the traveler's means of transportation is a semi-trailer truck versus a car. Semi-trailer trucks have a propensity to flip over or rollover onto their side when exposed to high wind speeds, due to having a large lateral surface area that may function like a sail when exposed to high wind speeds. In contrast, a car has a much smaller lateral surface area that is significantly less impacted by high wind speeds, and consequently a car may be less likely to flip onto its side than a semi-trailer truck exposed to the same wind speed. Therefore, the data importance factor associated with a data value concerning the average wind speed at a particular location may be higher when the traveler is traveling by means of a semi-trailer truck than when traveling by means of a car.

In some embodiments, the data importance factor may also be based at least in part on the type of thoroughfares that are commuted upon while traveling along a route (e.g., local city street, highway, sidewalk, footpath, hiking trail, cycleway, waterway, etc.). Additionally, in some embodiments the aspects of a thoroughfare (e.g., speed limit; geometric design elements (e.g., profile, cross-section, alignment incl. curvature, etc.), type of surface (e.g., dirt, gravel, cobblestone, concrete, asphalt, composite, etc.), and the like) may also be taken into consideration when the data importance factor is based at least in part on the type of thoroughfares that are commuted upon. For example, a data value concerning the carjacking rate in a city may have more relevance to the safety of a traveler (and thus have a higher associated data importance factor) when traveling on local city streets versus traveling on a highway. When traveling on local city streets, there may be stop signs, traffic lights, and low speed limits that create opportunities for carjackings. In contrast, when traveling on a highway, there may be high-speed limits and stop signs and traffic lights may be bypassed, thus minimizing the opportunities for carjackings. Therefore, the data importance factor associated with the data value concerning the carjacking rate in a city may be higher when the traveler is commuting on local city streets than when the traveler is commuting on a highway.

The data category of an information source may be a user rating or a statistical resource. The data category of user rating is associated with an information source which provides data that is derived from a user-provided safety rating. The user-provided safety rating is a safety rating provided by a user of the first client device 300 (i.e., a new rating, as discussed in more detail above with reference to operation 432). In some embodiments, the set data category of user rating may be further divided into the set data category of recent user rating and the set data category of historical user rating. The data category of recent user rating is associated with an information source which provides data that is derived from a recent user-provided safety rating. The recent user-provided safety rating may be a safety rating provided by the user of the first client device 300 within a predetermined period of time. The data category of historical user rating is associated with an information source which provides data that is derived from a historical user-provided safety rating. The historical user-provided safety rating may be a safety rating provided by the user of the first client device 300 outside of the predetermined period of time.

Accordingly, the recent user-provided safety rating is a safety rating that has been provided at later date and time (i.e., more recently) than when the historical user-provided safety rating has been provided. For example, the predetermined period of time may be equal to 2 weeks, such that a recent user-provided safety rating is a safety rating that has been provided within 2 weeks from the present date and time, and a historical user-provided safety rating is a safety rating that has been provided outside of the 2 week period (i.e., at a date and time earlier than 2 weeks from the present). In some embodiments, the age of a user-provided safety rating may have an inverse relationship with the significance associated with that user-provided safety rating. In other words, the older a user-provided safety rating is from the present, the less relevance to the safety of a traveler along the route that this user-provided safety rating is deemed to have. Accordingly, the historical user-provided safety rating may have a lower associated data importance factor than the recent user-provided safety rating.

The data category of statistical resource is associated with an information source which provides data that is derived from a statistic that is correlated to safety. A statistic may be positively or negatively correlated to safety. In some embodiments, the set data category of statistical resource may be further divided into the set data category of positive statistical resource and the set data category of negative statistical resource. The data category of positive statistical resource is associated with an information source which provides data that is derived from a positive statistic that is correlated to safety. The positive statistic may be any data or metrics that correlate with improved safety conditions, i.e., a reduced estimated likelihood of a traveler along the route being put in danger. The data category of negative statistical resource is associated with an information source which provides data that is derived from a negative statistic that is correlated to safety. The negative statistic may be any data or metrics that correlate with worsened safety conditions, i.e., an increased estimated likelihood of a traveler along the route being put in danger.

Any statistic may be viewed as a positive statistic or a negative statistic depending on whether its data or metrics have been shown to be statistically relevant for improved or worsened safety conditions, respectively. For example, a higher than average statistic for per capita income level, employment rate, or average education level (e.g. based upon high school graduation rates, advanced degrees rates, etc.) may be, but is not necessarily, a positive statistic correlated with improved safety conditions at the location associated with that statistic. Conversely, a lower than average statistic for per capita income level, employment rate, or average education level may be, but is not necessarily, a negative statistic correlated with worsened safety conditions at the location associated with the statistic.

With respect to a statistic for criminal activity, it may be inferred that locations having a higher than average statistic for criminal activity are necessarily less safe (i.e., more dangerous) than locations having a lower than average statistic for criminal activity. Additionally, in some embodiments a statistic for a certain type of criminal activity may be more or less correlated with safety conditions depending on the traveler's means of transportation (which are discussed above) and/or the type of thoroughfares that are commuted upon (which are discussed above). Statistics for criminal activity may include, but are not limited to, data or metrics concerning homicide, forcible rape, violent crime, robbery, property crime, aggravated assault, burglary, larceny, theft, motor vehicle theft, firearm murders, firearm robberies, firearm assaults, motor vehicle violations (e.g., speeding tickets), drug overdose, and other crimes.

As discussed above, statistics for travel conditions may include, but are not limited to, data or metrics concerning weather, temperature, ice formation, time of day, sunrise or sunset times, calendar date, season of the year, and other travel conditions that may impact safety. Such statistics for travel conditions may be correlated with improved or worsened safety conditions. For example, low temperatures and ice formation may be correlated with worsened safety conditions. Additionally, in some embodiments a statistic for a certain travel condition may be more or less correlated with safety conditions depending on the traveler's means of transportation (which are discussed above) and/or the type of thoroughfares that are commuted upon (which are discussed above). For example, ice formation may be more correlated with worsened safety conditions when the traveler's means of transportation is a motorcycle versus a car, since the additional wheels of the car may provide extra traction and grip on a road's surface which may in turn decrease the slipping effect of ice. In another example, traveling at a time of day after sunset (i.e., during the dark hours of the night) may be more correlated with worsened safety conditions when commuting upon a highway versus a local city street, since the high speeds of a highway may provide the traveler with less reaction time in an already limited visibility scenario.

In some embodiments, the server system 101 may provide a model for predicting improved or worsened safety conditions based at least in part on statistics for various travel conditions. In particular, the server system 101 may provide a numerical score based on the travel conditions and other factors relevant to safety. This numerical score may be utilized when determining and assigning the data importance factor for a particular information source. Additionally, in some embodiments, the data importance factor may also be based at least in part on a physics analysis and/or a simulated-driving analysis that analyzes the traveler's means of transportation (as discussed above), the type of thoroughfares that are commuted upon (as discussed above), and/or statistics for travel conditions including data related to weather (as discussed above).

The geographic zone of an information source indicates a geographic area associated with the information source. The geographic area associated with the information source delineates a geographic area of relevance for which the data value of the information source is relevant. As regards an information source having a data category of user rating, the geographic area of relevance for the data that is derived from a user-provided safety rating (as discussed above) may be the area within a predetermined distance from a location associated with the user-provided safety rating. The location associated with the user-provided safety rating is the new rating location, as discussed in more detail above with reference to operation 432). Therefore, the geographic zone for an information source having a data category of user rating may be the geographic area within a predetermined distance from the new rating location.

As regards an information source having a data category of statistical resource, the geographic area of relevance for the data that is derived from a statistic may include a preassigned territory specific to the statistic and an area within a predetermined distance from the preassigned territory. The preassigned territory for a statistic may be any suitable type of geographic identifier for locating and/or defining a geographic area including an address, a zip code, a municipality (e.g., a city, town, village, etc.), a neighborhood or district of a municipality, a state, a country, a specific location, a road or thoroughfare, a waterway, a location or region identified by GPS coordinates (e.g., latitude and longitude), etc. For example, the statistic may be a per capita income level in a zip code, the rate of carjackings in a district of a municipality, the employment rate in a state, the number of motor vehicle violations on a particular road, the average monthly temperature for a city, etc.

The predetermined distance may be specific to a particular statistic and based upon factors including the type of statistic (e.g., rate of homicide, average monthly temperature, etc.), the category of statistic (e.g., criminal activity, weather conditions, etc.), and a calculated affected area for which it has been determined that there is statistically relevant increase or decrease in the estimated likelihood of a traveler being put in danger due to the proximity of the traveler to the preassigned territory for the statistic. For example, the statistic for a rate of homicide in a zip code may have a predetermined distance of 1 mile, such that the geographic area of relevance includes the zip code and the area within 1 mile from the zip code. Therefore, the geographic zone for an information source having a data category of statistical resource may be the geographic area including a preassigned territory specific to a statistic and an area within a predetermined distance from the preassigned territory.

In operation 702, the server system 101 identifies, for at least one travel segment, a segment data set including one or more information sources for each travel segment. The first route comprises one or more travel segments, and each travel segment identifies a portion of the first route. Each information source in the segment data set has a geographic zone that is within a predetermined distance from any location included within the corresponding travel segment.

In operation 704, the server system 101 identifies one or more category data sets of information sources for each segment data set. Each of the category data sets is a subset of the segment data set. Each category data set has a set category and a category importance factor. The set category is one of a user rating and a statistical resource. In some embodiments, the set category of user rating may be further divided into the set category of recent user rating and the set category of historical user rating, as discussed above. In some embodiments, the set category of statistical resource may be further divided into the set category of positive statistical resource and the set category of negative statistical resource, as discussed above. Each category data set includes the one or more information sources in the segment data set that have a data category that matches the set category of the category data set.

The category importance factor is assigned to the category data set and indicates a degree of significance associated with the set category. Moreover, a higher category importance factor may indicate that a set category has greater significance than another set category associated with a lower category importance factor. For example, in some embodiments, the set category of recent user rating may have a higher category importance factor than the set category of historical user rating. As another example, in some embodiments, the set category of positive statistical resource may have a higher category importance factor than the set category of negative statistical resource.

In operation 706, the server system 101 calculates a category score for each category data set. The category score may be calculated based on the information sources included within the category data set. In some embodiments, the category score may be calculated based on the data value (i.e., the data after active manipulation and transformation, such as the assigned integer values discussed above for example) and the data importance factor of at least one information source that is included within the category data set. For example, the category score may be based on a weighted average of the data values of the at least one data information source while using the data importance factors as the corresponding weights. In another example, the category score may be based on a weighted median of the data values of the at least one data information source while using the data importance factors as the corresponding weights.

In another example, regression analysis may be performed to determine the category score as a function of at least the data values and the data importance factors of the at least one data information source. Regression analysis, as would be understood by a person of ordinary skill in the field of statistics, is a powerful tool to analyze data, enabling the identification and characterization of relationships among multiple factors and the identification of relevant factors for calculating risk scores based on case specific circumstances. In particular, regression analysis may be beneficial to determine the causal relationship of particular ones of the data information sources upon the safety of a traveler who is traveling through particular locations and can facilitate a determination as to which factors may be the most relevant to safety, which factors to ignore, and which factors may be assigned a greater or lesser weight. It should be understood that such regression analysis may be utilized when analyzing any information source and calculating, assigning, or deriving any score or value from raw or manipulated data, as not all information or data is equally important in ascertaining safety or risk. For example, a regression analysis may be performed as described by John Fox in “Applied Regression Analysis, Linear Models, and Related Methods,” SAGE Publications Inc., 1998, and/or as described by David G. Kleinbaum et al. in “Applied Regression Analysis and Other Multivariable Methods,” 5th Edition, Cengage Learning, 2013, the contents of each of which are hereby incorporated by reference herein in their entireties.

In some embodiments, in order to determine which of the information sources included within the category data set to utilize during the calculation of the category score, a statistical analysis may be performed that would be known by statisticians to correct for outlier data or anomalous data through the removal of certain information sources from the calculation. For example, outlier data may include those information sources having a data value, a data importance factor, or a resultant combination thereof that is not included within a predetermined number of standard deviations from the mean of the respective population of values.

In operation 708, the server system 101 calculates a segment score for each travel segment. Each segment score may indicate an estimated likelihood of the traveler being put in danger when traveling along one of the one or more travel segments that comprise the first route. The segment score may be calculated based on the category data sets included within the segment data set for the travel segment. The category data sets included within the segment data set are those category data sets that are subsets of the segment data set for the travel segment. In some embodiments, the segment score may be calculated based on the category score and the category importance factor of at least one category data set that is included within the segment data set. For example, the segment score may be based on a weighted average of the category scores of the at least one category data set while using the category importance factors as the corresponding weights. In another example, the segment score may be based on a weighted median of the category scores of the at least one category data set while using the category importance factors as the corresponding weights.

In another example, regression analysis may be performed to determine the segment score as a function of at least the category scores and the category importance factors of the at least one category data set. Regression analysis, as would be understood by a person of ordinary skill in the field of statistics, is a powerful tool to analyze data, enabling the identification and characterization of relationships among multiple factors and the identification of relevant factors for calculating risk scores based on case specific circumstances. In particular, regression analysis may be beneficial to determine the causal relationship of particular ones of the category data sets upon the safety of a traveler who is traveling through particular locations and can facilitate a determination as to which factors may be the most relevant to safety, which factors to ignore, and which factors may be assigned a greater or lesser weight. It should be understood that such regression analysis may be utilized when analyzing any category data set. For example, a regression analysis may be performed as described by John Fox in “Applied Regression Analysis, Linear Models, and Related Methods,” SAGE Publications Inc., 1998, and/or as described by David G. Kleinbaum et al. in “Applied Regression Analysis and Other Multivariable Methods,” 5th Edition, Cengage Learning, 2013, the contents of each of which are hereby incorporated by reference herein in their entireties.

In some embodiments, in order to determine which of the category data sets included within the segment data set to utilize during the calculation of the segment score, a statistical analysis may be performed that would be known by statisticians to correct for outlier data or anomalous data through the removal of certain category data sets from the calculation. For example, outlier data may include those category data sets having a category score, a category importance factor, or a resultant combination thereof that is not included within a predetermined number of standard deviations from the mean of the respective population of values.

In operation 710, the server system 101 calculates the first safety rating based on at least one segment score. In which each segment score has been calculated for a corresponding travel segment (as discussed above), and each travel segment identifies a portion of the first route (as discussed above). For example, the first safety rating may be based on an average of the at least one segment score. In another example, the first safety rating may be based on a median or mode of the at least one segment score. In another example, the path point score may be based on a weighted average of the at least one segment score while using as the corresponding weights the percentage of the distance of the first route that correlates with the portion of the first route identified by the travel segment. In another example, the path point score may be based on a weighted median of the at least one segment score while using as the corresponding weights the percentage of the distance of the first route that correlates with the portion of the first route identified by the travel segment.

In another example, regression analysis may be performed to determine the first safety rating as a function of at least the at least one segment score. Regression analysis, as would be understood by a person of ordinary skill in the field of statistics, is a powerful tool to analyze data, enabling the identification and characterization of relationships among multiple factors and the identification of relevant factors for calculating risk scores based on case specific circumstances. In particular, regression analysis may be beneficial to determine the causal relationship of particular ones of the path point scores upon the safety of a traveler who is traveling through particular locations and can facilitate a determination as to which factors may be the most relevant to safety, which factors to ignore, and which factors may be assigned a greater or lesser weight. It should be understood that such regression analysis may be utilized when analyzing any path point score. For example, a regression analysis may be performed as described by John Fox in “Applied Regression Analysis, Linear Models, and Related Methods,” SAGE Publications Inc., 1998, and/or as described by David G. Kleinbaum et al. in “Applied Regression Analysis and Other Multivariable Methods,” 5th Edition, Cengage Learning, 2013, the contents of each of which are hereby incorporated by reference herein in their entireties.

In some embodiments, in order to determine which of the segment scores to utilize during the calculation of the first safety rating, a statistical analysis may be performed that would be known by statisticians to correct for outlier data or anomalous data through the removal of certain segment scores from the calculation. For example, outlier data may include those segment scores that are not included within a predetermined number of standard deviations from the mean.

With reference to FIG. 8, a flowchart is depicted of an embodiment of a subprocess associated with transmitting an unsafe destination alert to the first client device 300 as shown by operation 426 in FIG. 4B, according to aspects of the disclosure. In this embodiment, operation 426 may include the following subtasks: determining whether a second route that satisfies the minimum safety threshold has been identified (operation 802); transmitting an alert to the first client device when the second route has not been identified (operation 804); generating a second data structure that includes the second route when it has been identified (operation 806); and transmitting the second data structure to the first client device 300 (operation 808).

In operation 802, the server system 101 determines whether a second route between and including the starting location and the destination that has a second safety rating that meets or exceeds the minimum safety threshold has been identified. Such a second route, if identified, is an alternative to the first route as they share the same starting and ending points. The second safety rating indicates an estimated likelihood of a traveler along the second route being put in danger. The second safety rating may be calculated in a substantially similar manner as to how the first safety rating is calculated, two embodiments of which are discussed above with reference to FIGS. 6-7. Upon a positive determination that such a second route has been identified, the process continues to operation 806. Otherwise upon a negative determination that such a second route has not been identified, the process continues to operation 804.

In operation 804, the server system 101 transmits an alert to the first client device 300 that stipulates that no route that satisfies the minimum safety threshold has been identified (i.e., no route having an associated safety rating that satisfies the minimum safety threshold has been identified). In some embodiments, upon receiving the alert the first client device 300 (or user of the first client device 300) may have the option to lower the minimum safety threshold (for only this particular instance and/or for all future navigation requests). If the minimum safety threshold is lowered, the process may continue to operation 802 so that the server system 101 may make another attempt to identify a second route having a second safety rating that satisfies the newly updated minimum safety threshold as lowered. Additionally or alternatively, if the minimum safety threshold is lowered, the process may continue to operation 418 in order to determine whether the first safety rating for the first route satisfies the newly updated minimum safety rating as lowered.

In operation 806, the server system 101 generates a second data structure that includes an indication of the second route and an indication of the second safety rating. In some embodiments, the second data structure may also include additional information items. The additional information items may contain data concerning the second route or any portion thereof, the second safety rating, and/or the destination. For example, such additional information items may include a warning about a dangerous portion of the second route (e.g., “many recent carjackings in this area”), additional explanation about the second safety rating (e.g., “the safety rating for this area has declined 50% in the last month” (which may be indicative of a spate of recent crimes)), or a warning about the destination (e.g., “fire reported close to the destination”).

In operation 808, the server system 101 transmits the second data structure to the first client device 300.

With reference to FIG. 9, a flowchart is depicted of an embodiment of a subprocess associated with transmitting an updated route and an updated safety rating to the first client device 300, as shown by operation 430 in FIG. 4B, according to aspects of the disclosure. In this embodiment, operation 426 may include the following subtasks: updating the starting location to be a current location of the first client device 300 (operation 902); identifying an updated route (operation 904), calculating an updated safety rating for the updated route (operation 906); generating a third data structure that includes the updated route and the updated safety rating (operation 908); and transmitting the third data structure to the first client device 300 (operation 910).

In operation 902, the server system 101 updates the starting location to be a current location of the first client device 300 (or a user of the first client device 300) in response to a predetermined condition. The predetermined condition may include, but is not limited to, the following examples: (a) a predetermined time interval having elapsed; (b) an expiration of a timer; (c) a periodic or random execution of the operation; (d) an occurrence of an action or the detection of a state, which may for example include a detection that the first client device 300 has commenced travel and/or has traveled a predetermined distance along the route; (e) a report safety condition request having been received from the first client device 300 (as described in more detail below with respect to operation 448) when the condition location is within a predetermined distance from the presently traveled route; and (f) the identification of a live danger condition by the server system 101 (as described in more detail below with regard to operation 440) when the live danger location is within a predetermined distance from the presently traveled route.

In operation 904, the server system 101 identifies an updated route from the starting location to the destination. In some instances, the updated route may identify a remaining portion of a route presently traveled by the first client device 300 (or the user of the first client device 300) that has not yet been completed. The route presently traveled may be, for example, the first route (see operation 420) or the second route (see operation 426), depending on the operations previously performed by the process 400. In some instances, the updated route may be different than the remaining portion of the route presently traveled while still sharing the same starting and ending points. In that situation, the updated route is an alternative to the remaining portion of the route presently traveled as they share the same starting and ending points, the starting point having been previously updated to be the current location of the first client device 300 (or a user of the first client device 300) as described above with regard to operation 902.

In operation 906, the server system 101 calculates an updated safety rating for the updated route. The updated safety rating indicates an estimated likelihood of a traveler along the updated route being put in danger. The updated safety rating may be calculated in a substantially similar manner as to how the first safety rating is calculated, two embodiments of which are discussed above with reference to FIGS. 6-7.

In operation 908, the server system 101 generates a third data structure that includes an indication of the updated route and an indication of the updated safety rating. In some embodiments, the third data structure may also include additional information items. The additional information items may contain data concerning the updated route or any portion thereof, the updated safety rating, and/or the destination. For example, such additional information items may include a warning about a dangerous portion of the updated route (e.g., “many recent carjackings in this area”), additional explanation about the updated safety rating (e.g., “the safety rating for this area has declined 50% in the last month” (which may be indicative of a spate of recent crimes), or a warning about the destination (e.g., “fire reported close to the destination”).

In operation 910, the server system 101 transmits the third data structure to the first client device 300.

With reference to FIG. 10, a flowchart is depicted of an embodiment of a subprocess associated with transmitting to the first client device 300 a second updated route and a second updated safety rating based at least in part on an updated set of user ratings, when predetermined conditions are satisfied, as shown by operation 436 in FIG. 4C, according to aspects of the disclosure. In this embodiment, operation 436 may include the following subtasks: determining whether a new rating location is within a predetermined distance from a second updated route (operation 1002); calculating a second updated safety rating for the second updated route (based at least in part on the set of user ratings) (operation 1004); generating a fourth data structure that includes the second updated route and the second updated safety rating (operation 1006); and transmitting the fourth data structure to the first client device 300 (operation 1008).

In operation 1002, the server system 101 identifies a second updated route that represents a remaining portion of a route presently traveled by the first client device 300 (or the user of the first client device 300) that has not yet been completed. The route presently traveled may be, for example, the first route (see operation 420), the second route (see operation 426), or the updated route (see operation 430), depending on the operations previously performed by the process 400. The server system 101 then determines whether a new rating location associated with a new rating received in operation 432 is within a predetermined distance from the second updated route. Upon a negative determination that the new rating location is not within the predetermined distance, the process continues to operation 438. Otherwise upon on a positive determination that the new rating location is within the predetermined distance, the process continues to operation 1004.

In operation 1004, the server system 101 calculates a second updated safety rating for the second updated route, based at least in part on a set of user ratings. The set of user ratings may have been updated to include the new rating, as discussed in greater detail above with regard to operation 434. The second updated safety rating indicates an estimated likelihood of a traveler along the second updated route being put in danger. The second updated safety rating may be calculated in a substantially similar manner as to how the first safety rating is calculated, two embodiments of which are discussed above with reference to FIGS. 6-7.

In operation 1006, the server system 101 generates a fourth data structure that includes an indication of the second updated route and an indication of the second updated safety rating. In some embodiments, the fourth data structure may also include additional information items. The additional information items may contain data concerning the second updated route or any portion thereof, the second updated safety rating, and/or the destination. For example, such additional information items may include a warning about a dangerous portion of the second updated route (e.g., “many recent carjackings in this area”), additional explanation about the second updated safety rating (e.g., “the safety rating for this area has declined 50% in the last month” (which may be indicative of a spate of recent crimes)), or a warning about the destination (e.g., “fire reported close to the destination”).

In operation 1008, the server system 101 transmits the fourth data structure to the first client device 300.

With reference to FIG. 11, a flowchart is depicted of an embodiment of a subprocess associated with transmitting to the first client device 300 a second updated route and a second updated safety rating based at least in part on an updated set of user ratings, when predetermined conditions are satisfied, as shown by operation 436 in FIG. 4C, according to aspects of the disclosure. In this embodiment, operation 436 may include the following subtasks: determining whether a new rating location is within a predetermined distance from a remaining portion of the route presently traveled (operation 1102); calculating a remaining safety rating for the remaining portion of the route presently traveled based at least in part on the updated set of user ratings (operation 1104); identifying a second updated route (operation 1106); calculating a second updated safety rating for the second updated route based at least in part on the updated set of user ratings (operation 1108); determining whether the second updated safety is better than or equal to the remaining safety rating (operation 1110); generating a fourth data structure that includes the second updated route and the second updated safety rating (operation 1112); and transmitting the fourth data structure to the first client device 300 (operation 1114).

In operation 1102, the server system 101 identifies a remaining portion of a route presently traveled by the first client device 300 (or the user of the first client device 300) that has not yet been completed. The route presently traveled may be, for example, the first route (see operation 420), the second route (see operation 426), or the updated route (see operation 430), depending on the operations previously performed by the process 400. The server system 101 then determines whether a new rating location associated with a new rating received in operation 432 is within a predetermined distance from the remaining portion of the route presently traveled. Upon a negative determination that the new rating location is not within the predetermined distance, the process continues to operation 438. Otherwise, upon on a positive determination that the new rating location is within the predetermined distance, the process continues to operation 1104.

In operation 1104, the server system 101 calculates a remaining safety rating for the remaining portion of the route presently traveled, based at least in part on a set of user ratings. The set of user ratings may have been updated to include the new rating, as discussed in greater detail above with regard to operation 434. The remaining safety rating indicates an estimated likelihood of a traveler along the remaining portion of the route presently traveled being put in danger. The remaining safety rating may be calculated in a substantially similar manner as to how the first safety rating is calculated, two embodiments of which are discussed above with reference to FIGS. 6-7.

In operation 1106, the server system 101 identifies a second updated route between and including a current location of the first client device 300 (or a user of the first client device 300) and the destination. In some instances, the second updated route may identify a remaining portion of a route presently traveled by the first client device 300 (or the user of the first client device 300) that has not yet been completed. In some instances, the second updated route may be different than the remaining portion of the route presently traveled while still sharing the same starting and ending points. In that situation, the second updated route is an alternative to the remaining portion of the route presently traveled as they share the same starting and ending points.

In operation 1108, the server system 101 calculates a second updated safety rating for the second updated route, based at least in part on the set of user ratings. The set of user ratings may have been updated to include the new rating, as discussed in greater detail above with regard to operation 434. The second updated safety rating indicates an estimated likelihood of a traveler along the second updated route being put in danger. The second updated safety rating may be calculated in a substantially similar manner as to how the first safety rating is calculated, two embodiments of which are discussed above with reference to FIGS. 6-7.

In operation 1110, the server system 101 determines whether the second updated safety rating is better than or equal to the remaining safety rating. Upon a positive determination that the second updated safety rating is better than or equal to the remaining safety rating, the subprocess proceeds to operation 1112. Otherwise, upon a negative determination that the second updated safety rating is lower than the remaining safety rating, the subprocess proceeds to operation 438. Alternatively, in some embodiments when the second updated safety rating equals the remaining safety rating the subprocess may proceed to operation 438.

In operation 1112, the server system 101 generates a fourth data structure that includes an indication of the second updated route and an indication of the second updated safety rating. In some embodiments, the fourth data structure may also include additional information items. The additional information items may contain data concerning the second updated route or any portion thereof, the second updated safety rating, and/or the destination. For example, such additional information items may include a warning about a dangerous portion of the second updated route (e.g., “many recent carjackings in this area”), additional explanation about the second updated safety rating (e.g., “the safety rating for this area has declined 50% in the last month” (which may be indicative of a spate of recent crimes)), or a warning about the destination (e.g., “fire reported close to the destination”).

In operation 1114, the server system 101 transmits the fourth data structure to the first client device 300.

With reference to FIG. 12, a flowchart is depicted of an embodiment of a subprocess associated with transmitting a safety change alert to the first client device 300, as shown by operation 438 in FIG. 4C, according to aspects of the disclosure. In this embodiment, operation 438 may include the following subtasks: calculating a second remaining safety rating for a remaining portion of the route presently traveled (operation 1202); determining whether the second remaining safety rating is less than the safety rating for the route presently traveled (operation 1204); determining whether the difference between the second remaining safety rating and the safety rating for the route presently traveled exceeds a predetermined threshold (operation 1206); generating a safety change alert (operation 1208); and transmitting the safety change alert to the first client device 300 (operation 1210).

In operation 1202, the server system 101 calculates a second remaining safety rating for a remaining portion of a route presently traveled by the first client device 300 (or the user of the first client device 300) that has not yet been completed, which may be in response to a predetermined condition. The route presently traveled may be, for example, the first route (see operation 420), the second route (see operation 426), the updated route (see operation 430), or the second updated route (see operation 436) depending on the operations previously performed by the process 400. The second remaining safety rating indicates an estimated likelihood of a traveler along the remaining portion of the route presently traveled being put in danger. The second remaining safety rating may be calculated in a substantially similar manner as to how the first safety rating is calculated, two embodiments of which are discussed above with reference to FIGS. 6-7.

The predetermined condition may include, but is not limited to, the following examples: (a) a predetermined time interval having elapsed; (b) an expiration of a timer; (c) a periodic or random execution of the operation; (d) an occurrence of an action or the detection of a state, which may for example include a detection that the first client device 300 has commenced travel and/or has traveled a predetermined distance along the route; (e) a report safety condition request having been received from the first client device 300 (as described in more detail below with respect to operation 448) when the condition location is within a predetermined distance from the presently traveled route; and (f) the identification of a live danger condition by the server system 101 (as described in more detail below with regard to operation 440) when the live danger location is within a predetermined distance from the presently traveled route.

In operation 1204, the server system 101 determines whether the second remaining safety rating is less than the safety rating for the route presently traveled. Upon a negative determination that the second remaining safety rating is not less than (i.e., greater than or equal to) the safety rating for the route presently traveled, the subprocess proceeds to operation 440. Otherwise, upon a positive determination that the second remaining safety rating is less than the safety rating for the route presently traveled, the subprocess proceeds to operation 1206.

In operation 1206, the server system 101 determines whether a difference between the second remaining safety rating and the safety rating for the route presently traveled (also referred to below as the ‘difference at issue’) exceeds a predetermined threshold. For example, if the safety rating for the route presently traveled is 7.5 and the predetermined threshold is set at 1.5, then the difference at issue will exceed the predetermined threshold when the second remaining safety rating is less than 6.0. Upon a negative determination that the difference at issue does not exceed the predetermined threshold, the subprocess proceeds to operation 440. Otherwise, upon a positive determination that the difference at issue exceeds the predetermined threshold, the subprocess proceeds to operation 1208.

In operation 1208, the server system 101 generates a safety change alert. The safety change alert may include additional information about the change in safety rating from (a) the safety rating for the route presently traveled (previously sent to the first client device 300) to (b) the second remaining safety rating (calculated in operation 1202). For example, such additional information about the change in safety rating may include: when the change occurred; why the change occurred (e.g., a new dangerous condition was identified near the client device 300); the magnitude of the change (expressed as a percent, a decimal number, etc.); where the client device 300 was located when the change occurred; and other information that would be useful when accessing the change in safety rating.

In operation 1210, the server system 101 transmits an indication of the safety change alert and an indication of the second remaining safety rating to the first client device 300.

With reference to FIG. 13, a flowchart is depicted of an embodiment of a subprocess associated with transmitting a live danger alert to the first client device 300, as shown by operation 442 in FIG. 4C, according to aspects of the disclosure. In this embodiment, operation 442 may include the following subtasks: identifying a remaining portion of the route presently travelled (operation 1302); determining whether a live danger location is within a predetermined distance from the remaining portion of the route presently traveled (operation 1304); determining whether there is a statistically relevant increase in the estimated likelihood of being put in danger because of the live danger condition (operation 1306); generating a live danger alert data structure that includes the live danger condition and the live danger location (operation 1308); and transmitting the live danger alert data structure to the first client device 300 (operation 1310).

In operation 1302, the server system 101 identifies a remaining portion of a route presently travelled by the first client device 300 (or the user of the first client device 300) that has not yet been completed. The route presently traveled may be, for example, the first route (see operation 420), the second route (see operation 426), the updated route (see operation 430), or the second updated route (see operation 436) depending on the operations previously performed by the process 400.

In operation 1304, the server system 101 determines whether a live danger location associated with a live danger condition received in operation 440 is within a predetermined distance from the remaining portion of the route presently traveled. Upon a negative determination that the live danger location is not within the predetermined distance, the process continues to operation 444. Otherwise, upon on a positive determination that the live danger location is within the predetermined distance, the process continues to operation 1306.

In operation 1306, the server system 101 determines whether there is a statistically relevant increase in the estimated likelihood of a traveler along the remaining portion of the route presently traveled being put in danger because of the live danger condition. For example, a tornado occurring near the remaining portion of the route presently traveled may cause a statistically relevant increase in the estimated likelihood of the traveler being put in danger. Upon a negative determination that there is no statistically relevant increase in the estimated likelihood of a traveler along the remaining portion of the route presently traveled being put in danger, the process continues to operation 444. Otherwise, upon on a positive determination that there is a statistically relevant increase in the estimated likelihood of a traveler along the remaining portion of the route presently traveled being put in danger, the process continues to operation 1308.

The determination of the server system 101 as to whether there is a statistically relevant increase in the estimated likelihood of a traveler along the remaining portion of the route presently traveled being put in danger because of the live danger condition may be made by analyzing a number of factors and considerations. Factors such as the type of live danger condition, the severity of the live danger condition, the distance from the live danger location to the route presently traveled, the distance from the live danger location to the first client device 300 (or the user of the first client device 300), the time of day at the live danger location, the temperature at the live danger location, the weather at the live danger location, as well as other data relevant to the live danger condition and/or the live danger location that may be utilized during the determination. The server system 101 may also consider historical data relevant to the live danger condition (e.g., records indicating a history of car accidents due to icy road conditions) and/or relevant to the live danger location (e.g., records indicating a history of car accidents within a predetermined distance from the live danger location), which along with the factors above may be employed to calculate statistical probabilities that are utilized during the determination.

Examples of a live danger condition include: criminal activity such as carjackings and gun violence; unsafe road conditions such as icy roads, a lack of street lighting, and a multi-vehicle collision; severe weather such as a tornado, a fire, and a flood; and other unsafe conditions that may affect a traveler along the route presently traveled. With regard to the example of the lack of street lighting, in order to make the determination the server system 101 may also consider factors such as the time of day at the live danger location, the times for sunset and sunrise at the live danger location (in order to determine daylight hours and dark hours), and whether historical data indicates a high statistical probability of dangerous conditions (e.g., car accidents, criminal activity, etc.) during the dark hours of the night within a predetermined distance from the live danger location. With regard to the example of the icy roads, in order to make the determination the server system 101 may also consider factors such as the temperature at the live danger location and whether historical data indicates a high statistical probability of dangerous accidents (e.g., car accidents, medical injuries, etc.) within a predetermined distance from the live danger location when the temperature is below a predetermined threshold. As demonstrated by these examples, the server system 101 will analyze a number of factors and considerations to determine whether there is a statistically relevant increase in the estimated likelihood of a traveler along the remaining portion of the route presently traveled being put in danger because of the live danger condition.

In operation 1308, the server system 101 generates a live danger alert data structure that includes an indication of the live danger condition and an indication of the live danger location. In some embodiments, the live danger alert data structure may also include additional information items about the live danger condition. For example, such additional information may include: a more detailed description of the live danger condition; information concerning another potential danger caused by the live danger condition (e.g., a bridge ahead has been destroyed by a tornado); information regarding how the live danger condition has affected the safety rating of the route presently traveled; information regarding how the live danger condition has affected the safety rating of the remaining portion of the route presently traveled; and other information that would be useful when accessing the potential danger caused by the live danger condition.

In operation 1310, the server system 101 transmits the live danger alert data structure to the first client device 300.

With reference to FIG. 14, a flowchart is depicted of an embodiment of a subprocess associated with effecting a predetermined response in response to an SOS request received from the first client device 300, as shown by operation 446 in FIG. 4D, according to aspects of the disclosure. In this embodiment, operation 446 includes the following subtasks: determining whether the SOS request is a request to contact emergency services (operation 1402); effecting communication with the emergency services (operation 1404); determining whether the SOS request is a request to contact an emergency contact (operation 1406); effecting communication with the emergency contact (operation 1408); determining whether the SOS request is a request to activate an alarm (operation 1410); and effecting activation of the alarm (operation 1412). As discussed above with regard to operation 444, the SOS request may be at least one of: (a) a request to contact emergency services; (b) a request to contact an emergency contact; and (c) a request to activate an alarm. In some embodiments, the SOS request may also be a user-defined customized request as determined by the first client device 300 (or the user of the first client device 300).

In operation 1402, the server system 101 determines whether the SOS request is a request to contact emergency services. Upon a positive determination that the SOS request is a request to contact emergency services, the process continues to operation 1404. Otherwise, upon on a negative determination that the SOS request is not a request to contact emergency services, the process continues to operation 1406.

In operation 1404, the server system 101 effects communication with the emergency services. For example, the server system 101 may effect communication with law enforcement (e.g., a local police department), fire and rescue services (e.g., a local fire department), emergency medical services (e.g., ambulance services for transportation to a hospital), and/or other providers of emergency services. Additionally or alternatively, the server system 101 may determine that the SOS request concerns a live danger condition and may proceed with operation 442 as part of the predetermined response. As discussed above with regard to operation 446, in some embodiments, the predetermined response may also include additional information items. The additional information items may include at least one of a user identification, a vehicle identification, a last known location of the first client device 300 (or the user of the first client device 300), a description of the reasons for the SOS request, information regarding an emergency contact including contact information, a waypoint stop (e.g., a service station, a gas station, etc.) within a predetermined distance from the first client device 300 (or a user of the first client device 300), and/or other information relevant to the SOS request. After communication has been effected with the emergency services, the process continues to operation 448.

In some embodiments, the server system 101 may utilize the additional information items in order to determine with which of the emergency services to effect communication. For example, the server system 101 may effect communication with the local fire department in response to detecting the existence of a keyword such as ‘fire’ in the description of the reasons for the SOS request, such description being an additional information item discussed above.

In some embodiments, the server system 101 may additionally transmit some of the additional information items to the emergency services. For example, the server system 101 may transmit the vehicle identification and the user identification to the local police in order to facilitate identification of the first client device 300 (or the user of the first client device 300). In another example, the server system 101 may transmit the last known location of the first client device 300 (or the user of the first client device 300) to emergency medical services so that an ambulance may be dispatched to the last known location.

In operation 1406, the server system 101 determines whether the SOS request is a request to contact an emergency contact. Upon a positive determination that the SOS request is a request to contact an emergency contact, the process continues to operation 1408. Otherwise upon on a negative determination that the SOS request is not a request to contact an emergency contact, the process continues to operation 1410.

In operation 1408, the server system 101 effects communication with the emergency contact. In some embodiments, the server system 101 may utilize contact information received from the first client device 300 and/or previously stored on the server system 101 in order to effect communication with the emergency contact. For example, such contact information may include a telephone number, email address, username for an online messaging service (e.g., Skype, Facebook Messenger, WhatsApp, and/or the like), and/or other information related to the emergency contact. Additionally or alternatively, the server system 101 may determine that the SOS request concerns a live danger condition and may proceed with operation 442 as part of the predetermined response. As discussed above with regard to operation 446, in some embodiments the predetermined response may also include additional information items. The additional information items may include at least one of a user identification, a vehicle identification, a last known location of the first client device 300 (or the user of the first client device 300), a description of the reasons for the SOS request, information regarding the emergency contact including contact information, a waypoint stop (e.g., a service station, a gas station, etc.) within a predetermined distance from the first client device 300 (or a user of the first client device 300), and/or other information relevant to the SOS request. After communication has been effected with the emergency contact, the process continues to operation 448.

In some embodiments, the server system 101 may additionally transmit some of the additional information items to the emergency contact. For example, the server system 101 may transmit the description of the reasons for the SOS request to the emergency contact. In another embodiment, the server system 101 may transmit the last known location of the first client device 300 (or the user of the first client device 300) to the emergency contact.

In operation 1410, the server system 101 determines whether the SOS request is a request to activate an alarm. Upon a positive determination that the SOS request is a request to activate an alarm, the process continues to operation 1412. Otherwise upon on a negative determination that the SOS request is not a request to activate an alarm, the process continues to operation 448.

In operation 1412, the server system 101 effects activation of the alarm. Additionally, the server system 101 may determine that the SOS request concerns a live danger condition and may proceed with operation 442 as part of the predetermined response. As discussed above with regard to operation 446, in some embodiments the predetermined response may also include additional information items. The additional information items may include at least one of a user identification, a vehicle identification, a last known location of the first client device 300 (or the user of the first client device 300), a description of the reasons for the SOS request, information regarding an emergency contact including contact information, a waypoint stop (e.g., a service station, a gas station, etc.) within a predetermined distance from the first client device 300 (or a user of the first client device 300), and/or other information relevant to the SOS request. In some embodiments, an alarm on the client device 300 itself may be activated. In some embodiments, an alarm for a vehicle being operated by a user of the first client device 300 may be activated (e.g., a car alarm, an alarm connected to a third-party service provider such as ONSTAR or LOJACK). After the system has effected activation of the alarm, the process continues to operation 448.

In some embodiments, the server system 101 may additionally transmit some of the additional information items to the third-party service provider (e.g., ONSTAR, LOJACK, etc.). For example, the server system 101 may transmit the last known location of the first client device 300 (or the user of the first client device 300) to the third-party service provider. In another example, the server system 101 may transmit the description of the reasons for the SOS request to the third-party service provider.

With reference to FIG. 15, a flowchart is depicted of an embodiment of a subprocess associated with effecting a predetermined response in response to a report safety condition request received from the first client device 300, as shown by operation 450 in FIG. 4D, according to aspects of the disclosure. In this embodiment, operation 450 may include the following subtasks: determining whether a condition type is within a predetermined category (operation 1502); and effecting a predetermined response based on at least one of the condition type and the predetermined condition category (operation 1504). As discussed above with regard to operation 448, the report safety condition request may be one of: (a) a request to report an unsafe condition; (b) a request to report criminal activity; and (c) a request to report a severe weather condition. In some embodiments, the report safety condition request may also be a user-defined customized request as determined by the first client device 300 (or the user of the first client device 300). As discussed above with regard to operation 448, the report safety condition request includes identifying information. The identifying information may include at least one of a condition type (e.g., carjacking), a condition location, a condition description, a user identification, a vehicle identification, and/or other information relevant to the report safety condition request.

It should be understood that the term “request” when referring to any of the above report safety condition requests should not necessarily be construed as a request by the first client device 300 (or a user of the first client device 300) to effect any particular action or response for, or on behalf of, the first client device 300 (or a user of the first client device 300). Rather, the term “request” should be construed more generally as either being only a report or additionally as a request in the ordinary sense of the word. In particular, the intent of the first client device 300 (or a user of the first client device 300) may simply be to report a safety condition without requesting any particular action or response for, or on behalf of, the first client device 300 (or a user of the first client device 300). Nonetheless, such a report safety condition request may result in the server system 101 taking action in response thereto that impacts the first client device 300 (or a user of the first client device 300) that made the request. In such a situation, the term “request” is used in the ordinary sense of the word.

In operation 1502, the server system 101 determines whether the condition type is within a predetermined condition category. For example, the condition types of ‘carjacking’ and ‘robbery’ may both be within a predetermined condition category for ‘crimes.’ In another example, the condition types of ‘tornado’ and ‘flood’ may both be within a predetermined condition category for ‘dangerous weather.’ In another example, the condition types of ‘fire’ and ‘pothole’ may both be within a predetermined condition category for ‘unsafe condition.’ Upon on a negative determination that the condition type is not within a predetermined condition category, the process continues to operation 452. Otherwise, upon a positive determination that the condition type is within a predetermined condition category, the process continues to operation 1504.

In operation 1504, the server system 101 effects a predetermined response based on at least one of the condition type and the predetermined condition category. It is also within the scope and spirit of the present disclosure, that the predetermined response may additionally or alternatively be based on other criteria or any combination thereof with the condition type and/or predetermined condition category. For example, the server system 101 may effect communication with a local police department in response to a report safety condition request having a condition type within the predetermined condition category for ‘crimes.’ Additionally or alternatively, the server system 101 may determine that the report safety condition request concerns a live danger condition and may proceed with operation 442 as part of the predetermined response. In some embodiments, the predetermined response (e.g., effecting communication with a local police department) may also include identifying information. The identifying information may include at least one of a condition type (e.g., carjacking), a condition location, a condition description, a user identification, a vehicle identification, a waypoint stop (e.g., a service station, a gas station, etc.) within a predetermined distance from the first client device 300 (or a user of the first client device 300), and/or other information relevant to the report safety condition request. After the system has effected the predetermined response, the process continues to operation 452.

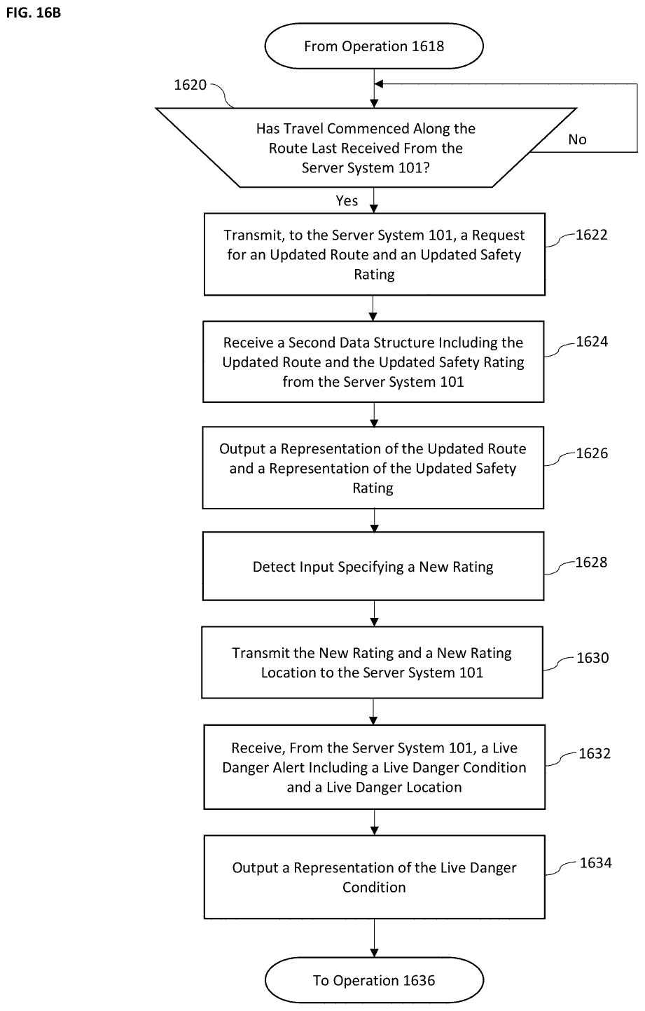

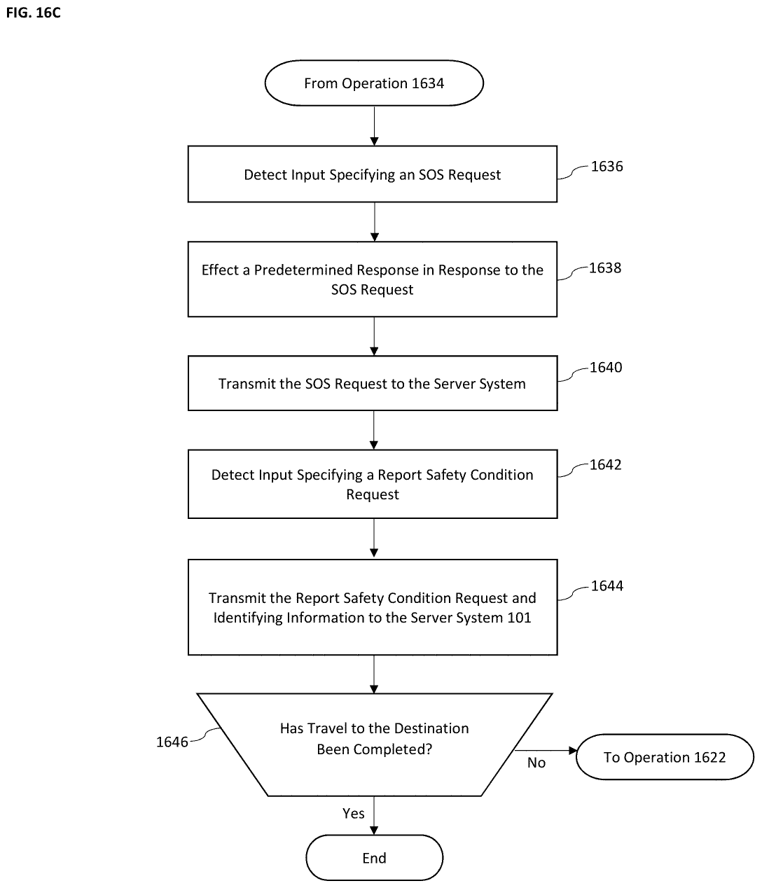

With reference to FIGS. 16A-C, a flow chart is depicted of an embodiment of a process 1600 performed by a client device 300, according to aspects of the disclosure. Although in this embodiment the operations of the process 1600 are described and illustrated as being performed by the client device 300, in other embodiments, at least some of the operations of the process 1600 may be performed by the server system 101 instead. Further, in some embodiments, the operations performed by the client device 300 may be performed on behalf of a respective user (i.e., a user of the client device 300).

In some operations described herein, input may be detected by the client device 300. Prior to the detection of such input, the user of the client device 300 may be presented with a message, a prompt, a notification, and/or any other suitable type of user interface component that specifies what input is being requested and may also explain why the input is being requested. The input may be detected with or without active steps being taken by the user of the client device 300. An active step in this context being the user of the client device 300 providing input via a user input component. Conversely, input may be detected without active steps being taken by the user of the client device 300, for example, when detecting the current location of the client device 300 using location services (as described in more detail below) without requiring the user of the client device 300 to actively input the current location via a user input component.

In operation 1601, the client device 300 detects input specifying a starting location and a destination for a route. The input may be any audible, visual, tactile (including a predetermined type of touch gesture being performed on the touchscreen 314 of the client device 300), and/or other form of input that is capable of capturing or specifying information provided by the user of the client device 300. The starting location and the destination may each be any suitable means to locate and/or define a geographic location. Such suitable means for locating and/or defining a geographic location may include, but are not limited to, one or more of the following examples: (a) using an address; (b) using GPS coordinates (e.g., latitude and longitude); (c) using a name for the location (e.g., “Yellowstone National Park”); (d) using the name of a municipality (e.g., a city, a town, a neighborhood); and/or using the name of a business or building that can be associated with an address or GPS coordinates. In some embodiments, the starting location may be determined by the client device 300 in cases where the starting location will be the current location of the client device 300. For example, the client device 300 may utilize location services (e.g., GPS, cell tower triangulation, Wi-Fi triangulation, etc.) in order to determine the current location of the client device 300 for use as the starting location without requiring the user to input the current location.

In operation 1602, the client device 300 transmits, to the server system 101, a request for: (a) a route between and including the starting location and the destination; and (b) a safety rating for the route that indicates an estimated likelihood of a traveler being put in danger when traveling along the route.

In operation 1604, the client device 300 detects input specifying a minimum safety threshold. The minimum safety threshold may be a numerical figure, a color, and/or any visual, audible, tactile (including a predetermined type of touch gesture being performed on the touchscreen 314 of the client device 300), or other input that is capable of capturing or specifying information provided by the user of the client device 300. The minimum safety threshold indicates the lowest safety rating that is acceptable to the client device 300 (or acceptable to the user of the client device 300). As discussed above, a safety rating may indicate an estimated likelihood of a traveler being put in danger: (a) at a specific location; (b) while traveling along a route; or (c) while traveling along a segment of the route. Preferably, a safety rating associated with a route, a segment of the route, or a destination that is provided by the server system 101 to the client device 300 satisfies the minimum safety threshold (i.e., does not fall below the minimum safety threshold), in order to prevent the user of the client device 300 from being navigated along a route, a segment of a route, or to a destination that does not satisfy the minimum safety threshold (i.e. has been determined to impose too high of a risk to the safety of the user). However, the user may opt to override the minimum safety threshold, for example in the case when no route would otherwise satisfy the minimum safety threshold, an embodiment of which is discussed below with regard to operations 1612-1614.

In operation 1606, the client device 300 transmits an indication of a minimum safety threshold to the server system 101.

In some embodiments, the client device 300 may detect input specifying a preferred route type. The preferred route type may be one of a safest route, a fastest route, a shortest route, and an optimized route, as described in more detail above with regard to operation 410. In cases where the client device 300 detects input specifying a preferred route type, the client device 300 may transmit an indication of the preferred route type to the server system 101.

In some embodiments, the client device 300 may detect input specifying route safety options. For example, the route safety options may include one or more of: an option to bypass roads without street lighting; an option to bypass roads not permitting commercial vehicle access; an option to bypass dirt roads; an option to bypass highways; and an option specifying a preferred road type for travel. The option specifying a preferred road type for travel may, for example, allow the user to select high-speed roads such as highways and freeways as being preferable for travel in contrast to low-speed roads such as local city streets. In cases where the client device 300 detects input specifying route safety options, the client device 300 may transmit an indication of the route safety options to the server system 101.

In operation 1608, the client device 300 receives a first data structure including an indication of a first route and an indication of a first safety rating for the first route, from the server system 101. The first route being between and including the starting location and the destination, and the first safety rating indicating an estimated likelihood of the traveler being put in danger while traveling along the first route. The indication of a first safety rating may be, for example, a numerical figure, a color, and/or any visual, audible, tactile, or other indicia or form of representation that is capable of providing the user of the client device 300 with information, or any combination thereof.

In some embodiments, the first data structure may also include additional information items. The additional information items may contain data concerning the first route or any portion thereof, the first safety rating, and/or the destination. For example, such additional information items may include a warning about a dangerous portion of the first route (e.g., “many recent carjackings in this area”), additional explanation about the first safety rating (e.g., “the safety rating for this area has declined 50% in the last month” (which may be indicative of a spate of recent crimes)), or a warning about the destination (e.g., “fire reported close to the destination”).

In operation 1610, the client device 300 determines whether the first safety rating associated with the first route satisfies the minimum safety threshold. Upon a positive determination that the first safety rating meets or exceeds the minimum safety threshold (i.e., that the first safety rating is as good or better than the user-defined minimum for safety), the process 1600 proceeds to operation 1618. Otherwise, upon a negative determination that the first safety rating does not meet or exceed the minimum safety threshold (i.e., that the first safety rating is worse than the user-defined minimum for safety), the process 1600 proceeds to operation 1612.

In operation 1612, the client device 300 detects input specifying a safety override approval. The input may be any audible, visual, tactile (including a predetermined type of touch gesture being performed on the touchscreen 314 of the client device 300), and/or other form of input that is capable of capturing or specifying information provided by the user of the client device 300.

In operation 1614, the client device 300 determines whether input specifying a safety override approval that is affirmative has been detected. Upon a positive determination that a safety override that is affirmative has been received, the process 1600 proceeds to operation 1618. Otherwise, upon a negative determination that a safety override approval that is affirmative has not been received, the process 1600 proceeds to operation 1616.

In operation 1616, the client device 300 transmits, to the server system 101, a request for: (a) a new route between and including the starting location and the destination, and (b) a new safety rating for the new route that indicates an estimated likelihood of a traveler along the new route being put in danger. Once this operation 1616 is complete, the process 1600 proceeds to operation 1608 in order to receive a data structure including the new route and the new safety rating from the server system 101.

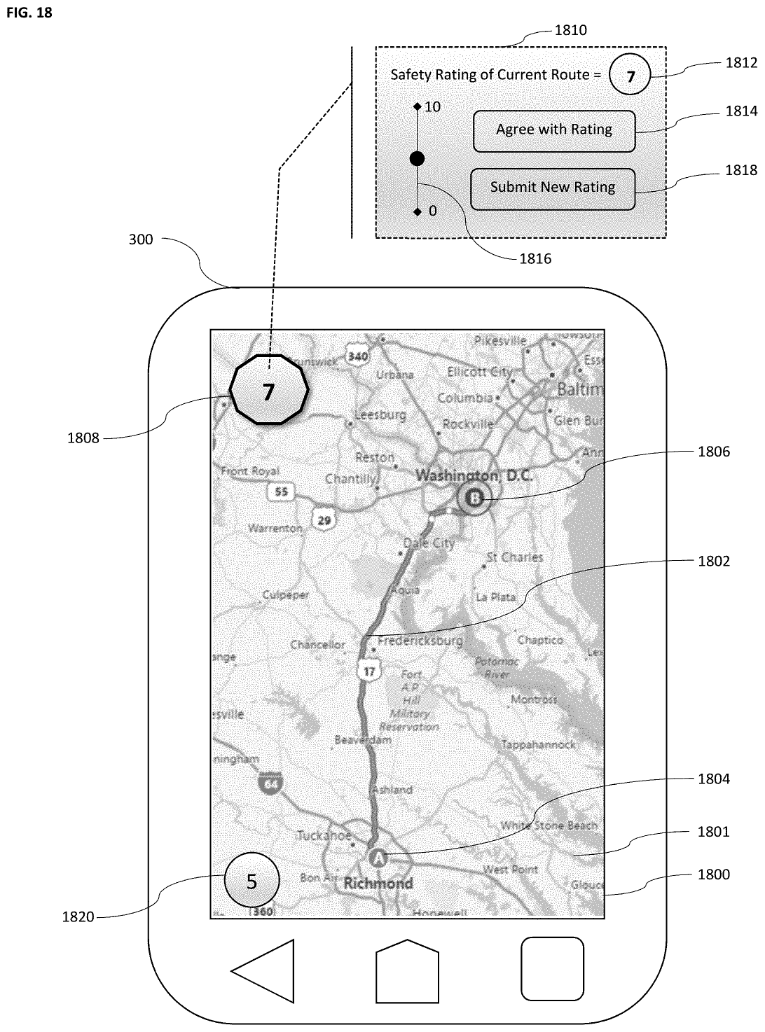

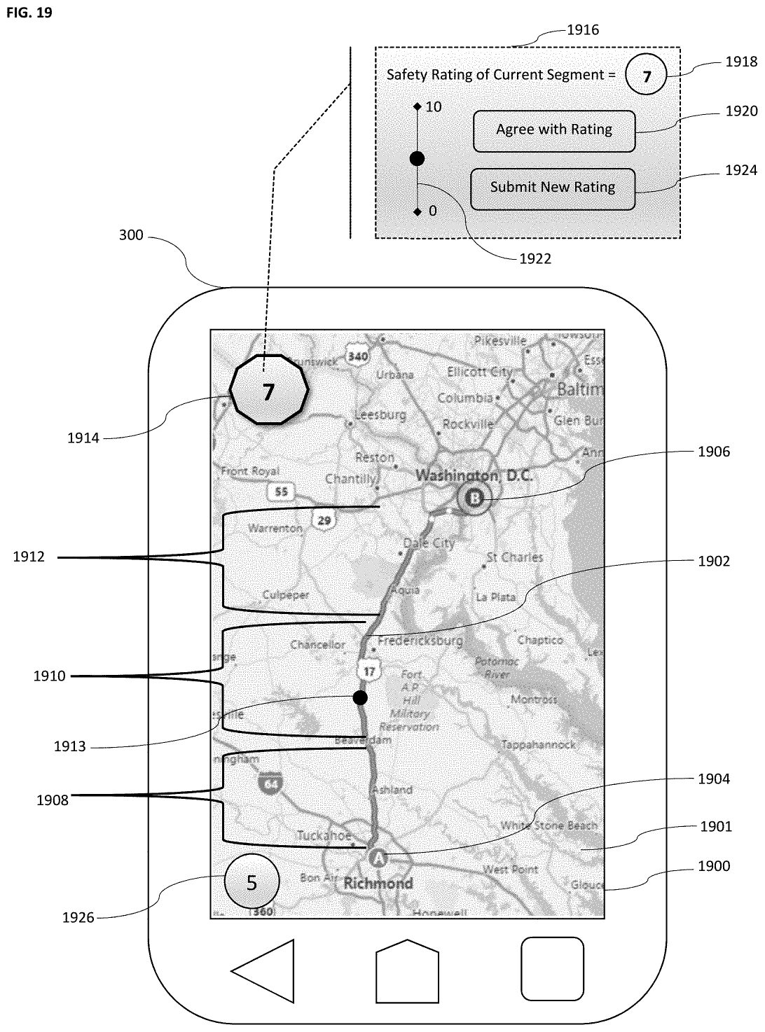

In operation 1618, the client device 300 outputs a representation of the first route and/or a representation of the first safety rating. A representation may be, for example, any visual, audible, tactile, and/or other indicia or form of representation, or any combination thereof, that provides the user of the client device 300 with information. In some embodiments, the output may occur on the display 310 of the client device 300, as illustrated in FIGS. 18-23. Further, the output may occur on another or an additional digital display, on printed physical media, or in any suitable format for its intended use. For example, audible and/or tactile output may be preferred by visually impaired users. Additionally or alternatively, in some embodiments the output may occur on a second device that is distinct from the client device 300. After operation 1618, the process 1600 proceeds to operation 1620.

In operation 1620, the client device 300 determines whether travel has commenced along the route last received from the server system 101 during operation 1608. The route last received may be, for example, the first route (see operation 1608) or the new route (see operation 1616) depending on the operations previously performed by the process 1600. Upon a negative determination that travel has not commenced, operation 1620 is repeated again. Otherwise, upon a positive determination that travel has commenced, the process 1600 proceeds to operation 1622.

In operation 1622, in response to a predetermined condition, the client device 300 transmits, to the server system 101, a request for: (a) an updated route between and including the current location of the client device 300 (or the user of the client device 300) and the destination; and (b) an updated safety rating for the updated route that indicates an estimated likelihood of a traveler along the updated route being put in danger. In some instances, the updated route may identify a remaining portion of a route presently traveled by the client device 300 (or the user of the client device 300) that has not yet been completed. The route presently traveled may be, for example, the first route (see operation 1608) or the new route (see operation 1616) depending on the operations previously performed by the process 1600. In some instances, the updated route may be different than the remaining portion of the route presently traveled while still sharing the same starting and ending points. In that situation, the updated route is an alternative to the remaining portion of the route presently traveled as they share the same starting and ending points.

The predetermined condition may include, but is not limited to, the following examples: (a) a predetermined time interval having elapsed; (b) an expiration of a timer; (c) a periodic or random execution of the operation; (d) an occurrence of an action or the detection of a state, which may for example include a detection that the first client device 300 has commenced travel and/or has traveled a predetermined distance along the route; (e) a report safety condition request having been received from the first client device 300 (as described in more detail below with respect to operation 448) when the condition location is within a predetermined distance from the presently traveled route; and (f) the identification of a live danger condition by the server system 101 (as described in more detail below with regard to operation 440) when the live danger location is within a predetermined distance from the presently traveled route.

In operation 1624, the client device 300 receives a second data structure including an indication of an updated route and an indication of an updated safety rating for the updated route, from the server system 101. In some embodiments, the second data structure may also include additional information items. The additional information items may contain data concerning the updated route or any portion thereof, the updated safety rating, and/or the destination. For example, such additional information items may include a warning about a dangerous portion of the first route (e.g., “many recent carjackings in this area”), additional explanation about the first safety rating (e.g., “the safety rating for this area has declined 50% in the last month” (which may be indicative of a spate of recent crimes)), or a warning about the destination (e.g., “fire reported close to the destination”).

In operation 1626, the client device 300 outputs a representation of the updated route and a representation of the updated safety rating. A representation may be, for example, any visual, audible, tactile, and/or other indicia or form of representation, or any combination thereof, that provides the user of the client device 300 with information. In some embodiments, the output may occur on the display 310 of the client device 300, as illustrated in FIGS. 18-23. Further, the output may occur on another or an additional digital display, on printed physical media, or in any suitable format for its intended use. For example, audible and/or tactile output may be preferred by visually impaired users. Additionally or alternatively, in some embodiments the output may occur on a second device that is distinct from the client device 300.

In operation 1628, the client device 300 detects input specifying a new rating (also referred to herein as a ‘user-provided safety rating’). The new rating indicates an estimated likelihood of a traveler at a new rating location associated with the new rating being put in danger, as determined by the client device 300 (or the user of the client device 300). The input may be a numerical figure, a color, and/or any visual, audible, tactile (including a predetermined type of touch gesture being performed on the touchscreen 314 of the client device 300), or other input that is capable of capturing or specifying information provided by the user of the client device 300. The new rating location may be, for example, a current location of the client device 300 (or the user of the client device 300) at the time when input specifying the new rating is detected. In some embodiments, the new rating location may be a user-provided location that the client device 300 detects as input.

In operation 1630, the client device 300 transmits an indication of the new rating and an indication of the new rating location to the server system 101.

In operation 1632, the client device 300 receives a live danger alert data structure including an indication of a live danger condition and an indication of a live danger location associated with the live danger condition, from the server system 101. Examples of a live danger condition include: criminal activity such as carjackings and gun violence; unsafe road conditions such as icy roads, a lack of street lighting, and a multi-vehicle collision; severe weather such as a tornado, a fire, and a flood; and other unsafe conditions that may affect a traveler.

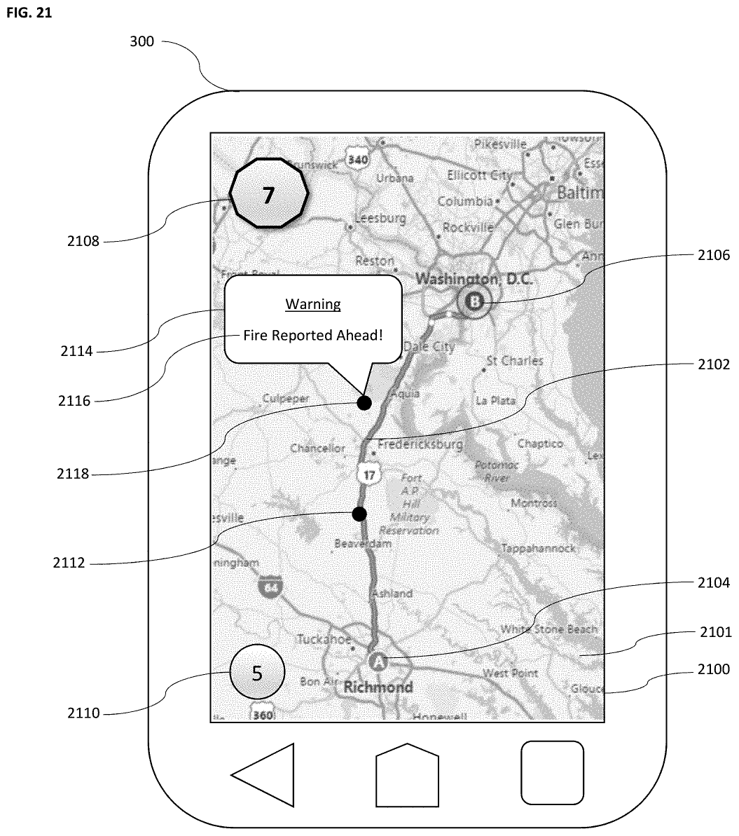

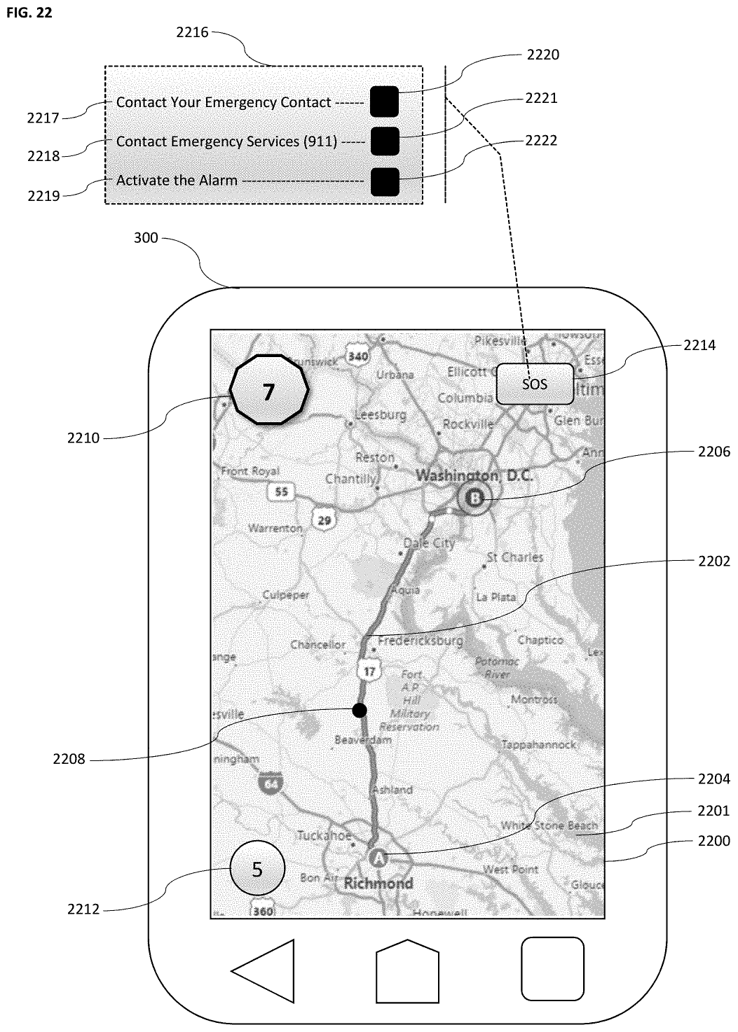

In operation 1634, the client device 300 outputs a representation of the live danger condition, an embodiment of which is illustrated in FIG. 21. In some embodiments, the client device 300 may additionally output a representation of the live danger location. A representation may be, for example, any visual, audible, tactile, and/or other indicia or form of representation, or any combination thereof, that is capable of providing the user of the client device 300 with information. For example, the live danger condition may be represented by text, a drawing, a photo, an animation, and/or other visual indicia. In some embodiments the output may occur on the display 310 of the client device 300, as illustrated in FIGS. 18-23. Further, the output may occur on another or an additional digital display, on printed physical media, or in any suitable format for its intended use. For example, audible and/or tactile indicia may be preferred by visually impaired users. Additionally or alternatively, in some embodiments the output may occur on a second device that is distinct from the client device 300.

In operation 1636, the client device 300 detects input specifying an SOS request. The input may be a numerical figure, a color, and/or any visual, audible, tactile (including a predetermined type of touch gesture being performed on the touchscreen 314 of the client device 300), or other input that is capable of capturing or specifying information provided by the user of the client device 300. The SOS request may be at least one of: (a) a request to contact emergency services; (b) a request to contact an emergency contact; and (c) a request to activate an alarm. In some embodiments, the SOS request may also be a user-defined customized request as determined by the client device 300 (or the user of the client device 300). In some embodiments, the SOS request may also include additional information items. The additional information items may include at least one of a user identification, a vehicle identification, a last known location of the client device 300 (or the user of the client device 300), a description of the reasons for the SOS request, information regarding an emergency contact including contact information, and/or other information relevant to the SOS request.

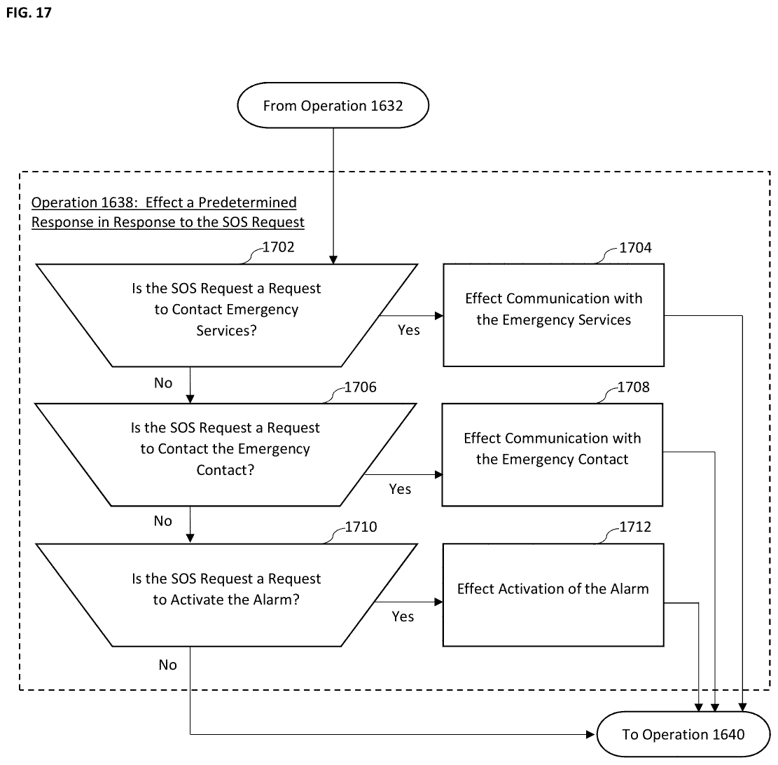

In operation 1638, the client device 300 may effect a predetermined response in response to the SOS request, an embodiment of which is discussed below with reference to FIG. 17. For example, the client device 300 may effect communication with emergency service in response to receiving an SOS request to contact emergency services. In some embodiments, the predetermined response (e.g., effecting communication with emergency services) may also include additional information items. The additional information items may include at least one of a user identification, a vehicle identification, a last known location of the client device 300 (or the user of the client device 300), a description of the reasons for the SOS request, information regarding an emergency contact including contact information, and/or other information relevant to the SOS request.

In operation 1640, the client device 300 transmits an indication of the SOS request to the server system 101. In some embodiments, the SOS request may also include additional information items. The additional information items may include at least one of a user identification, a vehicle identification, a last known location of the client device 300 (or the user of the client device 300), a description of the reasons for the SOS request, information regarding an emergency contact including contact information, and/or other information relevant to the SOS request.

In operation 1642, the client device 300 detects input specifying a report safety condition request. The input may be a numerical figure, a color, and/or any visual, audible, tactile (including a predetermined type of touch gesture being performed on the touchscreen 314 of the client device 300), or other input that is capable of capturing or specifying information provided by the user of the client device 300. The report safety condition request may be one of: (a) a request to report an unsafe condition; (b) a request to report criminal activity; and (c) a request to report a severe weather condition. In some embodiments, the report safety condition request may also be a user-defined customized request as determined by the client device 300 (or the user of the client device 300).

It should be understood that the term “request” when referring to any of the above report safety condition requests should not necessarily be construed as a request by the client device 300 (or a user of the client device 300) to effect any particular action or response for, or on behalf of, the client device 300 (or a user of the client device 300). Rather, the term “request” should be construed more generally as either being only a report or additionally as a request in the ordinary sense of the word. In particular, the intent of the client device 300 (or a user of the client device 300) may simply be to report a safety condition without requesting any particular action or response for, or on behalf of, the client device 300 (or a user of the client device 300). Nonetheless, such a report safety condition request may result in the server system 101 taking action in response thereto that impacts the client device 300 (or a user of the client device 300) that made the request. In such a situation, the term “request” is used in the ordinary sense of the word.

In operation 1644, the client device 300 transmits an indication of the report safety condition request and an indication of identifying information to the server system 101. The identifying information may include at least one of a condition type (e.g., carjacking), a condition location, a condition description, a user identification, a vehicle identification, and/or other information relevant to the report safety condition request.

In operation 1646, the client device 300 determines whether the client device 300 (or the user of the client device 300) has completed travel to the destination. Upon a negative determination that the client device 300 (or the user of the client device 300) has not yet completed travel to the destination, the process 1600 proceeds to operation 1622.

With reference to FIG. 17, a flowchart is depicted of an embodiment of a subprocess associated with effecting a predetermined response in response to an SOS request, as shown by operation 1638 in FIG. 16C, according to aspects of the disclosure. In this embodiment, operation 1638 may include the following subtasks: determining whether the SOS request is a request to contact emergency services (operation 1702); effecting communication with the emergency services (operation 1704); determining whether the SOS request is a request to contact an emergency contact (operation 1706); effecting communication with the emergency contact (operation 1708); determining whether the SOS request is a request to activate an alarm (operation 1710); and effecting activation of the alarm (operation 1712). As discussed above with regard to operation 1636, the SOS request may be at least one of: (a) a request to contact emergency services; (b) a request to contact an emergency contact; (c) a request to activate an alarm. In some embodiments, the SOS request may also be a user-defined customized request as determined by the client device 300 (or the user of the client device 300).

In operation 1702, the client device 300 determines whether the SOS request is a request to contact emergency services. Upon a positive determination that the SOS request is a request to contact emergency services, the process continues to operation 1704. Otherwise, upon on a negative determination that the SOS request is not a request to contact emergency services, the process continues to operation 1706.

In operation 1704, the client device 300 effects communication with the emergency services. For example, the client device 300 may effect communication with law enforcement (e.g., a local police department), fire and rescue services (e.g., a local fire department), emergency medical services (e.g., ambulance services for transportation to a hospital), and/or other providers of emergency services. As discussed above with regard to operation 1638, in some embodiments the predetermined response may also include additional information items. The additional information items may include at least one of a user identification, a vehicle identification, a last known location of the client device 300 (or the user of the client device 300), a description of the reasons for the SOS request, information regarding an emergency contact including contact information, and/or other information relevant to the SOS request. After communication has been effected with the emergency services, the process continues to operation 1640.

In some embodiments, the client device 300 may utilize the additional information items to determine with which of the emergency services to effect communication. For example, the client device 300 may effect communication with the local fire department in response to detecting the existence of a keyword such as ‘fire’ in the description of the reasons for the SOS request, such description being an additional information item described above.

In some embodiments, the client device 300 may additionally transmit some of the additional information items to the emergency services. For example, the client device 300 may transmit the vehicle identification and the user identification to the local police in order to facilitate identification of the client device 300 (or the user of the client device 300). In another example, the client device 300 may transmit the last known location of the client device 300 (or the user of the client device 300) to emergency medical services so that an ambulance may be dispatched to the last known location.

In operation 1706, the client device 300 determines whether the SOS request is a request to contact an emergency contact. Upon a positive determination that the SOS request is a request to contact an emergency contact, the process continues to operation 1708. Otherwise upon on a negative determination that the SOS request is not a request to contact an emergency contact, the process continues to operation 1710.

In operation 1708, the client device 300 effects communication with the emergency contact. In some embodiments, the client device 300 may utilize contact information that is detected as input, previously stored on the client device 300, and/or received from the server system 101 in order to effect communication with the emergency contact. For example, such contact information may include a telephone number, email address, username for an online messaging service (e.g., Skype, Facebook Messenger, WhatsApp, and/or the like), and/or other information related to the emergency contact. As discussed above with regard to operation 1638, in some embodiments the predetermined response may also include additional information items. The additional information items may include at least one of a user identification, a vehicle identification, a last known location of the client device 300 (or the user of the client device 300), a description of the reasons for the SOS request, information regarding the emergency contact including contact information, and/or other information relevant to the SOS request. After communication has been effected with the emergency contact, the process continues to operation 1640.

In some embodiments, the client device 300 may additionally transmit some of the additional information items to the emergency contact. For example, the client device 300 may transmit the description of the reasons for the SOS request to the emergency contact. In another example, the client device 300 may transmit the last known location of the client device 300 (or the user of the client device 300) to the emergency contact.

In operation 1710, the client device 300 determines whether the SOS request is a request to activate an alarm. Upon a positive determination that the SOS request is a request to activate an alarm, the process continues to operation 1712. Otherwise upon on a negative determination that the SOS request is not a request to activate an alarm, the process continues to operation 1640.

In operation 1712, the client device 300 effects activation of the alarm. As discussed above with regard to operation 1638, in some embodiments the predetermined response may also include additional information items. The additional information items may include at least one of a user identification, a vehicle identification, a last known location of the client device 300 (or the user of the client device 300), a description of the reasons for the SOS request, information regarding an emergency contact including contact information, and/or other information relevant to the SOS request. In some embodiments, an alarm on the client device 300 itself may be activated. In some embodiments, an alarm for a vehicle being operated by a user of the client device 300 may be activated (e.g., a car alarm, an alarm connected to a third-party service provider such as ONSTAR or LOJACK). After the system has effected activation of the alarm, the process continues to operation 1640.

In some embodiments, the client device 300 may additionally transmit some of the additional information items to the third-party service provider (e.g., ONSTAR, LOJACK, etc.). For example, the client device 300 may transmit the last known location of the client device 300 (or the user of the client device 300) to the third-party service provider. In another example, the client device 300 may transmit the description of the reasons for the SOS request to the third-party service provider.

With reference to FIG. 18, a diagram is depicted of an embodiment of a user interface for a client device 300, according to aspects of the disclosure. As illustrated, the user interface may include a screen 1800. The screen 1800 may be outputted on a display 310 of the client device 300, when the client device 300 receives a route from a server system 101 as discussed above with regard to operation 1608. As illustrated, the screen 1800 may include a map area 1801 and push buttons 1808 and 1820.

According to aspects of the disclosure, the map area 1801 may include map elements 1802, 1804, and 1806. The client device 300 may obtain the map area 1801 from the server system 101 and/or directly from an external map database 105. The map elements 1802, 1804, and 1806 may be overlaid or superimposed over the map area 1801 by the server system 101, the external map database 105, and/or the client device 300. As discussed in greater detail above with reference to FIG. 1, the server system 101 may include an internal map database 104 and may additionally or alternatively interact with the external map database 105. The map databases 104-105 store maps and mapping information that identify street layouts, intersection locations, geo-coded addresses, building locations, and other information that is typically found in a maps database. The map element 1802 is a visual representation of the route between and including a starting location 1804 and a destination 1806. The map elements 1804 and 1806 are visual representations of the starting location for the route and the destination for the route, respectively.

As illustrated, the push buttons 1808 and 1820 may be overlaid or superimposed over the map area 1801 by the server system 101 and/or the client device 300. In an alternative embodiment, any of the push buttons 1808 and 1820 may be located separate from the map area 1801. The push button 1808 may include a visual representation of a safety rating associated with the route, the safety rating having been received from the server system 101 as discussed above with regard to operation 1608. The safety rating indicates an estimated likelihood of a traveler along the route being put in danger. The safety rating may be represented by, for example, a numerical figure (as illustrated), a color, and/or any visual, audible, tactile, or other indicia or form of representation that is capable of providing the user of the client device 300 with information, or any combination thereof, as discussed above with regard to operation 1608. In some embodiments, the push button 1808 may be replaced with any other suitable type of user input component.

When push button 1808 is pressed, a pop-up window 1810 is launched and opened. In some embodiments, the pop-up window 1810 may be replaced with any other suitable type of user interface message or notification. In an alternative embodiment, when push button 1808 is pressed, the client device 300 may hide the screen 1800 and display in its place an alternate screen that may include the same user interface elements and/or may perform the same functions as the pop-up window 1810. Additionally or alternatively, in some embodiments the push button 1808 may be omitted and the pop-up window 1810 may be launched (or the alternate screen displayed) in response to a predetermined type of touch gesture being performed on the touchscreen 314 of the client device 300.

According to aspects of the disclosure, the pop-up window 1810 may include, for example, an informational element 1812, a range slider 1816, push buttons 1814 and 1818, and any combination thereof. The informational element 1812 may include a visual representation of the safety rating associated with the route. The safety rating may be represented by, for example, a numerical figure (as illustrated), a color, and/or any visual, audible, tactile, or other indicia or form of representation that is capable of providing the user of the client device 300 with information, or any combination thereof, as discussed above with regard to operation 1608. A user of the client device 300 may determine whether they agree or disagree with the safety rating previously received from the server system 101. The user of the client device 300 may press the push button 1814 to indicate agreement with the safety rating previously received from the server system 101. In some embodiments, the push button 1814 may be replaced with any other suitable type of user input component. When the push button 1814 is pressed, the client device 300 may transmit to the server system 101 an indication of a new user-provided safety rating (as discussed above with regard to operations 1628-1630) that is equivalent to the safety rating previously received from the server system 101. Additionally or alternatively, in some embodiments when the push button 1814 is pressed, the client device 300 may transmit to the server system 101 an indication that the safety rating previously received from the server system 101 was correct (for example, using a binary bit flag). In some embodiments, the client device 300 may also transmit an indication of a new rating location associated with the new user-determined safety rating to the server system 101. The new rating location may be, for example, a current location of the client device 300 (or the user of the client device 300) at the time when the push button 1814 is pressed. In some embodiments, the new rating location may be a user-provided location that is input by the user of the client device 300.

The user of the client device 300 may manipulate the range slider 1816 and then press the push button 1818 to indicate disagreement with the safety rating previously received from the server system 101. The range slider 1816 may be manipulated to specify a new user-provided safety rating (as discussed above with regard to operation 1628) that indicates an estimated likelihood of a traveler being put in danger at the new rating location as determined by the user of the client device 300. In some embodiments, the range slider 1816 may be replaced with any other suitable type of user input component, such as radio buttons, a drop-down menu, etc. Additionally or alternatively, in some embodiments the range slider 1816 may be omitted and the user of the client device 300 may specify the user-determined safety rating by performing a predetermined type of touch gesture on the touchscreen 314 of the client device 300. When the push button 1818 is pressed, the client device 300 may transmit to the server system 101 an indication of the new user-provided safety rating. In some embodiments, the client device 300 may also transmit an indication of the new rating location associated with the new user-provided safety rating to the server system 101. The new rating location may be, for example, a current location of the client device 300 (or the user of the client device 300) at the time when the push button 1814 is pressed. In some embodiments, the new rating location may be a user-provided location that is input by the user of the client device 300. In some embodiments, the push button 1818 may be replaced with any other suitable type of user input component.

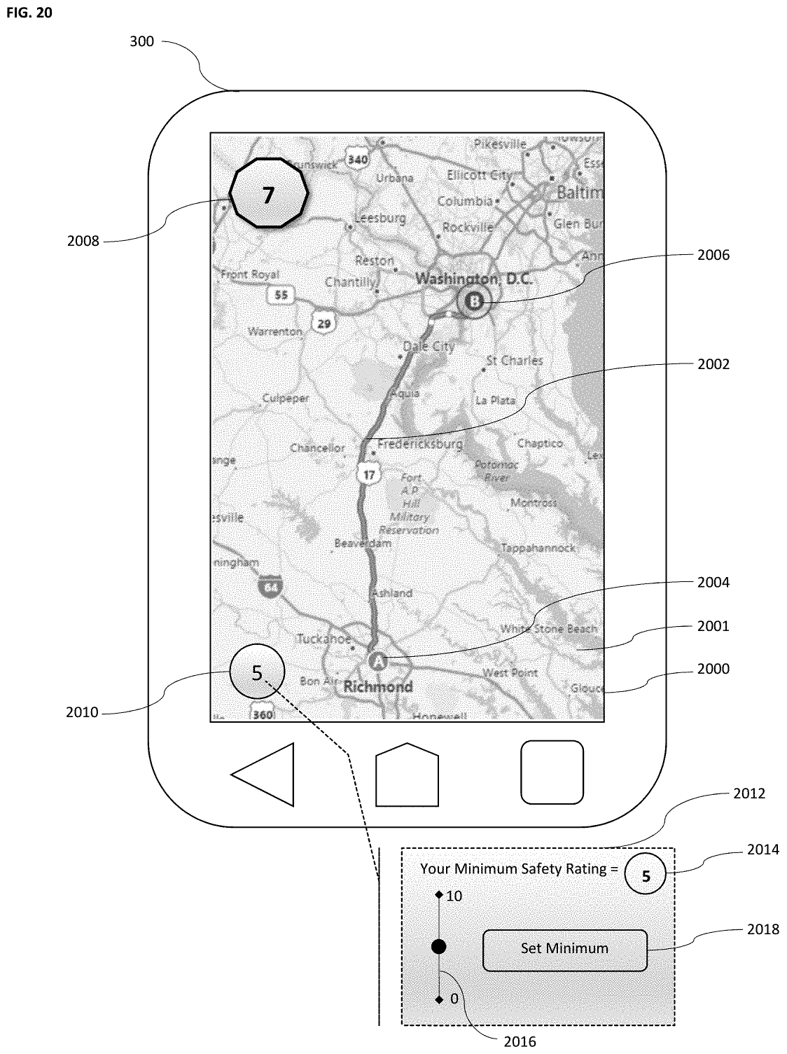

As illustrated, the push button 1820 may include a visual representation of a minimum safety threshold specified by the client device 300 (or the user of the client device 300). The minimum safety threshold may, for example, be a numerical figure (as illustrated), a color, and/or any visual, audible, tactile, or other indicia or form of representation that is capable of providing the user of the client device 300 with information, or any combination thereof, as discussed above with regard to operation 1604. The minimum safety threshold indicates the lowest safety rating that is acceptable to the client device 300 (or acceptable to the user of the client device 300). In some embodiments, the push button 1820 may be replaced with any other suitable type of user input component. In some embodiments, when the push button 1820 is pressed, the result may be the user interface depicted in the diagram of FIG. 20 as described hereinbelow.

With reference to FIG. 19, a diagram is depicted of an embodiment of a user interface for a client device 300, according to aspects of the disclosure. As illustrated, the user interface may include a screen 1900. The screen 1900 may be outputted on a display 310 of the client device 300, when the client device 300 receives a route from a server system 101 as discussed above with regard to operation 1608. As illustrated, the screen 1900 may include a map area 1901 and push buttons 1914 and 1926.

According to aspects of the disclosure, the map area 1901 may include map elements 1902-1913. The client device 300 may obtain the map area 1901 from the server system 101 and/or directly from an external map database 105. The map elements 1902-1913 may be overlaid or superimposed over the map area 1901 by the server system 101, the external map database 105, and/or the client device 300. As discussed in greater detail above with reference to FIG. 1, the server system 101 may include an internal map database 104 and may additionally or alternatively interact with the external map database 105. The map databases 104-105 store maps and mapping information that identify street layouts, intersection locations, geo-coded addresses, building locations, and other information that is typically found in a maps database. The map element 1902 is a visual representation of the route between and including a starting location 1904 and a destination 1906. The map elements 1904 and 1906 are visual representations of the starting location for the route and the destination for the route, respectively. The map elements 1908, 1910, and 1912 are visual representations of three portions or segments of the route. Each of the segments 1908, 1910, and 1912 of the route may be made visually distinct from the other segments by having a unique visual representation, for example, by the use of visual distinctions in color, style (e.g., a width, dash, shape, texture, or pattern), and/or other visual indicia. The map element 1913 is a visual representation of a current location of the client device 300 (or a user of the client device 300).

As illustrated, the push buttons 1914 and 1926 may be overlaid or superimposed over the map area 1901 by the server system 101 and/or the client device 300. In an alternative embodiment, any of the push buttons 1914 and 1926 may be located separate from the map area 1901. The push button 1914 may include a visual representation of a safety rating associated with a current segment of the route, the safety rating having been received from the server system 101 as discussed above with regard to operation 1608. The current segment of the route may be the segment that includes the current location of the client device 300 (or the user of the client device 300). For example, as illustrated the segment 1910 is the current segment since it includes the current location 1913 of the client device 300 (or a user of the client device 300), and consequently the push button 1914 includes a visual representation of the safety rating associated with the segment 1910. The safety rating associated with the current segment of the route indicates an estimated likelihood of a traveler along the current segment of the route being put in danger. The safety rating associated with the current segment of the route may be represented by, for example, a numerical figure (as illustrated), a color, and/or any visual, audible, tactile, or other indicia or form of representation that is capable of providing the user of the client device 300 with information, or any combination thereof, as discussed above with regard to operation 1608. In some embodiments, the push button 1914 may be replaced with any other suitable type of user input component.

When push button 1914 is pressed, a pop-up window 1916 is launched and opened. In some embodiments, the pop-up window 1916 may be replaced with any other suitable type of user interface message or notification. In an alternative embodiment, when push button 1914 is pressed, the client device 300 may hide the screen 1900 and display in its place an alternate screen that may include the same user interface elements and/or may perform the same functions as the pop-up window 1916. Additionally or alternatively, in some embodiments the push button 1914 may be omitted and the pop-up window 1916 may be launched (or the alternate screen displayed) in response to a predetermined type of touch gesture being performed on the touchscreen 314 of the client device 300.

According to aspects of the disclosure, the pop-up window 1916 may include, for example, an informational element 1918, a range slider 1922, push buttons 1920 and 1924, or any combination thereof. The informational element 1918 may include a visual representation of the safety rating associated with the current segment of the route. The safety rating associated with the current segment of the route may be represented by, for example, a numerical figure (as illustrated), a color, and/or any visual, audible, tactile, or other indicia or form of representation that is capable of providing the user of the client device 300 with information, or any combination thereof, as discussed above with regard to operation 1608. A user of the client device 300 may determine whether they agree or disagree with the safety rating previously received from the server system 101. The user of the client device 300 may press the push button 1920 to indicate agreement with the safety rating associated with the current segment, that was previously received from the server system 101. When the push button 1920 is pressed, the client device 300 may transmit to the server system 101 an indication of a new user-provided safety rating (as discussed above with regard to operations 1628-1630) for the current segment of the route that is equivalent to the safety rating previously received from the server system 101. Additionally or alternatively, in some embodiments when the push button 1920 is pressed, the client device 300 may transmit to the server system 101 an indication that the safety rating previously received from the server system 101 was correct (for example, using a binary bit flag). In some embodiments, the client device 300 may also transmit to the server system 101 an indication of a new rating location associated with the new user-determined safety rating for the current segment of the route. The new rating location may be, for example, the current location of the client device 300 (or the user of the client device 300) at the time when the push button 1920 is pressed. In some embodiments, the new rating location may be a user-provided location that is input by the user of the client device 300. In some embodiments, the push button 1920 may be replaced with any other suitable type of user input component.

The user of the client device 300 may manipulate the range slider 1922 and then press the push button 1924 to indicate disagreement with the safety rating associated with the current segment, that was previously received the server system 101. The range slider 1922 may be manipulated to specify a new user-provided safety rating (as discussed above with regard to operation 1628) that indicates an estimated likelihood of a traveler along the current segment of the route being put in danger at the new rating location as determined by the user of the client device 300. In some embodiments, the range slider 1922 may be replaced with any other suitable type of user input component, such as radio buttons, a drop-down menu, etc. Additionally or alternatively, in some embodiments the ranger slider 1922 may be omitted and the user of the client device 300 may specify the user-determined safety rating by performing a predetermined type of touch gesture on the touchscreen 314 of the client device 300. When the push button 1924 is pressed, the client device 300 may transmit to the server system 101 an indication of the new user-provided safety rating for the current segment of the route. In some embodiments, the client device 300 may also transmit to the server system 101 an indication of the new rating location associated with the new user-provided safety rating for the current segment of the route. The new rating location may be, for example, the current location of the client device 300 (or the user of the client device 300) at the time when the push button 1924 is pressed. In some embodiments, the new rating location may be a user-provided location that is input by the user of the client device 300. In some embodiments, the push button 1924 may be replaced with any other suitable type of user input component.

As illustrated, the push button 1926 may include a visual representation of a minimum safety threshold specified by the client device 300 (or the user of the client device 300). The minimum safety threshold may, for example, be a numerical figure (as illustrated), a color, and/or any visual, audible, tactile, or other indicia or form of representation that is capable of providing the user of the client device 300 with information, or any combination thereof, as discussed above with regard to operation 1604. The minimum safety threshold indicates the lowest safety rating that is acceptable to the client device 300 (or acceptable to the user of the client device 300). In some embodiments, the push button 1926 may be replaced with any other suitable type of user input component. In some embodiments, when the push button 1926 is pressed, the result may be the user interface depicted in the diagram of FIG. 20 as described hereinbelow.

With reference to FIG. 20, a diagram is depicted of an embodiment of a user interface for a client device 300, according to aspects of the disclosure. As illustrated, the user interface may include a screen 2000. The screen 2000 may be outputted on a display 310 of the client device 300, when the client device 300 receives a route from a server system 101 as discussed above with regard to operation 1608. As illustrated, the screen 2000 may include a map area 2001 and push buttons 2008 and 2010.

According to aspects of the disclosure, the map area 2001 may include map elements 2002, 2004, and 2006. The client device 300 may obtain the map area 2001 from the server system 101 and/or directly from an external map database 105. The map elements 2002, 2004, and 2006 may be overlaid or superimposed over the map area 2001 by the server system 101, the external map database 105, and/or the client device 300. As discussed in greater detail above with reference to FIG. 1, the server system 101 may include an internal map database 104 and may additionally or alternatively interact with the external map database 105. The map databases 104-105 store maps and mapping information that identify street layouts, intersection locations, geo-coded addresses, building locations, and other information that is typically found in a maps database. The map element 2002 is a visual representation of the route between and including a starting location 2004 and a destination 2006. The map elements 2004 and 2006 are visual representations of the starting location for the route and the destination for the route, respectively.

As illustrated, the push buttons 2008 and 2010 may be overlaid or superimposed over the map area 2001 by the server system 101 and/or the client device 300. In an alternative embodiment, any of the push buttons 2008 and 2010 may be located separate from the map area 2001. The push button 2008 may include a visual representation of a safety rating associated with the route, the safety rating having been received from the server system 101 as discussed above with regard to operation 1608. The safety rating indicates an estimated likelihood of a traveler along the route being put in danger. The safety rating may be represented by, for example, a numerical figure (as illustrated), a color, and/or any visual, audible, tactile, or other indicia or form representation that is capable of providing the user of the client device 300 with information, or any combination thereof, as discussed above with regard to operation 1608. In some embodiments, the push button 2008 may be replaced with any other suitable type of user input component. In some embodiments, when the push button 2008 is pressed, the result may be one of the user interfaces depicted in the diagrams of FIGS. 18-19 as described hereinabove.

As illustrated, the push button 2010 may include a visual representation of a minimum safety threshold specified by the client device 300 (or the user of the client device 300). The minimum safety threshold may, for example, be a numerical figure (as illustrated), a color, and/or any visual, audible, tactile, or other indicia or form of representation that is capable of providing the user of the client device 300 with information, or any combination thereof, as discussed above with regard to operation 1604. The minimum safety threshold indicates the lowest safety rating that is acceptable to the client device 300 (or acceptable to the user of the client device 300). In some embodiments, the push button 2010 may be replaced with any other suitable type of user input component.

When push button 2010 is pressed, a pop-up window 2012 is launched and opened. In some embodiments, the pop-up window 2012 may be replaced with any other suitable type of user interface message or notification. In an alternative embodiment, when push button 2010 is pressed, the client device 300 may hide the screen 2000 and display in its place an alternate screen that may include the same user interface elements and/or may perform the same functions as the pop-up window 2016. Additionally or alternatively, in some embodiments the push button 2010 may be omitted and the pop-up window 2012 may be launched (or the alternate screen displayed) in response to a predetermined type of touch gesture being performed on the touchscreen 314 of the client device 300.

According to aspects of the disclosure, the pop-up window 2012 may include, for example, an informational element 2014, a range slider 2016, push button 2018, or any combination thereof. The informational element 2014 may include a visual representation of the minimum safety threshold specified by the client device 300 (or the user of the client device 300). The minimum safety threshold may be, for example, a numerical figure (as illustrated), a color, and/or any visual, audible, tactile, or other indicia or form of representation that is capable of providing the user of the client device 300 with information, or any combination thereof, as discussed above with regard to operation 1604. The minimum safety threshold indicates the lowest safety rating that is acceptable to the client device 300 (or acceptable to the user of the client device 300).

A user of the client device 300 may decide to change the minimum safety threshold. The user of the client device 300 may manipulate the range slider 2016 and then press the push button 2018 to change indicate disagreement with the safety rating previously received from the server system 101. The range slider 2016 may be manipulated to specify a new minimum safety threshold that indicates the lowest safety rating that is acceptable to the client device 300 (or acceptable to the user of the client device 300). In some embodiments, the range slider 2016 may be replaced with any other suitable type of user input component, such as radio buttons, a drop-down menu, etc. Additionally or alternatively, in some embodiments the range slider 2016 may be omitted and the user of the client device 300 may specify the new minimum safety threshold by performing a predetermined type of touch gesture on the touchscreen 314 of the client device 300. When the push button 2018 is pressed, the client device 300 may transmit to the server system 101 an indication of the new minimum safety threshold. In some embodiments, the push button 2018 may be replaced with any other suitable type of user input component.

With reference to FIG. 21, a diagram is depicted of an embodiment of a user interface for a client device 300, according to aspects of the disclosure. As illustrated, the user interface may include a screen 2100. The screen 2100 may be outputted on a display 310 of the client device 300, when the client device 300 receives a route from a server system 101 as discussed above with regard to operation 1608. As illustrated, the screen 2100 may include a map area 2101, push buttons 2108 and 2110, and/or balloon notification 2114.

According to aspects of the disclosure, the map area 2101 may include map elements 2102, 2104, 2106, 2112, and 2118. The client device 300 may obtain the map area 2101 from the server system 101 and/or directly from an external map database 105. The map elements 2102, 2104, 2106, 2112, and 2118 may be overlaid or superimposed over the map area 2101 by the server system 101, the external map database 105, and/or the client device 300. As discussed in greater detail above with reference to FIG. 1, the server system 101 may include an internal map database 104 and may additionally or alternatively interact with the external map database 105. The map databases 104-105 store maps and mapping information that identify street layouts, intersection locations, geo-coded addresses, building locations, and other information that is typically found in a maps database. The map element 2102 is a visual representation of the route between and including a starting location 2104 and a destination 2106. The map elements 2104 and 2106 are visual representations of the starting location for the route and the destination for the route, respectively. The map element 2112 is a visual representation of a current location of the client device 300 (or a user of the client device 300). The map element 2118 is a visual representation of a live danger location that is associated with a live danger condition, the live danger location 2118 and the live danger condition having been received from the server system 101 as discussed above with regard to operation 1632

As illustrated, the push buttons 2108 and 2110 may be overlaid or superimposed over the map area 2101 by the server system 101 and/or the client device 300. In an alternative embodiment, any of the push buttons 2108 and 2110 may be located separate from the map area 2101. The push button 2108 may include a visual representation of a safety rating associated with the route, the safety rating having been received from the server system 101 as discussed above with regard to operation 1608. The safety rating indicates an estimated likelihood of a traveler along the route being put in danger. The safety rating may be represented, for example, by a numerical figure (as illustrated), a color, and/or any visual, audible, tactile, or other indicia or form of representation that is capable of providing the user of the client device 300 with information, or any combination thereof, as discussed above with regard to operation 1608. In some embodiments, the push button 2108 may be replaced with any other suitable type of user input component.

In some embodiments, when the push button 2108 is pressed, the result may be one of the user interfaces depicted in the diagrams of FIGS. 18-19 as described hereinabove. The push button 2110 may include a visual representation of a minimum safety threshold specified by the client device 300 (or the user of the client device 300). The minimum safety threshold may be, for example, a numerical figure (as illustrated), a color, and/or any visual, audible, tactile, or other indicia or form of representation that is capable of providing the user of the client device 300 with information, or any combination thereof, as discussed above with regard to operation 1604. The minimum safety threshold indicates the lowest safety rating that is acceptable to the client device 300 (or acceptable to the user of the client device 300). In some embodiments, the push button 2110 may be replaced with any other suitable type of user input component. In some embodiments, when the push button 2110 is pressed, the result may be the user interface depicted in the diagram of FIG. 20 as described hereinabove.

As illustrated, the balloon notification 2114 may be overlaid or superimposed over the map area 2101 by the server system 101, the external map database 105, and/or the client device 300. In some embodiments, the balloon notification 2114 may be replaced with any other suitable type of user interface message or notification. According to aspects of the disclosure, the balloon notification 2114 may include an informational element 2116. The informational element 2116 may include a visual representation of the live danger condition. The live danger condition may be represented by, for example, as text (as illustrated), a drawing, a photo, an animation, and/or any visual, audible, tactile, or other indicia or form of representation that is capable of providing the user of the client device 300 with information, or any combination thereof. For example, audible and/or tactile indicia may be preferred by visually impaired users.

As illustrated, the balloon notification 2114 may have a tail that points to the live danger location 2118 on the map area 2101 that is associated with the live danger condition. As illustrated, the live danger location 2118 need not be located directly on the route 2101; rather, the live danger location 2118 may be located within a predetermined distance from the route 2101 as discussed above with regard to operation 1632. The live danger condition that is illustrated in FIG. 21 concerns a “Fire Reported Ahead,” which is exemplary of a variety of conditions that may be determined to cause a statistically relevant increase in the estimated likelihood of a traveler along the route being put in danger. Such a statistically relevant increase is discussed in greater detail above with regard to operation 1306.

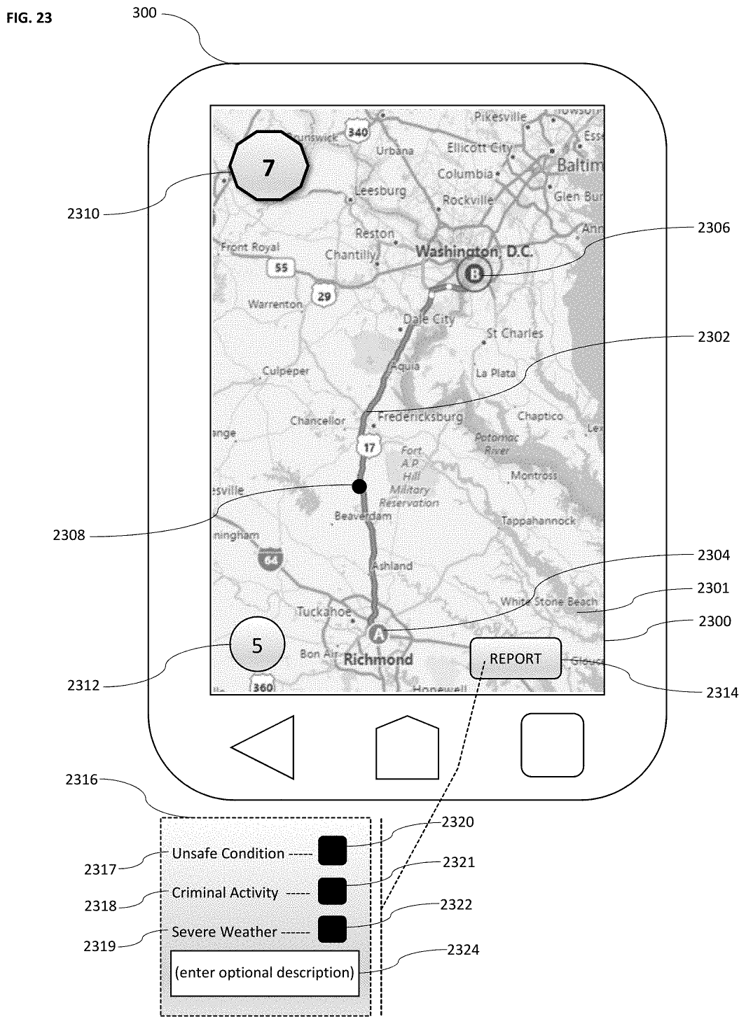

With reference to FIG. 22, a diagram is depicted of an embodiment of a user interface for a client device 300, according to aspects of the disclosure. As illustrated, the user interface may include a screen 2200. The screen 2200 may be outputted on a display 310 of the client device 300, when the client device 300 receives a route from a server system 101 as discussed above with regard to operation 1608. As illustrated, the screen 2200 may include a map area 2201, push buttons 2210 and 2212, and SOS button 2214.

According to aspects of the disclosure, the map area 2201 may include map elements 2202, 2204, 2206, and 2208. The client device 300 may obtain the map area 2201 from the server system 101 and/or directly from an external map database 105. The map elements 2202, 2204, 2206, and 2208 may be overlaid or superimposed over the map area 2201 by the server system 101, the external map database 105, and/or the client device 300. As discussed in greater detail above with reference to FIG. 1, the server system 101 may include an internal map database 104 and may additionally or alternatively interact with the external map database 105. The map databases 104-105 store maps and mapping information that identify street layouts, intersection locations, geo-coded addresses, building locations, and other information that is typically found in a maps database. The map element 2202 is a visual representation of the route between and including a starting location 2204 and a destination 2206. The map elements 2204 and 2206 are visual representations of the starting location for the route and the destination for the route, respectively. The map element 2208 is a visual representation of a current location of the client device 300 (or a user of the client device 300).

As illustrated, the push buttons 2210 and 2212 and the SOS button 2214 may be overlaid or superimposed over the map area 2201 by the server system 101 and/or the client device 300. In an alternative embodiment, any of the push buttons 2210 and 2212 and the SOS button 2214 may be located separate from the map area 2201. The push button 2210 may include a visual representation of a safety rating associated with the route, the safety rating having been received from the server system 101 as discussed above with regard to operation 1608. The safety rating indicates an estimated likelihood of a traveler along the route being put in danger. The safety rating may be represented by, for example, a numerical figure (as illustrated), a color, any visual, audible, tactile, or other indicia or form of representation that is capable of providing the user of the client device 300 with information, or any combination thereof, as discussed above with regard to operation 1608. In some embodiments, the push button 2210 may be replaced with any other suitable type of user input component. In some embodiments, when the push button 2210 is pressed, the result may be one of the user interfaces depicted in the diagrams of FIGS. 18-19 as described hereinabove.

As illustrated, the push button 2212 may include a visual representation of a minimum safety threshold specified by the client device 300 (or the user of the client device 300). The minimum safety threshold may, for example, be a numerical figure (as illustrated), a color, and/or any visual, audible, tactile, or other indicia or form of representation that is capable of providing the user of the client device 300 with information, or any combination thereof, as discussed above with regard to operation 1604. The minimum safety threshold indicates the lowest safety rating that is acceptable to the client device 300 (or acceptable to the user of the client device 300). In some embodiments, the push button 2212 may be replaced with any other suitable type of user input component. In some embodiments, when the push button 2212 is pressed, the result may be the user interface depicted in the diagram of FIG. 20 as described hereinabove.

When the SOS button 2214 is pressed, a pop-up window 2216 is launched and opened. In some embodiments, the SOS button 2214 may be replaced with any other suitable type of user input component. In some embodiments, the pop-up window 2216 may be replaced with any other suitable type of user interface message or notification. In an alternative embodiment, when the SOS button 2214 is pressed, the client device 300 may hide the screen 2200 and display in its place an alternate screen that may include the same user interface elements and/or may perform the same functions as the pop-up window 2216. Additionally or alternatively, in some embodiments the SOS button 2214 may be omitted and the pop-up window 2216 may be launched (or the alternate screen displayed) in response to a predetermined type of touch gesture being performed on the touchscreen 314 of the client device 300.

According to aspects of the disclosure, the pop-up window 2216 may include, for example, informational elements 2217-2219, push buttons 2220-2222, or any combination thereof. The informational element 2217 may include a visual representation that indicates the functionality associated with the push button 2220. As illustrated, in some embodiments the informational element 2217 may include the text “Contact Your Emergency Contact.” In some embodiments, when the client device 300 detects that the push button 2220 is pressed, the client device 300 may effect a predetermined response as discussed in greater detail above with regard to operation 1638. Additionally or alternatively, in some embodiments when the client device 300 detects that the push button 2220 is pressed, the client device 300 may transmit an SOS request to the server system 101 as discussed above with regard to operation 1640. In some embodiments, the push button 2220 may be replaced with any other suitable type of user input component.

The informational element 2218 may include a visual representation that indicates the functionality associated with the push button 2221. As illustrated, in some embodiments the informational element 2218 may include the text “Contact Emergency Services (911).” In some embodiments, when the client device 300 detects that the push button 2221 is pressed, the client device 300 may effect a predetermined response as discussed in greater detail above with regard to operation 1638. Additionally or alternatively, in some embodiments when the client device 300 detects that the push button 2221 is pressed, the client device 300 may transmit an SOS request to the server system 101 as discussed above with regard to operation 1640. In some embodiments, the push button 2221 may be replaced with any other suitable type of user input component.

The informational element 2219 may include a visual representation that indicates the functionality associated with the push button 2222. As illustrated, in some embodiments the informational element 2219 may include the text “Activate the Alarm.” In some embodiments, when the client device 300 detects that the push button 2222 is pressed, the client device 300 may effect a predetermined response as discussed in greater detail above with regard to operation 1638. Additionally or alternatively, in some embodiments when the client device 300 detects that the push button 2222 is pressed, the client device 300 may transmit an SOS request to the server system 101 as discussed above with regard to operation 1640. In some embodiments, the push button 2222 may be replaced with any other suitable type of user input component.

With reference to FIG. 23, a diagram is depicted of an embodiment of a user interface for a client device 300, according to aspects of the disclosure. As illustrated, the user interface may include a screen 2300. The screen 2300 may be outputted on a display 310 of the client device 300, when the client device 300 receives a route from a server system 101 as discussed above with regard to operation 1608. As illustrated, the screen 2300 may include a map area 2301, push buttons 2310 and 2312, and report button 2314.

According to aspects of the disclosure, the map area 2301 may include map elements 2302, 2304, 2306, and 2308. The client device 300 may obtain the map area 2301 from the server system 101 and/or directly from an external map database 105. The map elements 2302, 2304, 2306, and 2308 may be overlaid or superimposed over the map area 2301 by the server system 101, the external map database 105, and/or the client device 300. As discussed in greater detail above with reference to FIG. 1, the server system 101 may include an internal map database 104 and may additionally or alternatively interact with the external map database 105. The map databases 104-105 store maps and mapping information that identify street layouts, intersection locations, geo-coded addresses, building locations, and other information that is typically found in a maps database. The map element 2302 is a visual representation of the route between and including a starting location 2304 and a destination 2306. The map elements 2304 and 2306 are visual representations of the starting location for the route and the destination for the route, respectively. The map element 2308 is a visual representation of a current location of the client device 300 (or a user of the client device 300).

As illustrated, the push buttons 2310 and 2312 and the report button 2314 may be overlaid or superimposed over the map area 2301 by the server system 101 and/or the client device 300. In an alternative embodiment, any of the push buttons 2310 and 2312 and the report button 2314 may be located separate from the map area 2301. The push button 2310 may include a visual representation of a safety rating associated with the route, the safety rating having been received from the server system 101 as discussed above with regard to operation 1608. The safety rating indicates an estimated likelihood of a traveler along the route being put in danger. The safety rating may be represented by, for example, a numerical figure (as illustrated), a color, any visual, audible, tactile, or other indicia or form of representation that is capable of providing the user of the client device 300 with information, or any combination thereof, as discussed above with regard to operation 1608. In some embodiments, the push button 2310 may be replaced with any other suitable type of user input component. In some embodiments, when the push button 2310 is pressed, the result may be one of the user interfaces depicted in the diagrams of FIGS. 18-19 as described hereinabove.

As illustrated, the push button 2312 may include a visual representation of a minimum safety threshold specified by the client device 300 (or the user of the client device 300). The minimum safety threshold may be, for example, a numerical figure (as illustrated), a color, and/or or any visual, audible, tactile, or other indicia or form of representation that is capable of providing the user of the client device 300 with information, or any combination thereof, as discussed above with regard to operation 1604. The minimum safety threshold indicates the lowest safety rating that is acceptable to the client device 300 (or acceptable to the user of the client device 300). In some embodiments, the push button 2312 may be replaced with any other suitable type of user input component. In some embodiments, when the push button 2312 is pressed, the result may be the user interface depicted in the diagram of FIG. 20 as described hereinabove.

When the report button 2314 is pressed, a pop-up window 2316 is launched and opened. In some embodiments, the report button 2314 may be replaced with any other suitable type of user input component. In some embodiments, the pop-up window 2316 may be replaced with any other suitable type of user interface message or notification. In an alternative embodiment, when the report button 2314 is pressed, the client device 300 may hide the screen 2300 and display in its place an alternate screen that may include the same user interface elements and/or may perform the same functions as the pop-up window 2316. Additionally or alternatively, in some embodiments the report button 2314 may be omitted and the pop-up window 2316 may be launched (or the alternate screen displayed) in response to a predetermined type of touch gesture being performed on the touchscreen 314 of the client device 300.

According to aspects of the disclosure, the pop-up window 2316 may include, for example, informational elements 2317-2319, push buttons 2320-2322, text input field 2324, or any combination thereof. The text input field 2324 may be used for entering an optional description of an unsafe condition being reported by the client device 300 (or the user of the client device 300). The informational element 2317 may include a visual representation that indicates the functionality associated with the push button 2320. As illustrated, in some embodiments the informational element 2317 may include the text “Unsafe Condition.” When the client device 300 detects that the push button 2320 is pressed, the client device 300 may transmit a report safety condition request to the server system 101, the report safety condition request being a request to report an unsafe condition, as discussed in greater detail above with regard to operations 1642-1644. The report safety condition request may include an indication of the optional description entered into the text input field 2324. In some embodiments, the push button 2320 may be replaced with any other suitable type of user input component.

The informational element 2318 may include a visual representation that indicates the functionality associated with the push button 2321. As illustrated, in some embodiments the informational element 2318 may include the text “Criminal Activity.” When the client device 300 detects that the push button 2321 is pressed, the client device 300 may transmit a report safety condition request to the server system 101, the report safety condition request being a request to report criminal activity, as discussed in greater detail above with regard to operations 1642-1644. The report safety condition request may include an indication of the optional description entered into the text input field 2324. In some embodiments, the push button 2321 may be replaced with any other suitable type of user input component.

The informational element 2319 may include a visual representation that indicates the functionality associated with the push button 2322. As illustrated, in some embodiments the informational element 2319 may include the text “Severe Weather.” When the client device 300 detects that the push button 2322 is pressed, the client device 300 may transmit a report safety condition request to the server system 101, the report safety condition request being a request to report a severe weather condition, as discussed in greater detail above with regard to operations 1642-1644. The report safety condition request may include an indication of the optional description entered into the text input field 2324. In some embodiments, the push button 2322 may be replaced with any other suitable type of user input component.

According to various embodiments of the present disclosure, at least a part of the navigation systems, devices, and methods disclosed herein may be implemented with software, firmware, hardware, or any combination thereof. At least a part of the navigation systems, devices, and methods disclosed herein may be implemented (e.g., executed) by a processor (e.g., the processor 202, the processor 302, etc.). At least a part of the navigation systems, devices, and methods disclosed herein may include, for example, a module, a program, a routine, sets of instructions, or a process for performing at least one function.

The term “module” used herein may represent, for example, a unit including one of hardware, software and firmware or a combination thereof. The term “module” may be interchangeably used with the terms “unit,” “logic,” “logical block,” “component,” and “circuit.” The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific integrated circuit (ASIC) chip, a field-programmable gate array (FPGA), and a programmable-logic device for performing some operations, which are known or will be developed.

At least a part of devices (e.g., modules or functions of the devices) or methods (e.g., operations) according to various embodiments of the present disclosure may be implemented as instructions stored in a computer-readable storage medium in the form of a module. In the case where the instructions are performed by a processor, the processor may perform functions corresponding to the instructions. The computer-readable storage medium may be, for example, the memory 204, the memory 304, etc.

A computer-readable storage medium may include a hard disk, a floppy disk, a magnetic medium (e.g., a magnetic tape), an optical medium (e.g., CD-ROM, digital versatile disc (DVD)), a magneto-optical medium (e.g., a floptical disk), or a hardware device (e.g., a ROM, a RAM, a flash memory, or the like). The instructions may include machine language codes generated by compilers and high-level language codes that can be executed by computers using interpreters. For example, an electronic device may include a processor and a memory for storing computer-readable instructions. The memory may include instructions for performing the above-mentioned various methods or functions when executed by the processor. The above-mentioned hardware (e.g., devices) may be configured to be operated as one or more software modules for performing operations of various embodiments of the present disclosure and vice versa.

A module or a program module according to various embodiments of the present disclosure may include at least one of the above-mentioned elements, or some elements may be omitted or other additional elements may be added. Operations performed by the module, the program module, or other elements according to various embodiments of the present disclosure may be performed in a sequential, parallel, iterative, or heuristic way. Furthermore, some operations may be performed in another order or may be omitted, or other operations may be added.

While the present disclosure may have been shown and described with reference to various embodiments thereof, it will be understood by those skilled in the art that various changes in form and details may be made therein without departing from the spirit and scope of the present disclosure as defined by the appended claims and their equivalents. In other words, the present disclosure is not limited to the various exemplary embodiments disclosed herein, but rather these embodiments are intended to serve as illustrative examples to facilitate a more easy and complete understanding of the present disclosure.

1. A method for navigation, comprising:
receiving, by a server system, an indication of a starting location and an indication of a destination from a first client device;
identifying a first route between and including the starting location and the destination;
calculating a first safety rating for the first route, the first safety rating indicating an estimated likelihood of a traveler experiencing an incident when traveling along the first route;
transmitting, from the server system to the first client device, an indication of the first route and an indication of the first safety rating;
identifying, for at least one path point, a point data set including one or more information sources for each path point, each path point identifying a location included within the first route, each information source having a data value, a data importance factor, a data category, and a geographic zone, the geographic zone indicating a geographic area associated with the information source, the geographic zone of each information source in the point data set being within a predetermined distance from the corresponding path point, the data importance factor being assigned to the information source and indicating a degree of significance associated with the data value, the data category being one of a user rating and a statistical resource;
identifying one or more category data sets of information sources for each point data set, each of the category data sets being a subset of the point data set, each category data set having a set category and a category importance factor, the category importance factor being assigned to the category data set and indicating a degree of significance associated with the set category, the set category being one of the user rating and the statistical resource, and each category data set including the one or more information sources in the point data set having the data category matching the set category of the category data set;
calculating a category score for each category data set, the category score being calculated based on the data value and the data importance factor of at least one of the information sources that is included within the category data set;
calculating a path point score for each path point, the path point score being calculated based on the category score and the category importance factor associated with at least one of the category data sets that is a subset of the point data set for the path point; and
wherein the first safety rating is calculated based on the at least one path point score.

2. The method of claim 1, further comprising:
updating the starting location to be a current location of the first client device in response to detecting that the first client device has commenced travel along the first route;
identifying a second route between and including the starting location and the destination after updating the starting location to be the current location of the first client device;
calculating a second safety rating for the second route after identifying the second route, the second safety rating indicating an estimated likelihood of the traveler experiencing an incident when traveling along the second route; and
transmitting, from the server system to the first client device, an indication of the second route and an indication of the second safety rating.

3.-6. (canceled)

7. The method of claim 1, further comprising:
receiving, by the server system, an indication of a new user-reported rating and an indication of a new user-reported rating location from the first client device, the new user-reported rating indicating an estimated likelihood of the traveler experiencing an incident when at the new user-reported rating location.

8. The method of claim 1, wherein the first safety rating is calculated based at least on a set of user-reported ratings, the method further comprising:
receiving, by the server system, an indication of a new user-reported rating and an indication of a new user-reported rating location from a reporting client device, the new user-reported rating indicating an estimated likelihood of the traveler experiencing an incident when at the new user-reported rating location;
updating the set of user-reported ratings to include the new user-reported rating;
calculating a remaining safety rating for a remaining portion of the first route in response to detecting that the new user-reported rating location is within a predetermined distance from the remaining portion of the first route, the remaining portion of the first route being between and including a current location of the first client device and the destination, the remaining safety rating being calculated based on at least the set of user-reported ratings, the remaining safety rating indicating an estimated likelihood of the traveler experiencing an incident when traveling along the remaining portion of the first route; and
transmitting, from the server system to the first client device, an indication of the remaining portion of the first route and an indication of the remaining safety rating.

9. The method of claim 1, wherein the first safety rating is calculated based at least on a set of user-reported ratings, the method further comprising:
receiving, by the server system, an indication of a new user-reported rating and an indication of a new user-reported rating location from a reporting client device, the new user-reported rating indicating an estimated likelihood of the traveler experiencing an incident when at the new user-reported rating location;
updating the set of user-reported ratings to include the new user-reported rating;
calculating a remaining safety rating for a remaining portion of the first route in response to detecting that the new user-reported rating location is within a predetermined distance from the remaining portion of the first route, the remaining portion of the first route being between and including a current location of the first client device and the destination, the remaining safety rating being calculated based on at least the set of user-reported ratings, the remaining safety rating indicating an estimated likelihood of the traveler experiencing an incident when traveling along the remaining portion of the first route;
identifying a second route between and including a current location of the first client device and the destination;
calculating a second safety rating for the second route, the second safety rating being calculated based at least on the set of user-reported ratings, the second safety rating indicating an estimated likelihood of the traveler experiencing an incident when traveling along the second route; and
transmitting, from the server system to the first client device, an indication of the second route and an indication of the second safety rating in response to detecting that the second safety rating indicates that the estimated likelihood of the traveler experiencing an incident is no greater than that of the remaining safety rating.

10. The method of claim 1, further comprising:
receiving, by the server system, an indication of a minimum safety threshold from the first client device; and
transmitting, from the server system to the first client device, an indication of a second route and an indication of a second safety rating in response to:
(a) detecting that the first safety rating does not satisfy the minimum safety threshold;
(b) identifying the second route between and including the starting location and the destination, the second safety rating being associated with the second route, the second safety rating indicating an estimated likelihood of the traveler experiencing an incident when traveling along the second route; and
(c) the second safety rating satisfying the minimum safety threshold.

11. The method of claim 1, further comprising:
receiving, by the server system, an indication of a preferred route type from the first client device, the preferred route type being one of a safest route, a fastest route, a shortest route, and an optimized route, the optimized route being determined based on at least one of the first safety rating, a first duration for the first route, and a first distance for the first route; and
identifying the first route based on the preferred route type.

12. The method of claim 11, wherein the optimized route is determined using a function that maximizes the first safety rating and minimizes at least one of the first duration and the first distance.

13. The method of claim 11, wherein the first route is identified such that at least one of:
(a) the first duration has a first value within a predetermined number of standard deviations away from a mean value of durations of an identified set of routes or the first value is less than the mean value of durations of the identified set of routes; and
(b) the first distance has a second value within a predetermined number of standard deviations away from a mean value of distances of an identified set of routes or the second value is less than the mean value of distances of the identified set of routes.

14. The method of claim 1, further comprising:
identifying a live danger condition and a live danger location;
identifying a remaining portion of the first route in response to detecting that the first client device has commenced travel along the first route, the remaining portion of the first route being between and including a current location of the first client device and the destination; and
transmitting, from the server system to the first client device, an indication of the live danger condition and an indication of the live danger location in response to:
(a) detecting that the live danger location is within a predetermined distance from the remaining portion of the first route; and
(b) determining that there is a statistically relevant increase in the estimated likelihood of the traveler experiencing an incident when traveling along the remaining portion of the first route because of the live danger condition.

15. The method of claim 1, further comprising:
receiving, by the server system, an indication of route safety options from the first client device, the route safety options including an option to bypass roads without street lighting; and
identifying the first route based on the route safety options.

16. The method of claim 1, further comprising:
receiving, by the server system, an indication of an SOS request from the first client device, the SOS request being at least one of a request to contact emergency services, a request to contact an emergency contact, and a request to activate an alarm; and
effecting at least one of:
a communication with the emergency services in response to detecting that the SOS request is the request to contact emergency services, the communication with the emergency services including at least one of a user identification, a vehicle identification, and a last known location of the first client device;
a communication with the emergency contact in response to detecting that the SOS request is the request to contact the emergency contact, the communication with the emergency contact including at least one of the user identification, the vehicle identification, and the last known location of the first client device; and
an activation of the alarm in response to detecting that the SOS request is the request to activate the alarm.

17. The method of claim 1, further comprising:
receiving, by the server system, an indication of a report safety condition request and an indication of identifying information from the first client device, the report safety condition request being at least one of a request to report an unsafe condition, a request to report criminal activity, and a request to report a severe weather condition, and the identifying information including at least one of a condition type, a condition location, a condition description, a user identification, and a vehicle identification; and
effecting a predetermined response in response to detecting that the condition type is within a predetermined condition category.

18. The method of claim 1, further comprising:
receiving, by the server system, an indication of a minimum safety threshold from the first client device;
determining a first destination category for the destination;
calculating a destination safety rating for the destination, the destination safety rating indicating an estimated likelihood of the traveler experiencing an incident when at the destination;
identifying an alternate destination within a predetermined distance from the destination in response to detecting that the destination safety rating does not satisfy the minimum safety threshold, the alternate destination having an alternate safety rating that satisfies the minimum safety threshold, the alternate safety rating indicating an estimated likelihood of the traveler experiencing an incident when at the alternate destination, the alternate destination having a second destination category matching the first destination category; and
transmitting, from the server system to the first client device, an indication of the alternate destination and an indication of the alternate safety rating.

19. The method of claim 1, further comprising:
calculating a second safety rating for a remaining portion of the first route, the remaining portion of the first route being between and including a current location of the first client device and the destination in response to detecting that the first client device has commenced travel along the first route;
generating a safety change alert in response to detecting that the second safety rating indicates that the estimated likelihood of the traveler experiencing an incident is greater than that of the first safety rating and detecting that a difference between the second safety rating and the first safety rating exceeds a predetermined threshold; and
transmitting, from the server system, an indication of the safety change alert and an indication of the second safety rating to the first client device after generating the safety change alert.

20.-28. (canceled)

29. A server system for navigation, comprising:
a memory;
a communications interface; and
at least one processor operatively coupled to the memory, the processor being configured to:
receive an indication of a starting location and an indication of a destination from a first client device;
identify a first route between and including the starting location and the destination;
calculate a first safety rating for the first route, the first safety rating indicating an estimated likelihood of a traveler experiencing an incident when traveling along the first route;
transmit, to the first client device, an indication of the first route and an indication of the first safety rating;
identify, for at least one path point, a point data set including one or more information sources for each path point, each path point identifying a location included within the first route, each information source having a data value, a data importance factor, a data category, and a geographic zone, the geographic zone indicating a geographic area associated with the information source, the geographic zone of each information source in the point data set being within a predetermined distance from the corresponding path point, the data importance factor being assigned to the information source and indicating a degree of significance associated with the data value, the data category being one of a user rating and a statistical resource;
identify one or more category data sets of information sources for each point data set, each of the category data sets being a subset of the point data set, each category data set having a set category and a category importance factor, the category importance factor being assigned to the category data set and indicating a degree of significance associated with the set category, the set category being one of the user rating and the statistical resource, and each category data set including the one or more information sources in the point data set having the data category matching the set category of the category data set;
calculate a category score for each category data set, the category score being calculated based on the data value and the data importance factor of at least one of the information sources that is included within the category data set;
calculate a path point score for each path point, the path point score being calculated based on the category score and the category importance factor associated with at least one of the category data sets that is a subset of the point data set for the path point; and
wherein the first safety rating is calculated based on the at least one path point score.

30. (canceled)

31. A server system for navigation, comprising:
a memory;
a communications interface; and
at least one processor operatively coupled to the memory, the processor being configured to:
receive an indication of a starting location and an indication of a destination from a first client device;
identify a first route between and including the starting location and the destination, wherein the first route comprises one or more travel segments, each travel segment identifying a portion of the first route;
calculate a first safety rating for the first route, the first safety rating indicating an estimated likelihood of a traveler experiencing an incident when traveling along the first route, wherein the first safety rating is calculated based at least on one or more segment scores, each segment score indicating an estimated likelihood of the traveler experiencing an incident when traveling along one of the one or more travel segments;
transmit, to the first client device, an indication of the first route and an indication of the first safety rating;
identify, for at least one travel segment, a segment data set including one or more information sources for each travel segment, each information source having a data value, a data importance factor, a data category, and a geographic zone, the geographic zone indicating a geographic area associated with the information source, the geographic zone of each information source in the segment data set being within a predetermined distance from any location within the corresponding travel segment, the data importance factor being assigned to the information source and indicating a degree of significance associated with the data value, the data category being one of a user rating and a statistical resource;
identify one or more category data sets of information sources for each segment data set, each of the category data sets being a subset of the segment data set, each category data set having a set category and a category importance factor, the category importance factor being assigned to the category data set and indicating a degree of significance associated with the set category, the set category being one of the user rating and the statistical resource, each category data set including the one or more information sources in the segment data set having the data category matching the set category of the category data set;
calculate the category score for each category data set, the category score being calculated based on the data value and the data importance factor of at least one of the information sources that is included within the category data set; and
calculate a segment score for each travel segment, the segment score being calculated based on the category score and the category importance factor associated with at least one of the category data sets that is a subset of the segment data set for the travel segment.

32. A method for navigation, comprising:
receiving, by a server system, an indication of a starting location and an indication of a destination from a first client device;
identifying a first route between and including the starting location and the destination, wherein the first route comprises one or more travel segments, each travel segment identifying a portion of the first route;
calculating a first safety rating for the first route, the first safety rating indicating an estimated likelihood of a traveler experiencing an incident when traveling along the first route, wherein the first safety rating is calculated based at least on one or more segment scores, each segment score indicating an estimated likelihood of the traveler experiencing an incident when traveling along one of the one or more travel segments;
transmitting, from the server system to the first client device, an indication of the first route and an indication of the first safety rating;
identifying, for at least one travel segment, a segment data set including one or more information sources for each travel segment, each information source having a data value, a data importance factor, a data category, and a geographic zone, the geographic zone indicating a geographic area associated with the information source, the geographic zone of each information source in the segment data set being within a predetermined distance from any location within the corresponding travel segment, the data importance factor being assigned to the information source and indicating a degree of significance associated with the data value, the data category being one of a user rating and a statistical resource;
identifying one or more category data sets of information sources for each segment data set, each of the category data sets being a subset of the segment data set, each category data set having a set category and a category importance factor, the category importance factor being assigned to the category data set and indicating a degree of significance associated with the set category, the set category being one of the user rating and the statistical resource, each category data set including the one or more information sources in the segment data set having the data category matching the set category of the category data set;
calculating the category score for each category data set, the category score being calculated based on the data value and the data importance factor of at least one of the information sources that is included within the category data set; and
calculating a segment score for each travel segment, the segment score being calculated based on the category score and the category importance factor associated with at least one of the category data sets that is a subset of the segment data set for the travel segment.

33. The method of claim 32, further comprising:
updating the starting location to be a current location of the first client device in response to detecting that the first client device has commenced travel along the first route;
identifying a second route between and including the starting location and the destination after updating the starting location to be the current location of the first client device;
calculating a second safety rating for the second route after identifying the second route, the second safety rating indicating an estimated likelihood of the traveler experiencing an incident when traveling along the second route; and
transmitting, from the server system to the first client device, an indication of the second route and an indication of the second safety rating.

34. The method of claim 32, further comprising:
receiving, by the server system, an indication of a new user-reported rating and an indication of a new user-reported rating location from the first client device, the new user-reported rating indicating an estimated likelihood of the traveler experiencing an incident when at the new user-reported rating location.

35. The method of claim 32, wherein the first safety rating is calculated based at least on a set of user-reported ratings, the method further comprising:
receiving, by the server system, an indication of a new user-reported rating and an indication of a new user-reported rating location from a reporting client device, the new user-reported rating indicating an estimated likelihood of the traveler experiencing an incident when at the new user-reported rating location;
updating the set of user-reported ratings to include the new user-reported rating;
calculating a remaining safety rating for a remaining portion of the first route in response to detecting that the new user-reported rating location is within a predetermined distance from the remaining portion of the first route, the remaining portion of the first route being between and including a current location of the first client device and the destination, the remaining safety rating being calculated based on at least the set of user-reported ratings, the remaining safety rating indicating an estimated likelihood of the traveler experiencing an incident when traveling along the remaining portion of the first route; and
transmitting, from the server system to the first client device, an indication of the remaining portion of the first route and an indication of the remaining safety rating.

36. The method of claim 32, wherein the first safety rating is calculated based at least on a set of user-reported ratings, the method further comprising:
receiving, by the server system, an indication of a new user-reported rating and an indication of a new user-reported rating location from a reporting client device, the new user-reported rating indicating an estimated likelihood of the traveler experiencing an incident when at the new user-reported rating location;
updating the set of user-reported ratings to include the new user-reported rating;
calculating a remaining safety rating for a remaining portion of the first route in response to detecting that the new user-reported rating location is within a predetermined distance from the remaining portion of the first route, the remaining portion of the first route being between and including a current location of the first client device and the destination, the remaining safety rating being calculated based on at least the set of user-reported ratings, the remaining safety rating indicating an estimated likelihood of the traveler experiencing an incident when traveling along the remaining portion of the first route;
identifying a second route between and including a current location of the first client device and the destination;
calculating a second safety rating for the second route, the second safety rating being calculated based at least on the set of user-reported ratings, the second safety rating indicating an estimated likelihood of the traveler experiencing an incident when traveling along the second route; and
transmitting, from the server system to the first client device, an indication of the second route and an indication of the second safety rating in response to detecting that the second safety rating indicates that the estimated likelihood of the traveler experiencing an incident is no greater than that of the remaining safety rating.

37. The method of claim 32, further comprising:
receiving, by the server system, an indication of a minimum safety threshold from the first client device; and
transmitting, from the server system to the first client device, an indication of a second route and an indication of a second safety rating in response to:
(a) detecting that the first safety rating does not satisfy the minimum safety threshold;
(b) identifying the second route between and including the starting location and the destination, the second safety rating being associated with the second route, the second safety rating indicating an estimated likelihood of the traveler experiencing an incident when traveling along the second route; and
(c) the second safety rating satisfying the minimum safety threshold.

38. The method of claim 32, further comprising:
receiving, by the server system, an indication of a preferred route type from the first client device, the preferred route type being one of a safest route, a fastest route, a shortest route, and an optimized route, the optimized route being determined based on at least one of the first safety rating, a first duration for the first route, and a first distance for the first route; and
identifying the first route based on the preferred route type.

39. The method of claim 38, wherein the optimized route is determined using a function that maximizes the first safety rating and minimizes at least one of the first duration and the first distance.

40. The method of claim 38, wherein the first route is identified such that at least one of:
(a) the first duration has a first value within a predetermined number of standard deviations away from a mean value of durations of an identified set of routes or the first value is less than the mean value of durations of the identified set of routes; and
(b) the first distance has a second value within a predetermined number of standard deviations away from a mean value of distances of an identified set of routes or the second value is less than the mean value of distances of the identified set of routes.

41. The method of claim 32, further comprising:
identifying a live danger condition and a live danger location;
identifying a remaining portion of the first route in response to detecting that the first client device has commenced travel along the first route, the remaining portion of the first route being between and including a current location of the first client device and the destination; and
transmitting, from the server system to the first client device, an indication of the live danger condition and an indication of the live danger location in response to:
(a) detecting that the live danger location is within a predetermined distance from the remaining portion of the first route; and
(b) determining that there is a statistically relevant increase in the estimated likelihood of the traveler experiencing an incident when traveling along the remaining portion of the first route because of the live danger condition.

42. The method of claim 32, further comprising:
receiving, by the server system, an indication of route safety options from the first client device, the route safety options including an option to bypass roads without street lighting; and
identifying the first route based on the route safety options.

43. The method of claim 32, further comprising:
receiving, by the server system, an indication of a report safety condition request and an indication of identifying information from the first client device, the report safety condition request being at least one of a request to report an unsafe condition, a request to report criminal activity, and a request to report a severe weather condition, and the identifying information including at least one of a condition type, a condition location, a condition description, a user identification, and a vehicle identification; and
effecting a predetermined response in response to detecting that the condition type is within a predetermined condition category.

44. The method of claim 32, further comprising:
calculating a second safety rating for a remaining portion of the first route, the remaining portion of the first route being between and including a current location of the first client device and the destination in response to detecting that the first client device has commenced travel along the first route;
generating a safety change alert in response to detecting that the second safety rating indicates that the estimated likelihood of the traveler experiencing an incident is greater than that of the first safety rating and detecting that a difference between the second safety rating and the first safety rating exceeds a predetermined threshold; and
transmitting, from the server system, an indication of the safety change alert and an indication of the second safety rating to the first client device after generating the safety change alert.
